(19) United States
(12) Patent Application Publication
(10) Pub. No.: US 2024/0224898 A9
(43) Pub. Date: Jul. 11, 2024

(54) BIOMEDIA COMPOSITIONS FOR PEAT-REPLACEMENT PRODUCTS, AND PROCESSES FOR PRODUCING BIOMEDIA COMPOSITIONS

(71) Applicant: Carbon Technology Holdings, LLC, Oakdale, MN (US)

(72) Inventors: James A. Mennell, Brighton, UT (US); Daren Daugaard, Newburg, MO (US); Dustin Slack, Gwinn, MI (US)

(21) Appl. No.: 18/491,925

(22) Filed: Oct. 23, 2023

Related U.S. Application Data
(60) Provisional application No. 63/418,305, filed on Oct. 21, 2022.

(51) Int. Cl. A01G 24/22; A01G 24/40

(52) U.S. Cl. CPC A01G 24/22; A01G 24/40

(57) ABSTRACT

Some variations provide a biomedia composition comprising: from 50 wt % to 75 wt % total carbon, on a dry basis, according to ASTM D5373, wherein the total carbon is renewable according to ASTM D6866 (¹⁴C/¹²C isotopic ratio); from 20 wt % to 40 wt % oxygen, on a dry basis, according ASTM D5373; from 3 wt % to 10 wt % hydrogen, on a dry basis, according to ASTM D5373; and from 0.1 wt % to 2 wt % nitrogen, on a dry basis, according to ASTM D5373, wherein the biomedia composition is characterized by volatile-matter content from 50 wt % to 75 wt %, according to ASTM D3175; wherein the biomedia composition is characterized by ash content from 1 wt % to 25 wt %, according to ASTM D3174; and wherein the biomedia composition is characterized by moisture content from 0 to 75 wt %, according to ASTM D3173. Processes are also described to make and use the biomedia compositions.

### CROSS-REFERENCE TO RELATED APPLICATION(S)

This application claims the benefit of U.S. Provisional Patent Application No. 63/418,305, filed on Oct. 21, 2022, which is incorporated herein by reference in its entirety.

### TECHNICAL FIELD

The present invention generally relates to peat replacement products.

### BACKGROUND

Peat is an accumulation of partially decayed vegetation or organic matter. Peat is composed of organic matter, minerals, and water. Peat is conventionally harvested from natural areas, peatlands, which can take the specific form of bogs, mires, moors, muskegs, fens, pocosins, or peat swamp forests, for example.

### SUMMARY

Some variations of the invention provide a biomedia composition comprising:
from about 50 wt % to about 75 wt % total carbon, on a dry basis, according to an ASTM D5373 ultimate analysis of the biomedia composition, wherein the total carbon is at least 50% renewable according to an ASTM D6866 measurement of the ¹⁴C/¹²C isotopic ratio of the total carbon;
from about 20 wt % to about 40 wt % oxygen, on a dry basis, according to the ASTM D5373 ultimate analysis of the biomedia composition;
from about 3 wt % to about 10 wt % hydrogen, on a dry basis, according to the ASTM D5373 ultimate analysis of the biomedia composition; and
from about 0.1 wt % to about 2 wt % nitrogen, on a dry basis, according to the ASTM D5373 ultimate analysis of the biomedia composition,
wherein the biomedia composition is characterized by a volatile-matter content from about 50 wt % to about 75 wt %, according to an ASTM D3175 proximate analysis of the biomedia composition;
wherein the biomedia composition is characterized by an ash content from about 1 wt % to about 25 wt %, according to an ASTM D3174 proximate analysis of the biomedia composition; and
wherein the biomedia composition is characterized by a moisture content from 0 to about 75 wt %, according to an ASTM D3173 proximate analysis of the biomedia composition.

In some embodiments, the biomedia composition comprises from about 55 wt % to about 70 wt % total carbon, on a dry basis, according to the ASTM D5373 ultimate analysis of the biomedia composition. In certain embodiments, the biomedia composition comprises from about 60 wt % to about 65 wt % total carbon, on a dry basis, according to the ASTM D5373 ultimate analysis of the biomedia composition.

In some embodiments, the total carbon is at least 80% renewable according to the ASTM D6866 measurement of the ¹⁴C/¹²C isotopic ratio of the total carbon. In certain embodiments, the total carbon is at least 90% (e.g., 100%) renewable according to the ASTM D6866 measurement of the ¹⁴C/¹²C isotopic ratio of the total carbon.

In some embodiments, the biomedia composition comprises from about 25 wt % oxygen to about 35 wt % oxygen, on a dry basis, according to the ASTM D5373 ultimate analysis of the biomedia composition.

In some embodiments, the biomedia composition comprises from about 5 wt % to about 8 wt % hydrogen, on a dry basis, according to the ASTM D5373 ultimate analysis of the biomedia composition.

In some embodiments, the biomedia composition comprises from about 0.5 wt % to about 1 wt % nitrogen, on a dry basis, according to the ASTM D5373 ultimate analysis of the biomedia composition. Nitrogen is a critical nutrient for plant growth.

In some embodiments, the biomedia composition comprises phosphorus, potassium, sulfur, or a combination thereof. Phosphorus, potassium, and sulfur are important nutrients for plant growth.

In some embodiments, the biomedia composition contains less than 1 ppm mercury. The biomedia composition can be essentially free of mercury.

In some embodiments, the biomedia composition further comprises one or more additives. Additives can be introduced for a wide variety of reasons, including both functional (e.g., for pH optimization) as well as ornamental (e.g., color). Additives can be used to enhance the water absorbency, nutrient absorbency, or aeration potential of the biomedia composition, for example.

In some embodiments, the biomedia composition is characterized by a volatile-matter content from about 60 wt % to about 70 wt %, according to the ASTM D3175 proximate analysis of the biomedia composition.

In some embodiments, the biomedia composition is characterized by an ash content from about 2 wt % to about 20 wt %, according to the ASTM D3174 proximate analysis of the biomedia composition.

In some embodiments, the biomedia composition is characterized by a moisture content from 10 wt % to about 50 wt %, according to the ASTM D3173 proximate analysis of the biomedia composition.

In some embodiments, the biomedia composition is hydrophilic. In other embodiments, the biomedia composition is hydrophobic. In certain embodiments, the biomedia composition is amphipathic.

The biomedia composition can be characterized by an equilibrium moisture content defined according to ASTM D1412. The equilibrium moisture content can be from 0 to about 90 wt %, such as from about 25 wt % to about 75 wt % water. A greater equilibrium moisture content typically means that the biomedia composition has a high water-absorption capacity.

In some embodiments, the biomedia composition is in the form of fine particulates. In some embodiments, the biomedia composition is in the form of fibrous particles. In certain embodiments, the biomedia composition is in the form of a mixture of fine particulates and fibrous particles.

In some embodiments, the biomedia composition is in the form of a densified object, such as a pellet or a brick of the biomedia composition.

In some embodiments, the biomedia composition has a biomedia pH selected from about 4 to about 8. In certain embodiments, the biomedia composition has a biomedia pH selected from about 5 to about 7.

In some embodiments, the biomedia composition has a cationic exchange capacity selected from about 50 to about 200 meq/100 g, such as from about 80 to about 150 meq/100 g, or from about 100 to about 125 meq/100 g.

In some embodiments, the biomedia composition is characterized by a base-acid ratio defined by the following formula:

$$Base - Acid Ratio = \frac{{Fe}_{2} {O}_{3} + CaO + MgO + {K}_{2} O + {Na}_{2} O}{{SiO}_{2} + {Al}_{2} {O}_{3} + {TiO}_{2}}$$

wherein each of the Fe₂O₃, CaO, MgO, K₂O, Na₂O, SiO₂, Al₂O₃, and TiO₂ correspond to weight percentages in the biomedia composition pursuant to ASTM D4326, and wherein the base-acid ratio is selected from about 0.5 to about 10. In certain embodiments, the base-acid ratio is selected from about 1 to about 10, or from about 1 to about 5, or about 5 to about 10.

In some embodiments, the biomedia composition is characterized by an expanded base-acid ratio defined by the following formula:

$$Expanded Base - Acid Ratio = \frac{{Fe}_{2} {O}_{3} + CaO + MgO + {K}_{2} O + {Na}_{2} O + MnO + SrO + BaO}{{SiO}_{2} + {Al}_{2} {O}_{3} + {TiO}_{2} + {P}_{2} {O}_{5} + {SO}_{3}}$$

wherein each of the Fe₂O₃, CaO, MgO, K₂O, Na₂O, MnO, SrO, BaO, SiO₂, Al₂O₃, TiO₂, P₂O₅, and SO₃ correspond to weight fractions in the biomedia composition pursuant to ASTM D4326, and wherein the expanded base-acid ratio is selected from about 0.25 to about 8. In certain embodiments, the expanded base-acid ratio is selected from about 0.5 to about 8, or from about 1 to about 4, or from about 4 to about 8.

In some embodiments, the biomedia composition is biologically sterile.

In some embodiments, the biomedia composition is biodegradable.

In some embodiments, the biomedia composition is compostable.

In some embodiments, the biomedia composition has a low fines/particulates level to avoid dust hazards.

Other variations of the invention provide a process for producing a biomedia composition, the process comprising:
(a) providing a starting feedstock containing biomass, wherein the starting feedstock is optionally dried;
(b) mildly pyrolyzing the starting feedstock to generate an intermediate biocarbon stream and a pyrolysis vapor;
(c) optionally washing or treating the intermediate biocarbon stream with an acid, a base, a salt, a metal, H₂, H₂O, CO, CO₂, or a combination thereof, to adjust acidity of the intermediate biocarbon stream; and
(d) recovering a biomedia composition containing:
from about 50 wt % to about 75 wt % total carbon, on a dry basis, according to an ASTM D5373 ultimate analysis of the biomedia composition, wherein the total carbon is at least 50% renewable according to an ASTM D6866 measurement of the ¹⁴C/¹²C isotopic ratio of the total carbon;
from about 20 wt % to about 40 wt % oxygen, on a dry basis, according to the ASTM D5373 ultimate analysis of the biomedia composition;
from about 3 wt % to about 10 wt % hydrogen, on a dry basis, according to the ASTM D5373 ultimate analysis of the biomedia composition; and
from about 0.1 wt % to about 2 wt % nitrogen, on a dry basis, according to the ASTM D5373 ultimate analysis of the biomedia composition,
wherein the biomedia composition is characterized by a volatile-matter content from about 50 wt % to about 75 wt %, according to an ASTM D3175 proximate analysis of the biomedia composition;
wherein the biomedia composition is characterized by an ash content from about 1 wt % to about 25 wt %, according to an ASTM D3174 proximate analysis of the biomedia composition; and
wherein the biomedia composition is characterized by a moisture content from 0 to about 75 wt %, according to an ASTM D3173 proximate analysis of the biomedia composition.

Some variations of the invention provide a process for producing a biomedia composition, the process comprising:
(a) providing a starting feedstock containing biomass, wherein the starting feedstock is optionally dried;
(b) mildly pyrolyzing the starting feedstock to generate an intermediate biocarbon stream and a pyrolysis vapor;
(c) optionally introducing one or more additives during step (a) or step (b), to adjust the acidity of the intermediate biocarbon stream; and
(d) recovering a biomedia composition containing:
from about 50 wt % to about 75 wt % total carbon, on a dry basis, according to an ASTM D5373 ultimate analysis of the biomedia composition, wherein the total carbon is at least 50% renewable according to an ASTM D6866 measurement of the ¹⁴C/¹²C isotopic ratio of the total carbon;
from about 20 wt % to about 40 wt % oxygen, on a dry basis, according to the ASTM D5373 ultimate analysis of the biomedia composition;
from about 3 wt % to about 10 wt % hydrogen, on a dry basis, according to the ASTM D5373 ultimate analysis of the biomedia composition; and
from about 0.1 wt % to about 2 wt % nitrogen, on a dry basis, according to the ASTM D5373 ultimate analysis of the biomedia composition,
wherein the biomedia composition is characterized by a volatile-matter content from about 50 wt % to about 75 wt %, according to an ASTM D3175 proximate analysis of the biomedia composition;
wherein the biomedia composition is characterized by an ash content from about 1 wt % to about 25 wt %, according to an ASTM D3174 proximate analysis of the biomedia composition; and
wherein the biomedia composition is characterized by a moisture content from 0 to about 75 wt %, according to an ASTM D3173 proximate analysis of the biomedia composition.

In some processes, the biomass is selected from softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or combinations thereof.

In some processes, the intermediate biocarbon stream or the biomedia composition is mechanically shredded.

In some processes, the intermediate biocarbon stream or the biomedia composition is mechanically fluffed.

In some processes, the intermediate biocarbon stream or the biomedia composition is further treated.

In some processes, the intermediate biocarbon stream or the biomedia composition is treated to alter porosity of the biomedia composition.

In some processes, the intermediate biocarbon stream or the biomedia composition is treated to alter solid flowability of the biomedia composition.

In some processes, the biomedia composition is treated to adjust chemical oxygen demand of the biomedia composition.

In some processes, the biomedia composition is treated to adjust color of the biomedia composition.

In some processes, the biomedia composition is treated to adjust odor of the biomedia composition.

In some processes, the biomedia composition is treated to adjust texture of the biomedia composition.

In various processes, the biomedia composition comprises from about 55 wt % to about 70 wt % total carbon, on a dry basis, according to the ASTM D5373 ultimate analysis of the biomedia composition. In certain processes, the biomedia composition comprises from about 60 wt % to about 65 wt % total carbon, on a dry basis, according to the ASTM D5373 ultimate analysis of the biomedia composition.

In some processes, the total carbon is at least 80% renewable according to the ASTM D6866 measurement of the ¹⁴C/¹²C isotopic ratio of the total carbon. In certain processes, the total carbon is at least 90%, at least 95%, or 100% renewable according to the ASTM D6866 measurement of the ¹⁴C/¹²C isotopic ratio of the total carbon.

In some processes, the biomedia composition comprises from about 25 wt % oxygen to about 35 wt % oxygen, on a dry basis, according to the ASTM D5373 ultimate analysis of the biomedia composition.

In some processes, the biomedia composition comprises from about 5 wt % to about 8 wt % hydrogen, on a dry basis, according to the ASTM D5373 ultimate analysis of the biomedia composition.

In some processes, the biomedia composition comprises from about 0.5 wt % to about 1 wt % nitrogen, on a dry basis, according to the ASTM D5373 ultimate analysis of the biomedia composition.

In some processes, the biomedia composition comprises phosphorus, potassium, sulfur, or a combination thereof.

In some processes, the biomedia composition contains less than 1 ppm mercury. In certain processes, the biomedia composition is essentially free of mercury.

In some processes, the biomedia composition is characterized by a volatile-matter content from about 60 wt % to about 70 wt %, according to the ASTM D3175 proximate analysis of the biomedia composition.

In some processes, the biomedia composition is characterized by an ash content from about 2 wt % to about 20 wt %, according to the ASTM D3174 proximate analysis of the biomedia composition.

In some processes, the biomedia composition is characterized by a moisture content from 10 wt % to about 50 wt %, according to the ASTM D3173 proximate analysis of the biomedia composition.

In some processes, the biomedia composition is hydrophilic. In other processes, the biomedia composition is hydrophobic. In certain processes, the biomedia composition is amphipathic.

In some processes, the biomedia composition is in the form of fine particulates. In other processes, the biomedia composition is in the form of fibrous particles, or a mixture of fibrous particles and fine particulates. In still other processes, the biomedia composition is in the form of a densified object.

In some processes, step (c) is not performed. In other processes, step (c) is performed. When step (c) is done, the step can comprise washing or treating the intermediate biocarbon stream with an acid, a base, a salt, a metal, H₂, H₂O, CO, CO₂, or a combination thereof, to adjust acidity of the intermediate biocarbon stream, as well as introducing one or more additives during step (a) or step (b), to adjust the acidity of the intermediate biocarbon stream, if desired.

In some processes, the biomedia composition has a biomedia pH selected from about 4 to about 8, such as a biomedia pH selected from about 5 to about 7.

In some processes, the biomedia composition has a cationic exchange capacity selected from about 50 to about 200 meq/100 g, such as from about 80 to about 150 meq/100 g, or from about 100 to about 125 meq/100 g.

In some processes, the biomedia composition is characterized by a base-acid ratio defined by the following formula:

$$Base - Acid Ratio = \frac{{Fe}_{2} {O}_{3} + CaO + MgO + {K}_{2} O + {Na}_{2} O}{{SiO}_{2} + {Al}_{2} {O}_{3} + {TiO}_{2}}$$

wherein each of the Fe₂O₃, CaO, MgO, K₂O, Na₂O, SiO₂, Al₂O₃, and TiO₂ correspond to weight percentages in the biomedia composition pursuant to ASTM D4326, and wherein the base-acid ratio is selected from about 0.5 to about 10, such as from about 1 to about 10, or from about 1 to about 5, or from about 5 to about 10.

In some processes, the biomedia composition is characterized by an expanded base-acid ratio defined by the following formula:

$$Expanded Base - Acid Ratio = \frac{{Fe}_{2} {O}_{3} + CaO + MgO + {K}_{2} O + {Na}_{2} O + MnO + SrO + BaO}{{SiO}_{2} + {Al}_{2} {O}_{3} + {TiO}_{2} + {P}_{2} {O}_{5} + {SO}_{3}}$$

wherein each of the Fe₂O₃, CaO, MgO, K₂O, Na₂O, MnO, SrO, BaO, SiO₂, Al₂O₃, TiO₂, P₂O₅, and SO₃ correspond to weight fractions in the biomedia composition pursuant to ASTM D4326, and wherein the expanded base-acid ratio is selected from about 0.25 to about 8, such as from about 0.5 to about 8, or from about 1 to about 4, or from about 4 to about 8.

In some processes, the biomedia composition is biologically sterile. In some processes, the biomedia composition is biodegradable. In some processes, the biomedia composition is compostable.

The process can be continuous, semi-continuous, or a batch process.

### BRIEF DESCRIPTION OF THE DRAWINGS

FIG. 1 is a schematic illustration of an exemplary biomedia composition, in the form of fine particulates (not drawn to scale).

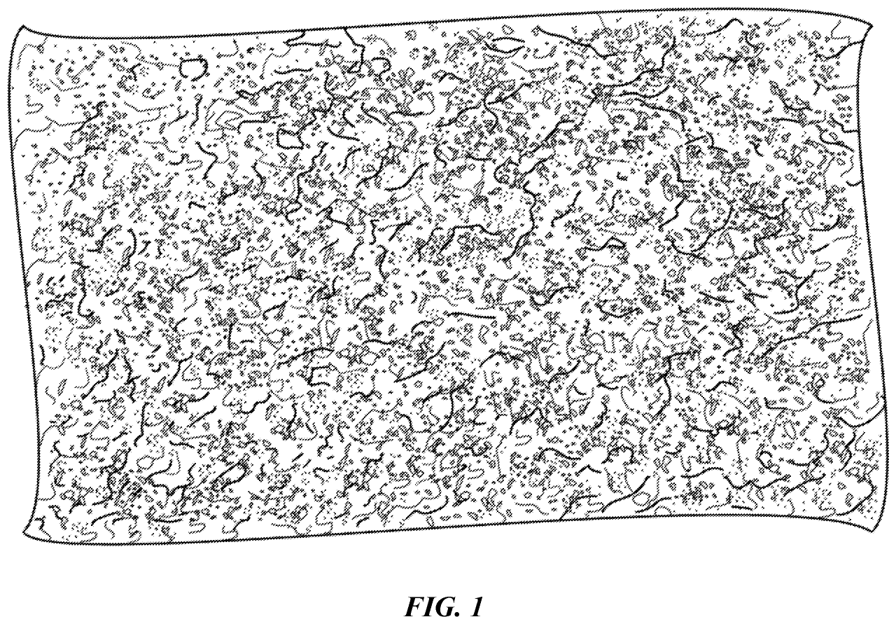

FIG. 2 is a schematic illustration of an exemplary biomedia composition, in the form of fibrous particles (not drawn to scale).

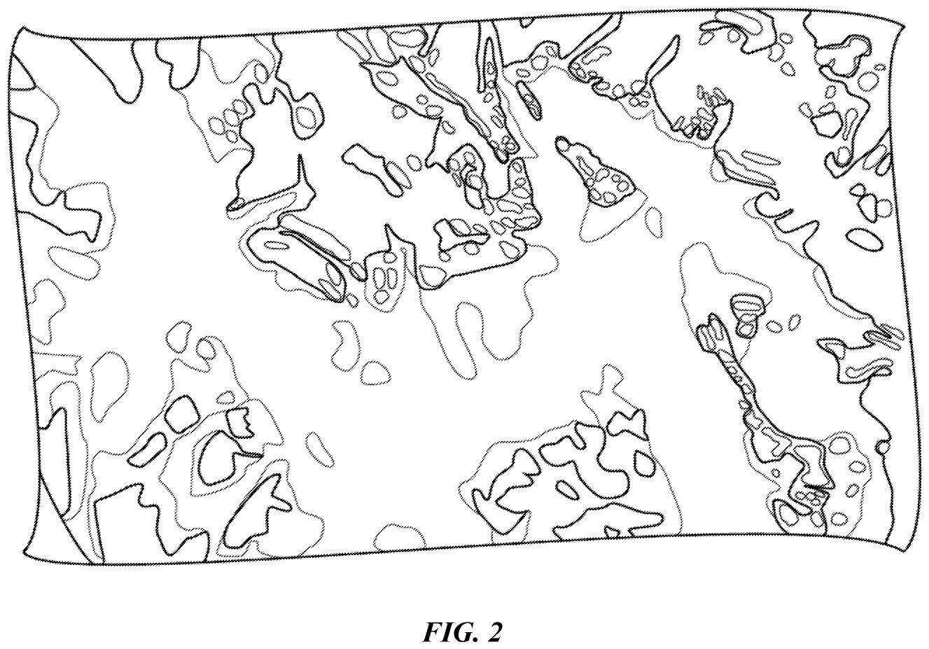

FIG. 3 is a simplified block-flow diagram of a process for converting a biomass feedstock into a biomedia composition, in some embodiments. Dotted lines denote optional streams and units.

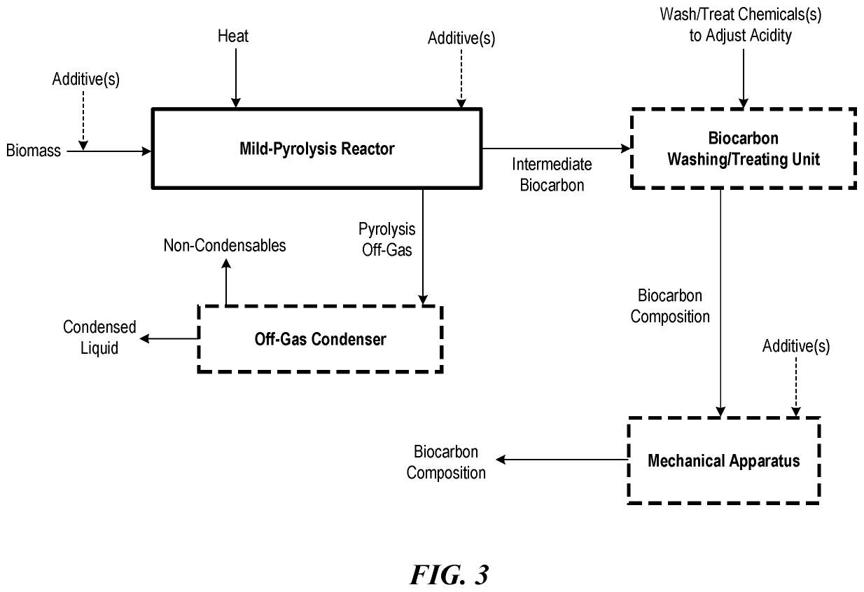

FIG. 4 is a simplified block-flow diagram of a process for converting a biomass feedstock into a biomedia composition, in some embodiments. Dotted lines denote optional streams and units.

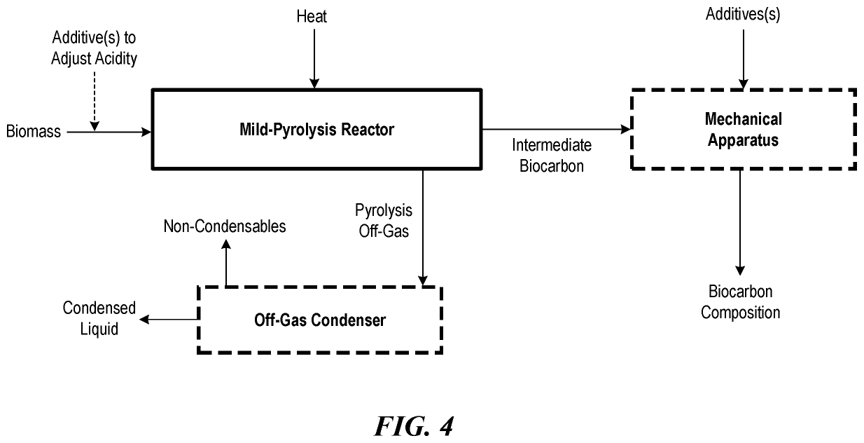

### DETAILED DESCRIPTION

Globally, peat stores about 40% of all soil carbon on the Earth, which exceeds the carbon stored in all other vegetation types, even though peat covers just 3% of the Earth's land surface. See Dunne, “Climate change and deforestation threaten world's largest tropical peatland,” Carbon Brief, January 2018, www.carbonbrief.org/climate-change-and-deforestation-threaten-worlds-largest-tropical-peatland retrieved Apr. 18, 2022.

It usually takes thousands of years for peatlands to develop. Peat, therefore, is not generally regarded as a renewable source of energy or biomaterials. The formation of peat is often an initial step in the geological formation of fossil fuels, such as coal, particularly low-grade coal such as lignite. The extraction rate of peat in industrialized countries far exceeds its slow regrowth rate on the order of 1 mm per year. Centuries of burning and draining of peat by humans has released a significant amount of CO₂ into the atmosphere. Peatland restoration is being pursued in some areas.

Sphagnum is a genus of between 151 and 350 species of mosses commonly called “peat moss” due to its prevalence in wet habitats, where the sphagnum contributes to the formation of peat bogs and mires. “Sphagnum moss” refers to the live moss growing on top of a peat bog. “Sphagnum peat moss” (American usage) and “sphagnum peat” (British usage) refer to moss slowly decaying underneath the sphagnum moss. Note that peat moss is a common component of peat, but many other decayed plants can be present in peat as well.

Peat is utilized for horticulture and agriculture in certain parts of the world. Peat, such as peat moss, is used as a primary growing media and soil conditioner for cultivating plants by increasing the soil's capacity to hold water and nutrients, primarily by increasing capillary forces and cation exchange capacity. As a result of mass harvesting as well as flooding and ecosystem damage associated with environmental changes, the annual production capacity of peat has decreased in recent years, resulting in higher peat market prices. Moreover, natural sphagnum moss often becomes infected by the fungus Fusarium oxysporum or becomes a carrier of blight. The result is inferior quality of plants cultivated by natural sphagnum moss.

Research for peat replacements began in the 1970s, as the environmental consequences of destroying peatlands started to attract concern in some parts of the world. The first generation of alternatives were often made from waste materials that had been composted, such as grass and tree clippings, food processing byproducts, such as spent brewers grain, and animal manures. None of these alternatives were as successful as peat.

It is known that polymers, such as polyesters or polyamides, can function as a peat replacement product. However, using polyesters or polyamides as a soil amendment causes an accumulation of polymer waste that does not biodegrade on reasonable time scales.

What is still desired is a natural and sustainable peat replacement product that has uniform quality, is free from infection, and is not susceptible to blight.

Some variations of the invention are premised on the realization that peat harvesting is not sustainable, while biomass harvesting and biomass pyrolysis can be done in a sustainable manner. A peat-like product, in the form of a biomedia composition, is described in this disclosure, it being understood that the biomedia composition has numerous other applications. A peat-like product can be formed in minutes or hours rather than over thousands of years. Also, the biomedia composition can have certain superior properties compared to conventional peat.

As used herein, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing reaction conditions, stoichiometries, concentrations of components, and so forth used in the specification and claims are to be understood as being modified in all instances by the term “about.” Accordingly, unless indicated to the contrary, the numerical parameters set forth in the following specification and attached claims are approximations that can vary depending at least upon a specific analytical technique.

As used herein, the term “about” means±20% of the indicated range, value, or structure, unless otherwise indicated.

As used herein, any concentration range, percentage range, ratio range, or integer range is to be understood to include the value of any integer within the recited range and, when appropriate, fractions thereof (such as one tenth and one-hundredth of an integer), unless otherwise indicated. Also, any number range recited herein is to be understood to include any integer within the recited range, unless otherwise indicated.

As used herein, “from about X to about Y”; “in the range of from or in between about”; “in the range of from or in between about X, Y, or Z”; includes “at least X to at most Z.”

As used herein, the term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements can be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms. Thus in some embodiments not otherwise explicitly recited, any instance of “comprising” can be replaced by “consisting of” or, alternatively, by “consisting essentially of.”

As used herein, unless expressly stated to the contrary, “or” refers to an inclusive “or” and not to an exclusive “or.” Unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and both A and B. Where the context permits, singular or plural terms can also include the plural or singular term, respectively.

As used herein, “biogenic” is a material (whether a feedstock, product, or intermediate) that contains an element, such as carbon, that is renewable on time scales of months, years, or decades. Non-biogenic materials can be non-renewable, or can be renewable on time scales of centuries, thousands of years, millions of years, or even longer geologic time scales. For example, traditional fuel sources of coal and petroleum are non-renewable and non-biogenic. A biogenic material can consist essentially of biogenic sources. It will be understood by one skilled in the art that biogenic materials, as natural sources or derived from nature, can comprise an immaterial amount of non-biogenic material. Further, the processes disclosed herein can be used with non-biogenic material, though the beneficial environmental impact may not be as great.

There are three naturally occurring isotopes of carbon, ¹²C, ¹³C, and ¹⁴C. ¹²C and ¹³C are stable, occurring in a natural proportion of approximately 93:1. ¹⁴C is produced by thermal neutrons from cosmic radiation in the upper atmosphere, and is transported down to earth to be absorbed by living biological material. Isotopically, ¹⁴C constitutes a negligible part; but, since it is radioactive with a half-life of 5,700 years, it is radiometrically detectable. Dead tissue does not absorb ¹⁴C, so the amount of ¹⁴C is one of the methods used for radiometric dating of biological material.

Plants take up ¹⁴C by fixing atmospheric carbon through photosynthesis. Animals then take ¹⁴C into their bodies when they consume plants or consume other animals that consume plants. Accordingly, living plants and animals have the same ratio of ¹⁴C to ¹²C as the atmospheric CO₂. Once an organism dies, it stops exchanging carbon with the atmosphere, and thus no longer takes up new ¹⁴C. Radioactive decay then gradually depletes the ¹⁴C in the organism. This effect is the basis of radiocarbon dating.

Fossil fuels, such as coal, are made primarily of plant material that was deposited millions of years ago. This period of time equates to thousands of half-lives of ¹⁴C, so essentially all of the ¹⁴C in fossil fuels has decayed. Fossil fuels also are depleted in ¹³C relative to the atmosphere, because they were originally formed from living organisms. Therefore, the carbon from fossil fuels is depleted in both ¹³C and ¹⁴C compared to biogenic carbon.

This difference between the carbon isotopes of recently deceased organic matter, such as that from renewable resources, and the carbon isotopes of fossil fuels, such as coal, allows for a determination of the source of carbon in a composition. Specifically, whether the carbon in the composition was derived from a renewable resource or from a fossil fuel; in other words, whether a renewable resource or a fossil fuel was used in the production of the composition.

Biomass is a term used to describe any biologically produced matter, or biogenic matter. Biomass refers to the mass of living organisms, including plants, animals, and microorganisms, or, from a biochemical perspective, cellulose, lignin, sugars, fats, and proteins. Biomass includes both the above- and belowground tissues of plants, for example, leaves, twigs, branches, boles, as well as roots of trees and rhizomes of grasses. The chemical energy contained in biomass is derived from solar energy using the natural process of photosynthesis. This is the process by which plants take in carbon dioxide and water from their surroundings and, using energy from sunlight, convert them into sugars, starches, cellulose, hemicellulose, and lignin. Biomass is useful in that it is, effectively, stored solar energy. Biomass is the only renewable source of carbon.

As used herein, “total carbon” is fixed carbon plus non-fixed carbon that is present in volatile matter. In some embodiments, component weight percentages are on an absolute basis, which is assumed unless stated otherwise. In other embodiments, component weight percentages are on a moisture-free and ash-free basis.

As used herein, “zones” are regions of space within a single physical unit, physically separate units, or any combination thereof. For a continuous reactor, the demarcation of zones can relate to structure, such as the presence of flights within the reactor or distinct heating elements to provide heat to separate zones. Alternatively, or additionally, the demarcation of zones in a continuous reactor can relate to function, such as distinct temperatures, fluid flow patterns, solid flow patterns, or extent of reaction. In a single batch reactor, “zones” are operating regimes in time, rather than in space. There are not necessarily abrupt transitions from one zone to another zone. For example, the boundary between the preheating zone and pyrolysis zone can be somewhat arbitrary; some amount of pyrolysis can take place in a portion of the preheating zone, and some amount of “preheating” can continue to take place in the pyrolysis zone. The temperature profile in the reactor is typically continuous, including at zone boundaries within the reactor.

As used herein, a “reagent” is a material in its broadest sense; a reagent can be a fuel, a chemical, a material, a compound, an additive, a blend component, a solvent, and so on. A reagent is not necessarily a chemical reagent that causes or participates in a chemical reaction. A reagent can or can not be a chemical reactant; it can or can not be consumed in a reaction. A reagent can be a chemical catalyst for a particular reaction. A reagent can cause or participate in adjusting a mechanical, physical, or hydrodynamic property of a material to which the reagent can be added. For example, a reagent can be introduced to a metal to impart certain strength properties to the metal. A reagent can be a substance of sufficient purity (which, in the current context, is typically carbon purity) for use in chemical analysis or physical testing.

As used herein, a “derivative” is a compound, molecule, or ion that is derived from another substance by a chemical reaction. The substance from which the derivative is derived is an additive. A derivative is also an additive.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness can in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, a “product” can be a composition, a material, an object, or a structure, for example. The term “product” shall not be limited by its commercial fate, such as whether it is sold, stored, traded, further processed, sold to another party as an intermediate for further processing, etc.

As used herein, “high-carbon” indicates a relatively high carbon content as compared to the initial feedstock utilized to produce a high-carbon biogenic reagent. Typically, a high-carbon biogenic reagent will comprise at least about half its weight as carbon. More typically, a high-carbon biogenic reagent will comprise at least 55 wt %, 60 wt %, 65 wt %, 70 wt %, or greater carbon.

Notwithstanding the foregoing, as used herein, the term “high-carbon biogenic reagent” indicates materials that can be produced by processes and systems as disclosed, in various embodiments. Limitations as to carbon content, or any other concentrations, shall not be imputed from the term itself but rather only by reference to particular embodiments and equivalents thereof. For example it will be appreciated that a starting material having very low carbon content, subjected to the disclosed processes, can produce a high-carbon biogenic reagent that is highly enriched in carbon relative to the starting material (high yield of carbon), but nevertheless relatively low in carbon (low purity of carbon), including less than 50 wt % carbon.

For purposes of an enabling technical disclosure, various explanations, hypotheses, theories, speculations, assumptions, and so on are disclosed. The present invention does not rely on any of these being in fact true. None of the explanations, hypotheses, theories, speculations, or assumptions in this detailed description shall be construed to limit the scope of the invention in any way.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

Some variations of the invention provide a biomedia composition comprising:
from about 50 wt % to about 75 wt % total carbon, on a dry basis, according to an ASTM D5373 ultimate analysis of the biomedia composition, wherein the total carbon is at least 50% renewable according to an ASTM D6866 measurement of the ¹⁴C/¹²C isotopic ratio of the total carbon;
from about 20 wt % to about 40 wt % oxygen, on a dry basis, according to the ASTM D5373 ultimate analysis of the biomedia composition;
from about 3 wt % to about 10 wt % hydrogen, on a dry basis, according to the ASTM D5373 ultimate analysis of the biomedia composition; and
from about 0.1 wt % to about 2 wt % nitrogen, on a dry basis, according to the ASTM D5373 ultimate analysis of the biomedia composition,
wherein the biomedia composition is characterized by a volatile-matter content from about 50 wt % to about 75 wt %, according to an ASTM D3175 proximate analysis of the biomedia composition;
wherein the biomedia composition is characterized by an ash content from about 1 wt % to about 25 wt %, according to an ASTM D3174 proximate analysis of the biomedia composition; and
wherein the biomedia composition is characterized by a moisture content from 0 to about 75 wt %, according to an ASTM D3173 proximate analysis of the biomedia composition.

In some embodiments, the biomedia composition comprises from about 55 wt % to about 70 wt % total carbon, on a dry basis, according to the ASTM D5373 ultimate analysis of the biomedia composition. In certain embodiments, the biomedia composition comprises from about 60 wt % to about 65 wt % total carbon, on a dry basis, according to the ASTM D5373 ultimate analysis of the biomedia composition.

In some embodiments, the total carbon is at least 80% renewable according to the ASTM D6866 measurement of the ¹⁴C/¹²C isotopic ratio of the total carbon. In certain embodiments, the total carbon is at least 90% (e.g., 100%) renewable according to the ASTM D6866 measurement of the ¹⁴C/¹²C isotopic ratio of the total carbon.

In some embodiments, the biomedia composition comprises from about 25 wt % oxygen to about 35 wt % oxygen, on a dry basis, according to the ASTM D5373 ultimate analysis of the biomedia composition.

In some embodiments, the biomedia composition comprises from about 5 wt % to about 8 wt % hydrogen, on a dry basis, according to the ASTM D5373 ultimate analysis of the biomedia composition.

In some embodiments, the biomedia composition comprises from about 0.5 wt % to about 1 wt % nitrogen, on a dry basis, according to the ASTM D5373 ultimate analysis of the biomedia composition. Additionally, or alternatively, the biomedia composition can comprises phosphorus, potassium, sulfur, or a combination thereof.

Nitrogen is a critical nutrient for plant growth. Nitrogen is part of the chlorophyll molecule, which gives plants their green color and is involved in creating food for the plant through photosynthesis. Nitrogen is also the primary building block for plant protoplasm. Protoplasm is the translucent substance that is the living matter in cells. It is needed for flower differentiation, speedy shoot growth, and the health of flower buds, for example.

Phosphorus, potassium, and sulfur are also important nutrients for plant growth. Phosphorus is an essential nutrient in several plant structure compounds and functions as a catalyst in numerous biochemical reactions in plants, including photosynthesis. Phosphorus is also a vital component of DNA and RNA; the structures of both DNA and RNA are linked together by phosphorus bonds. Potassium is classified as a macronutrient because plants take up large quantities of potassium during their life cycle. Plants deficient in potassium are less resistant to drought, excess water, and high and low temperatures. Plants deficient in potassium are also less resistant to pests, diseases, and nematode attacks. Sulfur is another essential nutrient that is required for the adequate growth and development of plants. Sulfur is a structural component of protein disulfide bonds, amino acids, vitamins, and cofactors.

When the biomedia composition contains nitrogen, phosphorus, potassium, or sulfur, the biomedia composition can function as a fertilizer for soil or another substrate into which the biomedia composition is placed.

In some embodiments, the biomedia composition contains less than 1 ppm mercury. The biomedia composition can be essentially free of mercury.

In some embodiments, the biomedia composition further comprises one or more additives. Additives can be introduced for a wide variety of reasons, including both functional (e.g., for pH optimization) as well as ornamental (e.g., color). Additives can be used to enhance the water absorbency, nutrient absorbency, or aeration potential of the biomedia composition, for example.

In some embodiments, the biomedia composition is characterized by a volatile-matter content from about 55 wt % to about 75 wt %, according to an ASTM D3175 proximate analysis of the biomedia composition. In various embodiments, the biomedia composition is characterized by a volatile-matter content of about, at least about, or at most about 50, 55, 60, 65, 70, or 75 wt %, including any intervening ranges, according to the ASTM D3175 proximate analysis of the biomedia composition.

In some embodiments, the biomedia composition is characterized by an ash content from about 2 wt % to about 20 wt %, according to an ASTM D3174 proximate analysis of the biomedia composition. In various embodiments, the biomedia composition is characterized by an ash content of about, at least about, or at most about 1, 2, 3, 4, 5, 6, 7, 8, 9, 10, 15, 20, or 25 wt %, including any intervening ranges, according to an ASTM D3174 proximate analysis of the biomedia composition.

In some embodiments, the biomedia composition is characterized by a moisture content from 10 wt % to about 50 wt %, according to an ASTM D3173 proximate analysis of the biomedia composition. In various embodiments, the biomedia composition is characterized by an ash content of about, at least about, or at most about 0, 0.5, 1, 2, 3, 4, 5, 6, 7, 8, 9, 10, 15, 20, 25, 30, 35, 40, 45, 50, 55, 60, 65, 70, or 75 wt %, including any intervening ranges, according to an ASTM D3173 proximate analysis of the biomedia composition.

Generally speaking, the fixed-carbon content of the biomedia composition is defined as 100 wt % minus the sum of volatile matter, ash, and moisture. As an example, a biomedia composition with 50 wt % volatile matter, 10 wt % moisture, and 5 wt % ash has a fixed-carbon content of 100−50−10−5=35 wt %.

In some embodiments, the biomedia composition is hydrophilic. In other embodiments, the biomedia composition is hydrophobic or moderately hydrophobic.

In certain embodiments, the biomedia composition is amphipathic. An amphipathic biomedia composition has hydrophilic and hydrophobic regions. For example, there can be a region with a relatively high concentration of hydrophilic —OH, —COOH, or —CHO groups as well as a hydrophobic carbon-rich region. An amphipathic biomedia composition can arise, without being limited by theory, when mild pyrolysis partially converts hydrophilic biomass to a hydrophobic material, such as via conversion of —OH and —COOH groups to aliphatic and aromatic groups. The pyrolysis conditions can be adjusted to tune the degree of hydrophilicity or hydrophobicity of the biomedia composition.

The biomedia composition can be characterized by an equilibrium moisture content defined according to ASTM D1412. The equilibrium moisture content can be from 0 to about 90 wt %, such as from about 25 wt % to about 75 wt % water. A higher equilibrium moisture content typically means that the biomedia composition has a high water-absorption capacity. For many commercial applications of the biomedia composition, a high water-absorption capacity is desirable, to enable better penetration of soil nutrients, for example.

In some embodiments, the biomedia composition is in the form of fine particulates. The fine particulates can have an average particle size from about 10 microns to about 1000 microns, such as about, at least about, or at most about 10, 20, 30, 40, 50, 75, 100, 200, 300, 400, 500, 600, 700, 800, 900, or 1000 microns, including any intervening ranges. The fine particulates can be spherical or non-spherical. In the case of spheres, the particle size refers to the diameter; in the case of other geometries for the fine particulates, the particle size refers to the equivalent diameter, which is the diameter of a sphere of equivalent volume as the non-spherical particulate.

In some embodiments, the biomedia composition is in the form of fibrous particles. For some applications, a fibrous biomedia composition is preferred over fine particulates. For example, a biomedia composition with a low fines/particulates level can be desirable to avoid dust-related health and safety (e.g., fire) hazards.

When the biomedia composition is in the form of fibrous particles, they can have an average fiber length from about 100 microns to about 100 millimeters, such as about, at least about, or at most about 100, 200, 300, 400, 500, 600, 700, 800, 900, or 1000 microns, or about, at least about, or at most about 1, 2, 5, 10, 15, 20, 25, 30, 40, 50, 60, 70, 80, 90, or 100 millimeters, including any intervening ranges. The fibrous particles can have an average fiber diameter from about 1 micron to about 1000 microns, such as about, at least about, or at most about 1, 2, 5, 10, 15, 20, 25, 50, 75, 100, 150, 200, 250, 300, 400, 500, 600, 700, 800, 900, or 1000 microns, including any intervening ranges.

In some embodiments, the biomedia composition is in the form of a mixture of fine particulates and fibrous particles. When there is a mixture, the fine particulates can have an average particle size from about 10 microns to about 1000 microns, such as about, at least about, or at most about 10, 20, 30, 40, 50, 75, 100, 200, 300, 400, 500, 600, 700, 800, 900, or 1000 microns, including any intervening ranges; and the fibrous particles can have an average fiber length from about 100 microns to about 100 millimeters, such as about, at least about, or at most about 100, 200, 300, 400, 500, 600, 700, 800, 900, or 1000 microns, or about, at least about, or at most about 1, 2, 5, 10, 15, 20, 25, 30, 40, 50, 60, 70, 80, 90, or 100 millimeters, including any intervening ranges, and the fibrous particles can have an average fiber diameter from about 1 micron to about 1000 microns, such as about, at least about, or at most about 1, 2, 5, 10, 15, 20, 25, 50, 75, 100, 150, 200, 250, 300, 400, 500, 600, 700, 800, 900, or 1000 microns, including any intervening ranges. The biomedia composition in the form of a mixture can contain a weight ratio of fine particulates to fibrous particles from about 0.01 to about 100, such as about, at least about, or at most about 0.01, 0.02, 0.05, 0.1, 0.2, 0.3, 0.4, 0.5, 0.6, 0.7, 0.8, 0.9, 1, 2, 3, 4, 5, 10, 15, 20, 25, 30, 40, 50, 60, 70, 80, 90, or 100, including any intervening ranges.

When the biomedia composition contains fibrous particles, the fibrous particles can contain multiple length scales in a hierarchical structure. For example, a fibrous particle can be characterized by fibers having a primary length and diameter, wherein the fiber structurally contains smaller, fine fibrils attached to the main fiber, typically disposed at random angles relative to the surface of the fiber. In materials science, this type of hierarchical morphology is known as a “hairy” structure. In such a hierarchical structure, the primary fibers can have an average primary-fiber length from about 100 microns to about 100 millimeters, such as about, at least about, or at most about 100, 200, 300, 400, 500, 600, 700, 800, 900, or 1000 microns, or about, at least about, or at most about 1, 2, 5, 10, 15, 20, 25, 30, 40, 50, 60, 70, 80, 90, or 100 millimeters, including any intervening ranges, and the primary fibers can have an average primary-fiber diameter from about 1 micron to about 1000 microns, such as about, at least about, or at most about 1, 2, 5, 10, 15, 20, 25, 50, 75, 100, 150, 200, 250, 300, 400, 500, 600, 700, 800, 900, or 1000 microns, including any intervening ranges; while the fine fibrils (attached to the primary fibers) can have an average fine-fibril length from about 100 nanometers to about 100 microns, such as about, at least about, or at most about 100, 200, 300, 400, 500, 600, 700, 800, 900, or 1000 nanometers, or about, at least about, or at most about 1, 2, 5, 10, 15, 20, 25, 30, 40, 50, 60, 70, 80, 90, or 100 microns, for example.

In some embodiments, the biomedia composition is in the form of a densified object. Exemplary densified objects include pellets, sheets, mats, bricks, blocks, blankets, and sponges. The bulk density of the densified object containing the biomedia composition can be from about 1.0 g/cm³ to about 2.0 g/cm³, such as about, at least about, or at most about 1.0, 1.1, 1.2, 1.3, 1.4, 1.5, 1.6, 1.7, 1.8, 1.9, or 2.0 g/cm³, including any intervening ranges. A characteristic length scale of the densified object (e.g., the diameter or effective diameter, or the length) can be from about 1 millimeter to about 1 meter, such as from about 1 centimeter to about 100 centimeters. An exemplary densified object that has a length scale on the order of 1 meter is a bale of the biomedia composition, such as for storage or shipping.

There are many embodiments in which a biomedia composition in the form of a densified object is shipped, stored, and potentially used directly or mechanical de-densified and then used. In one embodiment, loose pellets of the biomedia composition are applied to a field and then, under ordinary weather (e.g., wind and rain), the pellets fall apart to form fine particulates or fibrous particles that then penetrate the soil matrix. In another application, pertaining to replacing a conventional feedstock to a peat boiler, strong pellets (such as pellets containing a binder) can be fabricated and then fed to the peat boiler. Similar embodiments can utilize the biomedia composition in the form of pellets or other densified objects to feed a peat gasifier.

When the biomedia composition is in the form of a biomedia pellet, the size and geometry of the biomedia pellet can vary. By “pellet” as used herein, it is meant an agglomerated object rather than a loose powder. The pellet geometry is not limited to spherical or approximately spherical. Also, in this disclosure, “pellet” is synonymous with “briquette,” “granule,” and “prill.” The pellet geometry can be spherical (round or ball shape), cube (square), octagon, hexagon, honeycomb/beehive shape, oval shape, egg shape, column shape, bar shape, disk shape, pillow shape, random shape, or a combination thereof. For convenience of disclosure, the term “pellet” will generally be used for any object containing a powder agglomerated, optionally with a binder.

The biomedia pellets can be characterized by an average pellet diameter, which is the true diameter in the case of a sphere, or an equivalent diameter in the case of any other 3D geometry. The equivalent diameter of a non-spherical pellet is the diameter of a sphere of equivalent volume to the actual pellet. In some embodiments, the average pellet diameter is about, or at least about, 1, 2, 3, 4, 5, 6, 7, 8, 9, 10, 11, 12, 13, 14, 15, 20, or 25 millimeters, including all intervening ranges. In some embodiments, the average pellet diameter is about, or at least about, 500, 1000, 1500, 2000, 2500, 3000, 3500, 4000, 4500, 5000, 5500, 6000, or 6500 microns, including all intervening ranges.

In some embodiments, there is a plurality of biomedia pellets that are relatively uniform in size, such as a standard deviation of less than ±100%, less than ±50%, less than ±25%, less than ±10%, or less than ±5% of the average pellet diameter. In other embodiments, there is a wide range of sizes of biomedia pellets, as this can be advantageous in some applications.

In some embodiments, the biomedia composition has a biomedia pH selected from about 4 to about 8. In certain embodiments, the biomedia composition has a biomedia pH selected from about 5 to about 7. In various processes, the biomedia pH is about, at least about, or at most about 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, including any intervening ranges (e.g., 4.8-7.2, 5.3-6.9, etc.). The biomedia pH can be measured by adding two volumes of water to one volume of biomedia composition and then measuring the pH of the liquid solution following 25° C. extraction for 10 minutes from the solid biomedia composition. Alkaline additives can be added to the biomedia composition to raise the pH to a desired range, such as from about 6.5 to about 7.5, for example.

Cationic exchange capacity (CEC) has been used historically to describe the buffering capacity of soil. Buffering gives a resistance to change in pH or nutrient concentration in the soil solution. A medium that is high in CEC helps growers maintain a stable pH or nutrient concentration over time. Biomedia particles that have negatively charged “exchange sites” allow the particles to loosely hold onto positively charged cations including H⁺, NH₄⁺, Ca²⁺, Mg²⁺, K⁺, and Na⁺, for example. Biomedia particles with high CEC have the ability to absorb and release large amounts of cations from the soil (or other matrix) solution. In some embodiments, the biomedia composition has a cationic exchange capacity selected from about 50 to about 200 meq/100 g, such as from about 80 to about 150 meq/100 g, or from about 100 to about 125 meq/100 g.

In some embodiments, the biomedia composition is characterized by a base-acid ratio defined by the following formula:

$$Base - Acid Ratio = \frac{{Fe}_{2} {O}_{3} + CaO + MgO + {K}_{2} O + {Na}_{2} O}{{SiO}_{2} + {Al}_{2} {O}_{3} + {TiO}_{2}}$$

wherein each of the Fe₂O₃, CaO, MgO, K₂O, Na₂O, SiO₂, Al₂O₃, and TiO₂ correspond to weight percentages in the biomedia composition pursuant to ASTM D4326. In some embodiments, the base-acid ratio is selected from about 0.5 to about 10. In certain embodiments, the base-acid ratio is selected from about 1 to about 10, or from about 1 to about 5, or about 5 to about 10. In some embodiments, the base-acid ratio is selected from about 0.1 to about 0.4, or from about 0.5 to about 10, or from about 0.8 to about 10, or from about 1.5 to about 5, or from about 0.4 to about 0.7. In certain embodiments, the base-acid ratio is less than 0.4 or greater than 0.7.

In some embodiments, the biomedia composition is characterized by an expanded base-acid ratio defined by the following formula:

$$Expanded Base - Acid Ratio = \frac{{Fe}_{2} {O}_{3} + CaO + MgO + {K}_{2} O + {Na}_{2} O + MnO + SrO + BaO}{{SiO}_{2} + {Al}_{2} {O}_{3} + {TiO}_{2} + {P}_{2} {O}_{5} + {SO}_{3}}$$

wherein each of the Fe₂O₃, CaO, MgO, K₂O, Na₂O, MnO, SrO, BaO, SiO₂, Al₂O₃, TiO₂, P₂O₅, and SO₃ correspond to weight fractions in the biomedia composition pursuant to ASTM D4326, and wherein the expanded base-acid ratio is selected from about 0.25 to about 8. In certain embodiments, the expanded base-acid ratio is selected from about 0.5 to about 8, or from about 1 to about 4, or from about 4 to about 8. In some embodiments, the expanded base-acid ratio is selected from about 0.1 to about 0.4, or from about 0.5 to about 10, or from about 0.8 to about 10, or from about 1.5 to about 5, or from about 0.4 to about 0.7. In certain embodiments, the expanded base-acid ratio is less than 0.4 or greater than 0.7.

In some embodiments, the biomedia composition itself is biologically sterile. A biologically sterile biomedia composition is substantially free of bacteria, fungi, and weed seeds that could harm plants. Other organic matter (e.g., compost) carries the risk of contaminating soil with various pathogens.

In some embodiments, the biomedia composition is biodegradable. In this specification, a biodegradable biomedia composition is capable of breaking down to environmentally acceptable products such as water, carbon dioxide, and humus by the action of naturally available microorganisms under normal environmental conditions.

In some embodiments, the biomedia composition is compostable. In this specification, a compostable biomedia composition meets the specifications for compostability defined in ASTM D6400, which is hereby incorporated by reference herein.

Other variations of the invention provide a process for producing a biomedia composition, the process comprising:
(a) providing a starting feedstock containing biomass, wherein the starting feedstock is optionally dried;
(b) mildly pyrolyzing the starting feedstock to generate an intermediate biocarbon stream and a pyrolysis vapor;
(c) optionally washing or treating the intermediate biocarbon stream with an acid, a base, a salt, a metal, H₂, H₂O, CO, CO₂, or a combination thereof, to adjust acidity of the intermediate biocarbon stream; and
(d) recovering a biomedia composition containing:
from about 50 wt % to about 75 wt % total carbon, on a dry basis, according to an ASTM D5373 ultimate analysis of the biomedia composition, wherein the total carbon is at least 50% renewable according to an ASTM D6866 measurement of the ¹⁴C/¹²C isotopic ratio of the total carbon;
from about 20 wt % to about 40 wt % oxygen, on a dry basis, according to the ASTM D5373 ultimate analysis of the biomedia composition;
from about 3 wt % to about 10 wt % hydrogen, on a dry basis, according to the ASTM D5373 ultimate analysis of the biomedia composition; and
from about 0.1 wt % to about 2 wt % nitrogen, on a dry basis, according to the ASTM D5373 ultimate analysis of the biomedia composition,
wherein the biomedia composition is characterized by a volatile-matter content from about 50 wt % to about 75 wt %, according to an ASTM D3175 proximate analysis of the biomedia composition;
wherein the biomedia composition is characterized by an ash content from about 1 wt % to about 25 wt %, according to an ASTM D3174 proximate analysis of the biomedia composition; and
wherein the biomedia composition is characterized by a moisture content from 0 to about 75 wt %, according to an ASTM D3173 proximate analysis of the biomedia composition.

Some variations of the invention provide a process for producing a biomedia composition, the process comprising:
(a) providing a starting feedstock containing biomass, wherein the starting feedstock is optionally dried;
(b) mildly pyrolyzing the starting feedstock to generate an intermediate biocarbon stream and a pyrolysis vapor;
(c) optionally introducing one or more additives during step (a) or step (b), to adjust the acidity of the intermediate biocarbon stream; and
(d) recovering a biomedia composition containing:
from about 50 wt % to about 75 wt % total carbon, on a dry basis, according to an ASTM D5373 ultimate analysis of the biomedia composition, wherein the total carbon is at least 50% renewable according to an ASTM D6866 measurement of the ¹⁴C/¹²C isotopic ratio of the total carbon;
from about 20 wt % to about 40 wt % oxygen, on a dry basis, according to the ASTM D5373 ultimate analysis of the biomedia composition;
from about 3 wt % to about 10 wt % hydrogen, on a dry basis, according to the ASTM D5373 ultimate analysis of the biomedia composition; and
from about 0.1 wt % to about 2 wt % nitrogen, on a dry basis, according to the ASTM D5373 ultimate analysis of the biomedia composition,
wherein the biomedia composition is characterized by a volatile-matter content from about 50 wt % to about 75 wt %, according to an ASTM D3175 proximate analysis of the biomedia composition;
wherein the biomedia composition is characterized by an ash content from about 1 wt % to about 25 wt %, according to an ASTM D3174 proximate analysis of the biomedia composition; and
wherein the biomedia composition is characterized by a moisture content from 0 to about 75 wt %, according to an ASTM D3173 proximate analysis of the biomedia composition.

In some processes, the biomass is selected from softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or combinations thereof.

In some processes, the intermediate biocarbon stream is mechanically shredded. Alternatively, or additionally, the biomedia composition can be mechanically shredded. In these or other processes, the intermediate biocarbon stream can be mechanically fluffed. Alternatively, or additionally, the biomedia composition can be mechanically fluffed.

Mechanical treatment can be useful to add porosity, surface area, or hierarchical particle sizes to the biomedia composition. A mechanical apparatus such as a shredder can be utilized to form fibrous strands. Other mechanical apparatus include, but are not limited to, a hammer mill, an extruder, an attrition mill, a disk mill (e.g., with a single disk or double disks), a pin mill, a ball mill, a cone crusher, a jaw crusher, a pulp refiner, a defibrator, and combinations thereof, for example.

In general, the intermediate biocarbon stream or the biomedia composition can be treated. In this specification, “treatment,” “treated” and the like refer to chemical modification, physical modification, the use of additives, or a combination thereof.

In some processes, the intermediate biocarbon stream or the biomedia composition is treated to alter porosity of the biomedia composition. For example, injection of a gas through a bed of biomedia composition can be used to create porosity.

In some processes, the intermediate biocarbon stream or the biomedia composition is treated to alter solid flowability of the biomedia composition. Solid flowability can be a practical feature of the biomedia composition, enabling it to be easily packed into containers for shipment and storage, and then easily applied to a soil or other matrix.

In some processes, the biomedia composition is treated to adjust chemical oxygen demand of the biomedia composition. For example, an organic chemical substrate (e.g., glycerol, ethanol, or monomeric sugars) can be introduced as an additive to the biomedia composition.

In some processes, the biomedia composition is treated to adjust color of the biomedia composition. For example, an organic dye can be incorporated into the biomedia composition. In certain embodiments, the organic dye itself is a plant extract, such as an extract of madder root (reds), indigo (blues), and weld (yellows).

In some processes, the biomedia composition is treated to adjust odor of the biomedia composition. An additive can be incorporated that imparts a desirable odor, such as a botanical extract functioning as a fragrance. Alternatively, or additionally, an additive can be incorporated that that removes or masks an odor associated with the biomedia composition.

In some processes, the biomedia composition is treated to adjust texture of the biomedia composition. For example, the biomedia composition can be mechanically treated to enhance the texture (feel) of the product. Alternatively, or additionally, an additive (e.g., cellulose fibers, straw, sand, or silt) can be incorporated to adjust the texture of the biomedia composition.

In various processes, the biomedia composition comprises from about 55 wt % to about 70 wt % total carbon, on a dry basis, according to the ASTM D5373 ultimate analysis of the biomedia composition. In certain processes, the biomedia composition comprises from about 60 wt % to about 65 wt % total carbon, on a dry basis, according to the ASTM D5373 ultimate analysis of the biomedia composition.

In some processes, the total carbon is at least 80% renewable according to the ASTM D6866 measurement of the ¹⁴C/¹²C isotopic ratio of the total carbon. In certain processes, the total carbon is at least 90%, at least 95%, or 100% renewable according to the ASTM D6866 measurement of the ¹⁴C/¹²C isotopic ratio of the total carbon.

In some processes, the biomedia composition comprises from about 25 wt % oxygen to about 35 wt % oxygen, on a dry basis, according to the ASTM D5373 ultimate analysis of the biomedia composition.

In some processes, the biomedia composition comprises from about 5 wt % to about 8 wt % hydrogen, on a dry basis, according to the ASTM D5373 ultimate analysis of the biomedia composition.

In some processes, the biomedia composition comprises from about 0.5 wt % to about 1 wt % nitrogen, on a dry basis, according to the ASTM D5373 ultimate analysis of the biomedia composition.

In some processes, the biomedia composition comprises phosphorus, potassium, sulfur, or a combination thereof.

In some processes, the biomedia composition contains less than 1 ppm mercury. In certain processes, the biomedia composition is essentially free of mercury.

In some processes, the biomedia composition is characterized by a volatile-matter content from about 60 wt % to about 70 wt %, according to the ASTM D3175 proximate analysis of the biomedia composition.

In some processes, the biomedia composition is characterized by an ash content from about 2 wt % to about 20 wt %, according to the ASTM D3174 proximate analysis of the biomedia composition.

In some processes, the biomedia composition is characterized by a moisture content from 10 wt % to about 50 wt %, according to the ASTM D3173 proximate analysis of the biomedia composition.

In some processes, the biomedia composition is hydrophilic. In other processes, the biomedia composition is hydrophobic. In certain processes, the biomedia composition is amphipathic.

In some processes, the biomedia composition is in the form of fine particulates. In other processes, the biomedia composition is in the form of fibrous particles, or a mixture of fibrous particles and fine particulates. In still other processes, the biomedia composition is in the form of a densified object.

In some processes, step (c) is not performed. Step (c) can be omitted, for example, when the pH of the final biomedia composition is already in an acceptable range for an intended product application.

In other processes, step (c) is performed. When step (c) is done, such as for pH optimization, the step can comprise washing or treating the intermediate biocarbon stream with an acid, a base, a salt, a metal, H₂, H₂O, CO, CO₂, or a combination thereof, to adjust acidity of the intermediate biocarbon stream, as well as introducing one or more additives during step (a) or step (b), to adjust the acidity of the intermediate biocarbon stream, if desired.

In some processes, the biomedia composition has a biomedia pH selected from about 4 to about 8, such as a biomedia pH selected from about 5 to about 7. In various processes, the selected biomedia pH is about, at least about, or at most about 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, including any intervening ranges (e.g., 4.5-7.0, 5.5-6.8, etc.).

In some processes, the biomedia composition has a cationic exchange capacity selected from about 50 to about 200 meq/100 g, such as from about 80 to about 150 meq/100 g, or from about 100 to about 125 meq/100 g.

In some processes, the biomedia composition is characterized by a base-acid ratio defined by the following formula:

$$Base - Acid Ratio = \frac{{Fe}_{2} {O}_{3} + CaO + MgO + {K}_{2} O + {Na}_{2} O}{{SiO}_{2} + {Al}_{2} {O}_{3} + {TiO}_{2}}$$

wherein each of the Fe₂O₃, CaO, MgO, K₂O, Na₂O, SiO₂, Al₂O₃, and TiO₂ correspond to weight percentages in the biomedia composition pursuant to ASTM D4326, and wherein the base-acid ratio is selected from about 0.5 to about 10, such as from about 1 to about 10, or from about 1 to about 5, or from about 5 to about 10.

In some processes, the biomedia composition is characterized by an expanded base-acid ratio defined by the following formula:

$$Expanded Base - Acid Ratio = \frac{{Fe}_{2} {O}_{3} + CaO + MgO + {K}_{2} O + {Na}_{2} O + MnO + SrO + BaO}{{SiO}_{2} + {Al}_{2} {O}_{3} + {TiO}_{2} + {P}_{2} {O}_{5} + {SO}_{3}}$$

wherein each of the Fe₂O₃, CaO, MgO, K₂O, Na₂O, MnO, SrO, BaO, SiO₂, Al₂O₃, TiO₂, P₂O₅, and SO₃ correspond to weight fractions in the biomedia composition pursuant to ASTM D4326, and wherein the expanded base-acid ratio is selected from about 0.25 to about 8, such as from about 0.5 to about 8, or from about 1 to about 4, or from about 4 to about 8.

In some processes, the biomedia composition is biologically sterile. In some processes, the biomedia composition is biodegradable. In some processes, the biomedia composition is compostable.

The process can be continuous, semi-continuous, or a batch process. In some processes, for example, mild pyrolysis of the starting feedstock is performed in a continuous pyrolysis reactor to generate an intermediate biocarbon stream that is recovered. Then, the intermediate biocarbon stream is washed or treated in a batch process to generate a biomedia composition that is recovered.

With reference to the base-acid ratio, Fe₂O₃, CaO, MgO, K₂O, Na₂O, SiO₂, Al₂O₃, and TiO₂ concentrations are those in the ash fraction following sample combustion, pursuant to ASTM D4326-13 “Standard Test Method for Major and Minor Elements by XRF,” which is hereby incorporated by reference in its entirety and is referred to herein as “ASTM D4326.”

ASTM D4326 is a test method that covers the analysis of the commonly determined major and minor elements in ash from a carbon sample using X-ray fluorescence (XRF) techniques. The carbon to be analyzed is ashed under standard conditions and ignited to constant weight. Previously ashed materials are ignited to constant weight under standard conditions. The ash is fused with lithium tetraborate (Li₂B₄O₇) or other suitable flux and either ground and pressed into a pellet or cast into a glass disk. The pellet or disk is then irradiated by an X-ray beam of short wavelength. The characteristic X-rays of the atom that are emitted or fluoresced upon absorption of the primary or incident X-rays are dispersed and intensities at selected wavelengths are measured by sensitive detectors. Detector output is related to concentration by calibration curves or by computerized data-handling equipment. The K spectral lines are used for all of the elements determined by this procedure. All elements are determined as the element and reported as the oxide and include Si, Al, Fe, Ca, Mg, Na, K, P, Ti, Mn, Sr, and Ba. A compositional analysis of ash is used in describing the quality of biocarbon for its complete characterization. Ash composition is useful in predicting slagging and fouling characteristics of combusted materials as well as the potential utilization in various commercial applications.

In this disclosure, a “compositional parameter” is any parameter that is a function of the biomedia composition or correlates with the biomedia composition. In some embodiments, a compositional parameter is determined according to ASTM D4326 and equations with inputs from the ASTM D4326 results.

In some embodiments, the biomedia composition described above is further characterized by an iron-calcium ratio defined by the Fe₂O₃ divided by the CaO, each as weight percentages in the biocarbon composition pursuant to ASTM D4326, wherein the iron-calcium ratio is selected from about 0.05 to about 5. In some embodiments, the iron-calcium ratio is selected from about 0.1 to about 2, or from about 0.3 to about 1. In certain embodiments, the iron-calcium ratio is less than 0.3 or greater than 3. In various embodiments, the iron-calcium ratio is about, at least about, or at most about 0.05, 0.1, 0.2, 0.3, 0.4, 0.5, 0.6, 0.7, 0.8, 0.9, 1, 1.5, 2, 2.5, 3, 3.1, 3.2, 3.3, 3.4, 3.5, 4, 4.5, or 5, including all intervening ranges.

In some embodiments, the biomedia composition described above is further characterized by an iron-plus-calcium parameter defined as the sum of the Fe₂O₃ and the CaO, each as weight percentages in the biomedia composition pursuant to ASTM D4326, and wherein the iron-plus-calcium parameter is selected from about 5 wt % to about 50 wt %. In various embodiments, the iron-plus-calcium parameter is about, at least about, or at most about 5, 10, 15, 20, 25, 30, 35, 40, 45, or 50 wt %, including all intervening ranges. In some embodiments, the iron-plus-calcium parameter is selected from about 10 wt % to about 40 wt %, or from about 20 wt % to about 50 wt %. In certain embodiments, the iron-plus-calcium parameter is less than 10 wt %. In other embodiments, the iron-plus-calcium parameter is greater than 10 wt %.

In some embodiments, the biomedia composition described above is further characterized by a slagging factor defined as a base-acid ratio multiplied by weight percentage of sulfur present in the biomedia composition on a dry basis, wherein the base-acid ratio is defined by the following formula:

$$Base - Acid Ratio = \frac{{Fe}_{2} {O}_{3} + CaO + MgO + {K}_{2} O + {Na}_{2} O}{{SiO}_{2} + {Al}_{2} {O}_{3} + {TiO}_{2}}$$

wherein each of the Fe₂O₃, CaO, MgO, K₂O, Na₂O, SiO₂, Al₂O₃, and TiO₂ correspond to weight percentages in the biomedia composition pursuant to ASTM D4326, and wherein the slagging factor is selected from about 0.001 to about 1. In some embodiments, the slagging factor is selected from about 0.01 to about 0.5, or from about 0.01 to about 0.1. In certain embodiments, the slagging factor is less than 0.6. In various embodiments, the slagging factor is about, at least about, or at most about 0.001, 0.002, 0.005, 0.01, 0.02, 0.03, 0.04, 0.05, 0.1, 0.2, 0.3, 0.4, 0.5, 0.55, 0.6, 0.65, 0.7, 0.75, 0.8, 0.9, 0.95, or 1, including all intervening ranges.

In some embodiments, the biomedia composition described above is further characterized by a fouling factor defined as a base-acid ratio multiplied by the Na₂O as weight percentage in the biocarbon composition pursuant to ASTM D4326, wherein the base-acid ratio defined by the following formula:

$$Base - Acid Ratio = \frac{{Fe}_{2} {O}_{3} + CaO + MgO + {K}_{2} O + {Na}_{2} O}{{SiO}_{2} + {Al}_{2} {O}_{3} + {TiO}_{2}}$$

wherein each of the Fe₂O₃, CaO, MgO, K₂O, Na₂O, SiO₂, Al₂O₃, and TiO₂ correspond to weight percentages in the biocarbon composition pursuant to ASTM D4326, and wherein the fouling factor is selected from about 0.1 to about 10. In some embodiments, the fouling factor is less than 2. In certain embodiments, the fouling factor is less than 1. Typically, a low fouling factor is desirable. However, in certain embodiments, a moderate or even high fouling factor is beneficial to form alkali-bonded deposits, such as when fabricating alkali-containing composites for high-pH biomedia applications. In various embodiments, the fouling factor is about, at least about, or at most about 0.1, 0.2, 0.5, 0.6, 0.7, 0.75, 0.8, 0.85, 0.9, 1, 1.2, 1.5, 1.8, 2, 2.5, 3, 3.5, 4, 5, 6, 7, 8, 9, or 10, including all intervening ranges.

In some embodiments, the biomedia composition described above is further characterized by a modified fouling factor defined as a base-acid ratio multiplied by water-soluble Na₂O, wherein the water-soluble Na₂O is weight percentage of Na₂O that leaches, in the presence of water, out of ash derived from the biomedia composition pursuant to ASTM D4326, wherein the base-acid ratio defined by the following formula:

$$Base - Acid Ratio = \frac{{Fe}_{2} {O}_{3} + CaO + MgO + {K}_{2} O + {Na}_{2} O}{{SiO}_{2} + {Al}_{2} {O}_{3} + {TiO}_{2}}$$

wherein each of the Fe₂O₃, CaO, MgO, K₂O, Na₂O, SiO₂, Al₂O₃, and TiO₂ correspond to weight percentages in the biomedia composition pursuant to ASTM D4326, and wherein the modified fouling factor is selected from about 0.1 to about 10. In some embodiments, the modified fouling factor is less than 2. In certain embodiments, the modified fouling factor is less than 1. In various embodiments, the modified fouling factor is about, at least about, or at most about 0.1, 0.2, 0.5, 0.6, 0.7, 0.75, 0.8, 0.85, 0.9, 1, 1.2, 1.5, 1.8, 2, 2.5, 3, 3.5, 4, 5, 6, 7, 8, 9, or 10, including all intervening ranges.

In some embodiments, the biomedia composition described above is characterized by an equilibrium moisture content according to ASTM D1412. The equilibrium moisture can be from about 1 wt % to about 50 wt %, such as about, at least about, or at most about 1, 2, 3, 4, 5, 6, 7, 8, 9, 10, 15, 20, 25, 30, 35, 40, 45, or 50 wt %, including all intervening ranges.

In some embodiments, the biomedia composition described above is further characterized by a silica percentage defined as weight percentage of the SiO₂ in the biocarbon composition pursuant to ASTM D4326. For example, the silica percentage can be selected from about 5 wt % to about 50 wt %. Note that the silica percentage is SiO₂ concentration in the ash (ashing test under ASTM D4326), not in the original biomedia composition. In certain embodiments, the silica percentage is selected from about 10 wt % to about 30 wt %. In various embodiments, the silica percentage is about, at least about, or at most about 5, 10, 15, 20, 25, 30, 35, 40, 45, or 50 wt %, including all intervening ranges.

In some embodiments, the biomedia composition described above is characterized by a low mercury content. The biomedia composition can comprise less than 100 ppm mercury (ppm=parts per million on weight basis), less than 10 ppm mercury, or can be essentially free of mercury. By “essentially free of mercury” it is meant that Hg or Hg-containing compounds are either absolutely zero (not present) or are below the detection limit of mercury when a sample is analyzed according to ASTM D6414-14, which is hereby incorporated by reference. In various embodiments, the biocarbon composition contains less than about 200, 150, 100, 90, 80, 70, 60, 50, 40, 30, 20, 10, 5, 4, 3, 2, 1, 0.5, 0.2, or 0.1 ppm mercury.

The biomedia composition can contain from about 10 wt % to about 50 wt % fixed carbon on an actual basis (with any moisture). In various embodiments, the biomedia composition contains about, at least about, or at most about 10, 15, 20, 25, 30, 35, 40, 45, or 50 wt % fixed carbon on an actual basis, including any intervening ranges.

The total carbon within the biomedia composition can be at least 90% renewable as determined from a measurement of the ¹⁴C/¹²C isotopic ratio of the total carbon. The total carbon within the biomedia composition can be at least 99% renewable as determined from a measurement of the ¹⁴C/¹²C isotopic ratio of the total carbon. The total carbon within the biomedia composition can be fully renewable as determined from a measurement of the ¹⁴C/¹²C isotopic ratio of the total carbon.

In certain embodiments, the biomedia composition is in the form of a pellet with a binder, and the binder comprises non-renewable carbon, where the remainder of the pellet comprises at least 50%, at least 90%, at least 95%, or 100% renewable carbon.

In certain embodiments, the biomedia composition is in the form of a pellet with a binder, and the binder comprises carbon that is at least 50%, at least 90%, at least 95%, or 100% renewable carbon, where the remainder of the pellet (i.e., not the binder) comprises at least 50%, at least 90%, at least 95%, or 100% renewable carbon. In some embodiments, essentially all of the carbon in the biomedia composition is fully renewable.

In certain embodiments, the biomedia composition comprises an additive, and the additive comprises non-renewable carbon, where the remainder of the biomedia composition comprises at least 50%, at least 90%, at least 95%, or 100% renewable carbon.

In certain embodiments, the biomedia composition comprises an additive, and the additive comprises carbon that is at least 50%, at least 90%, at least 95%, or 100% renewable carbon. The remainder of the biomedia composition (i.e., not the additive) can comprise at least 50%, at least 90%, at least 95%, or 100% renewable carbon. In certain biomedia compositions comprising additives, essentially all the carbon in the biomedia composition is fully renewable.

In this disclosure, 100% or “fully” renewable carbon allows for very minor adsorbed atmospheric CO₂ molecules that can have been derived from fossil fuels.

The biomedia composition can be in the form of a pellet. The pellet optionally contains a binder. The binder can be selected from starch, thermoplastic starch, crosslinked starch, starch polymers, cellulose, cellulose ethers, hemicellulose, methylcellulose, chitosan, lignin, lactose, sucrose, dextrose, maltodextrin, banana flour, wheat flour, wheat starch, soy flour, corn flour, wood flour, coal tars, coal fines, met coke, asphalt, coal-tar pitch, petroleum pitch, bitumen, pyrolysis tars, gilsonite, bentonite clay, borax, limestone, lime, waxes, vegetable waxes, baking soda, baking powder, sodium hydroxide, potassium hydroxide, iron ore concentrate, silica fume, gypsum, Portland cement, guar gum, xanthan gum, polyvidones, polyacrylamides, polylactides, phenol-formaldehyde resins, vegetable resins, recycled shingles, recycled tires, derivatives thereof, or any combinations of the foregoing, for example. In some embodiments, the pellet does not contain an externally added binder.

When there is an organic or inorganic binder, the base-acid ratio and other compositional parameters are based on the total material including the binder. For example, when a composition parameter is derived from ASTM D4326, the entire pellet is ashed.

The biomedia composition can be in the form of a powder, which can be a loose powder, a compacted powder, a granulated powder, or other form. In some embodiments, the powder is flowable.

The biomedia composition can be in the form of fibers, which can be a loose fibers, compacted fibers, or other form. In some embodiments, the fiber-containing biomedia composition is flowable.

When there is an organic or inorganic additive in the biomedia composition, the base-acid ratio and other compositional parameters are based on the total material including the additive. For example, when a composition parameter is derived from ASTM D4326, the entire sample is ashed.

In some embodiments of the biomedia composition with an optimized base-acid ratio or an optimized expanded base-acid ratio, the biomedia composition is characterized by an iron-calcium ratio defined by the Fe₂O₃ divided by the CaO, each as weight percentages in the biomedia composition pursuant to ASTM D4326, and wherein the iron-calcium ratio is selected from about 0.05 to about 5. The iron-calcium ratio can be selected from about 0.1 to about 2, or from about 0.3 to about 1, for example. In certain embodiments, the iron-calcium ratio is less than 0.3 or greater than 3.

In some embodiments of the biomedia composition with an optimized base-acid ratio or an optimized expanded base-acid ratio, the biomedia composition is characterized by an iron-plus-calcium parameter defined as the sum of the Fe₂O₃ and the CaO, each as weight percentages in the biomedia composition pursuant to ASTM D4326, and wherein the iron-plus-calcium parameter is selected from about 5 wt % to about 50 wt %. The iron-plus-calcium parameter can be selected from about 10 wt % to about 40 wt %, or from about 20 wt % to about 50 wt %, for example. In certain embodiments, the iron-plus-calcium parameter is less than 10 wt %. In other embodiments, the iron-plus-calcium parameter is greater than 10 wt %.

In some embodiments of the biomedia composition with an optimized base-acid ratio or an optimized expanded base-acid ratio, the biomedia composition is characterized by a slagging factor defined as the base-acid ratio multiplied by weight percentage of sulfur present in the biomedia composition on a dry basis, and wherein the slagging factor is selected from about 0.001 to about 1. The slagging factor can be selected from about 0.01 to about 0.5, or from about 0.01 to about 0.1, for example. In certain embodiments, the slagging factor is less than 0.6.

In some embodiments of the biomedia composition with an optimized base-acid ratio or an optimized expanded base-acid ratio, the biomedia composition is characterized by a fouling factor defined as the base-acid ratio multiplied by the Na₂O as weight percentage in the biomedia composition pursuant to ASTM D4326, and wherein the fouling factor is selected from about 0.1 to about 10. The fouling factor can be less than 2 or less than 1, for example.

In some embodiments of the biomedia composition with an optimized base-acid ratio or an optimized expanded base-acid ratio, the biomedia composition is characterized by a modified fouling factor defined as the base-acid ratio multiplied by water-soluble Na₂O, wherein the water-soluble Na₂O is weight percentage of Na₂O that leaches, in the presence of water, out of ash derived from the biomedia composition pursuant to ASTM D4326, and wherein the modified fouling factor is selected from about 0.1 to about 10. The modified fouling factor can be less than 2 or less than 1, for example.

In some embodiments of the biomedia composition with an optimized base-acid ratio or an optimized expanded base-acid ratio, the biomedia composition is characterized by a silica percentage defined as weight percentage of the SiO₂ in the biomedia composition pursuant to ASTM D4326, wherein the silica percentage is selected from about 5 wt % to about 50 wt %. The silica percentage can be selected from about 10 wt % to about 30 wt %, for example.

In some embodiments of the biomedia composition with an optimized base-acid ratio or an optimized expanded base-acid ratio, the biomedia composition is further characterized by an equilibrium moisture content according to ASTM D1412. The equilibrium moisture can be from about 1 wt % to about 50 wt %, such as about, at least about, or at most about 1, 2, 3, 4, 5, 6, 7, 8, 9, 10, 15, 20, 25, 30, 35, 40, 45, or 50 wt %, including all intervening ranges.

In certain embodiments of the biomedia composition comprising an optimized base-acid ratio or an optimized expanded base-acid ratio, the biomedia composition comprises less than 100 ppm mercury, comprises less than 10 ppm mercury, or is essentially free of mercury.

Any of the disclosed biomedia compositions can further contain one or more additives, such as (but not limited to) an additive selected from calcium, calcium oxide, calcium carbonate, magnesium oxide, magnesium carbonate, limestone, lime, dolomite, dolomitic lime, bentonite, gypsum, magnesium, manganese, aluminum, nickel, chromium, silicon, boron, cerium, molybdenum, phosphorus, tungsten, vanadium, iron chloride, iron bromide, iron ore concentrate, fluorite, fluorospar, sodium hydroxide, potassium hydroxide, magnesium oxide, hydrogen bromide, hydrogen chloride, sodium silicate, potassium permanganate, borax, silica, alumina, aluminosilicates, titanium, titanium dioxide, titanium carbide, titanium hydride, titanium nitride, or combinations thereof. When an additive is present, the additive can be selected to adjust any of the compositional parameters disclosed herein (e.g., biomedia pH, base-acid ratio, etc.). In some process embodiments, an additive is introduced in step (c). Alternatively, or additionally, an additive can be introduced elsewhere in the process, such as directly to the starting biomass, or injected into the mild-pyrolysis reactor.

In some process embodiments, step (c) selectively removes basic components, thereby reducing the Fe₂O₃, the CaO, the MgO, the K₂O, the Na₂O, or any other basic components present.

In some process embodiments, step (c) utilizes acidic water that is obtained from step (a), step (b), or another process step that is conducted prior to step (c). For example, acidic water can be obtained from condensation of the pyrolysis vapor to generate a condensed liquid having a pH from about 1 to about 7.

In some embodiments, step (c) selectively removes acidic components, thereby reducing the SiO₂, the Al₂O₃, the TiO₂, or any other acidic components present.

In some embodiments, step (c) utilizes alkaline water that is obtained from step (a), step (b), or another process step that is conducted prior to step (c).

In some embodiments, step (c) utilizes steam cleaning of the intermediate biocarbon stream, as a type of washing.

Any of the processes disclosed herein can be optimized to achieve pre-selected values or ranges for one or more compositional parameters discussed earlier. Any discussion of properties for biomedia compositions is hereby incorporated by reference into each instance of discussion of a process.

A process can be optimized to target a single compositional parameter (e.g., base-acid ratio), or more than one compositional parameter—e.g., 2, 3, 4, 5, 6, 7, 8, 9, 10 or more compositional parameters. It will be recognized that there is some covariance between certain compositional parameters, so that optimization of one will often influence another. For example, optimization of the base-acid ratio to achieve a selected value will influence the expanded base-acid ratio since many of the factors are the same (Fe₂O₃, SiO₂, etc.). Another example is fouling factor, which is a linear function of base-acid ratio, which means that a change to base-acid ratio will cause a change to fouling factor unless the Na₂O is adjusted in the other direction.

As will be appreciated by one skilled in the art, various process optimization methodologies can be undertaken. Examples include, but are not limited to, linear optimization, non-linear optimization, weighted optimization wherein certain compositional parameters are designated as more important, design and analysis of experiments, statistical process control, artificial intelligence, machine learning, and other techniques.

In certain embodiments, one or more compositional parameters are pre-selected based on an intended use of the biomedia composition. Then, a process to make the biomedia composition is optimized using process control to realize the pre-selected compositional parameters, within a prescribed tolerance. The process optimization can utilize the results of previous experiments or production campaigns, simulations, calculations, and analysis. For example, if a pre-selected base-acid ratio is 2.2, then the process can be designed using a wash treatment or an additive (or both) to target a continuous base-acid ratio set-point of 2.2±0.2 (a tolerance of about 10%). The controlled base-acid ratio can be biased such that higher numbers are more acceptable than lower numbers; e.g., the process can be designed using a wash treatment or an additive (or both) to target a continuous base-acid ratio set-point of 2.2+0.4/−0.1. In this disclosure, a compositional parameter can be a “pre-selected” compositional parameter when such parameter is selected in order to optimize a process to actually achieve the set-point via process control. Process control, in turn, preferably employs principles of process control such as feedback loops and proportional-integral-derivative logic programs.

The intended use of the biomedia composition can vary widely, beyond peat-like products. For example, the biomedia composition can be a solid fuel, a solid gasifier feedstock, a metallurgical-process input (for energy, for reduction chemistry, or for carbon content), a filtration media, an agricultural product (e.g., for supporting growth of a crop), a landscaping product (e.g., for enhancing grass growth), an animal-management product (e.g., animal bedding), or a precursor for another material, for example.

When the biomedia composition will ultimately be combusted or oxidized, either for energy production or as part of a metal-making process, it can be desired that the compositional parameters be optimized to avoid issues such as slagging and fouling in the reactors—e.g., lower base-acid ratio, slagging factor, and fouling factor. When the biomedia composition will be used as filtration media to remove acidic components, it can be desired that the compositional parameters be optimized to enhance neutralization of acids—e.g., higher base-acid ratio, and consequently, higher parameters that are linear functions of the base-acid ratio (e.g., fouling factor). When the biomedia composition will be used as a reducing agent in a metal-making process, it can be desired that the compositional parameters be optimized to balance acid and base content to achieve a desirable pH for the reduction chemistry, such as generation of Fe from FeO)—e.g., a moderate base-acid ratio. When the biomedia composition will be used as agricultural media, it can be desired that the compositional parameters be optimized to account for the soil into which the carbon will be placed, in order to select a base-acid ratio and other parameters.

In some embodiments, acid water washing is utilized to optimize one or more compositional parameters. The biomedia is produced by a non-combustion thermal process (e.g., pyrolysis) that converts starting biomass to biochar, gas, vapors, or liquids. The process can be configured such that water coming in with the starting feedstock as well as water generated during pyrolysis reactions is utilized in ways that displace some or all of the need for an external source of water.

When the starting feedstock is biomass, which contains biogenic and renewable carbon, the resulting carbon from mild pyrolysis is also biogenic. This can be shown from a measurement of the ¹⁴C/¹²C isotopic ratio of the carbon, using for example ASTM D6866. The total carbon within the biomedia composition can be at least 90% renewable as determined from a measurement of the ¹⁴C/¹²C isotopic ratio of the total carbon. In some embodiments, the total carbon within the biomedia composition is fully renewable as determined from a measurement of the ¹⁴C/¹²C isotopic ratio of the total carbon.

Any biogenic carbon that is oxidized to carbon dioxide creates biogenic CO₂. This also can be shown from a measurement of the ¹⁴C/¹²C isotopic ratio of the carbon in a sample of the generated CO₂. This biogenic CO₂, which is derived from biomass, returns to the environment to be taken up again by growing new biomass via photosynthesis. In this way, net CO₂ emissions are significantly reduced.

In the above or other embodiments, the biocarbon biomedia is characterized by a carbon intensity less than 0 kg CO₂e per metric ton of the biocarbon composition, such as a carbon intensity less than about −100, −200, −300, −400, or −500 kg CO₂e per metric ton of the biocarbon composition. The “carbon intensity” of a product (or a process) is the net quantity by weight of carbon dioxide generated per ton of product, or sometimes per ton of feedstock processed to make the product. A “CO₂-equivalent carbon intensity” can also be defined, as the net quantity of carbon dioxide equivalent generated per ton of product. The “carbon dioxide equivalent” or “CO₂e” signifies the amount of CO₂ which would have the equivalent global-warming impact. The typical units of carbon intensity are kilograms carbon dioxide equivalent per metric ton (1000 kg) of product.

A greenhouse gas (or “GHG”) is any gas in the atmosphere which absorbs and re-emits heat, and thereby keeps the planet's atmosphere warmer than it otherwise would be. The main GHGs in the Earth's atmosphere are water vapor, carbon dioxide, methane, nitrous oxide, and ozone. By convention, the global-warming potential of CO₂ is defined to be 1. The global-warming potential of CH₄ is about 30, i.e., methane is 30× more potent than CO₂ as a greenhouse gas. See “IPCC Fourth Assessment Report: Climate Change 2007,” Intergovernmental Panel on Climate Change, Cambridge University Press, Cambridge (2007), which is hereby incorporated by reference herein.

In order to calculate the carbon intensity of a product and process in general, the carbon intensities of the starting materials need to be estimated, as do the carbon intensities associated with the conversion of starting materials to intermediates, and the carbon intensities associated with the conversion of intermediates to final products. One skilled in the art of chemical engineering is able to make these calculations, which can be aided by software, such as life-cycle analysis software (e.g., GREET® or SimaPro® software).

It can be desired that known principles of life-cycle analysis are employed in calculating carbon intensity as well as water intensity. Life-cycle assessment (LCA) is a known method used to evaluate the environmental impact of a product through its life cycle, encompassing processing of the raw materials, manufacturing, distribution, use, recycling, and final disposal. When conducting an LCA, the fate of the final product usually needs to be specified. For example, in the case of steel, the steel often is installed such that it is place for long periods of time. In some embodiments, end-of-life options for the steel are considered, including industrial recycling options (steel is the most recycled material on the planet).

LCA also can consider the status quo regarding environmental inputs and outputs associated with a particular material. For example, forest residues that are not harvested will undergo decomposition that emits large quantities of methane, which causes a severe GHG penalty. If those forest residues are instead directed to production of biocarbon and then metal, the avoided methane emissions can be taken into account in the overall carbon intensity. There are numerous possibilities and the status quo itself is evolving, so it can be preferable to utilize a database within LCA software so that appropriate industry averages are employed.

### Pyrolysis Processes and Systems

Processes and systems suitable for mildly pyrolyzing a biomass feedstock to generate a biogenic reagent (i.e., an intermediate biocarbon stream) comprising carbon will now be further described in detail.

“Pyrolysis” and “pyrolyze” generally refer to thermal decomposition of a carbonaceous material. In pyrolysis, less oxygen is present than is required for complete combustion of the material, such as less than 10%, 5%, 1%, 0.5%, 0.1%, or 0.01% of the oxygen (O₂ molar basis) that is required for complete combustion. In some embodiments, pyrolysis is performed in the absence of oxygen.

Exemplary changes that can occur during pyrolysis include any of the following: (i) heat transfer from a heat source increases the temperature inside the feedstock; (ii) the initiation of primary pyrolysis reactions at this higher temperature releases volatiles and forms a char; (iii) the flow of hot volatiles toward cooler solids results in heat transfer between hot volatiles and cooler unpyrolyzed feedstock; (iv) condensation of some of the volatiles in the cooler parts of the feedstock, followed by secondary reactions, can produce tar; (v) autocatalytic secondary pyrolysis reactions proceed while primary pyrolytic reactions simultaneously occur in competition; and (vi) further thermal decomposition, reforming, water-gas shift reactions, free-radical recombination, or dehydrations can also occur, which are a function of the residence time, temperature, and pressure profile.

Pyrolysis can at least partially dehydrate a starting feedstock (e.g., lignocellulosic biomass). In various embodiments, pyrolysis removes greater than about 10%, 25%, 50%, 75%, 90%, 95%, or more of the water from the starting feedstock.

As stated earlier, mild pyrolysis is preferred when producing a biomedia composition intended as a peat-replacement product and similar applications. Exemplary pyrolysis conditions for mild pyrolysis include a pyrolysis temperature from about 150° C. to about 600° C., such as about, at least about, or at most about 175° C., 200° C., 225° C., 250° C., 275° C., 300° C., 325° C., 350° C., 400° C., 450° C., 500° C., 550° C., or 600° C., including any intervening ranges. Exemplary pyrolysis conditions for mild pyrolysis include a pyrolysis time from about 10 minutes to about 8 hours, such as about, at least about, or at most about 15 minutes, 30 minutes, 45 minutes, 1 hour, 1.5 hours, 2 hours, 3 hours, 4 hours, 6 hours, or 8 hours, including any intervening ranges.

In some embodiments of the present invention, the mild pyrolysis can be classified as torrefaction. In biomass torrefaction, a starting biomass feedstock is heated to about 200-300° C. in a substantially inert environment. The residence time for biomass torrefaction is typically from about 30 minutes to about 2 hours.

In some embodiments, a starting biomass feedstock is selected from softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, lignin, animal manure, municipal solid waste, municipal sewage, or combinations thereof. Note that typically a biomass feedstock contains at least carbon, hydrogen, and oxygen.

The biogenic reagent can comprise at least about 50 wt %, at least about 75 wt %, or at least about 90 wt % carbon (total carbon). In various embodiments, the biogenic reagent contains about, at least about, or at most about 50, 55, 60, 65, 70, 75, 80, 85, 90, 95, or 99 wt % carbon. The total carbon is fixed carbon plus non-fixed carbon that is present in volatile matter. In some embodiments, component weight percentages are on an absolute basis, which is assumed unless stated otherwise. In other embodiments, component weight percentages are on a moisture-free and ash-free basis.

The biogenic reagent can comprise at least about 50 wt %, at least about 75 wt %, or at least about 90 wt % fixed carbon. In various embodiments, the biogenic reagent contains about, at least about, or at most about 50, 55, 60, 65, 70, 75, 80, 85, 90, 95, or 99 wt % fixed carbon.

The carbon (within the biogenic reagent) can be at least about 50 wt %, at least about 75 wt %, or at least about 90 wt % fixed carbon, for example, with the remainder of the carbon being volatile carbon. In various embodiments, the carbon contains about, at least about, or at most about 50, 55, 60, 65, 70, 75, 80, 85, 90, 95, 99, or 100 wt % fixed carbon.

The mild-pyrolysis conditions can be varied widely, depending on the desired compositions for the biogenic reagent and pyrolysis off-gas, the starting feedstock, the reactor configuration, and other factors.

In some embodiments, multiple reactor zones are designed and operated in a way that optimizes carbon yield and product quality from pyrolysis, while maintaining flexibility and adjustability for feedstock variations and product requirements.

In some non-limiting embodiments, the temperatures and residence times are preferably selected to achieve relatively slow pyrolysis chemistry. The benefit is potentially the substantial preservation of cell walls contained in the biomass structure, which means the final product can retain some, most, or all of the shape and strength of the starting biomass. In order to maximize this potential benefit, it is preferred to utilize apparatus that does not mechanically destroy the cell walls or otherwise convert the biomass particles into small fines. Certain suitable reactor configurations are discussed following the process description below.

Additionally, if the feedstock is a milled or sized feedstock, such as wood chips or pellets, it can be desirable for the feedstock to be carefully milled or sized. Careful initial treatment will tend to preserve the strength and cell-wall integrity that is present in the native feedstock source (e.g., trees). This can also be important when the final product should retain some, most, or all of the shape and strength of the starting biomass.

In some embodiments, a first zone of a pyrolysis reactor is configured for feeding biomass (or another carbon-containing feedstock) in a manner that does not “shock” the biomass, which would rupture the cell walls and initiate fast decomposition of the solid phase into vapors and gases. This first zone can be thought of as mild pyrolysis.

In some embodiments, a second zone of a pyrolysis reactor is configured as the primary reaction zone, in which preheated biomass undergoes pyrolysis chemistry to release gases and condensable vapors, leaving a significant amount of solid material which is a high-carbon reaction intermediate. Biomass components (primarily cellulose, hemicellulose, and lignin) decompose and create vapors, which escape by penetrating through pores or creating new nanopores. The latter effect contributes to the creation of porosity and surface area.

In some embodiments, a third zone of a pyrolysis reactor is configured for receiving the high-carbon reaction intermediate and cooling down the solids to some extent. Typically, the third zone will be a lower temperature than the second zone. In the third zone, the chemistry and mass transport can be surprisingly complex. Without being limited by any particular theory or proposed mechanisms, it is believed that secondary reactions can occur in the third zone. Essentially, carbon-containing components that are in the gas phase can decompose to form additional fixed carbon or become adsorbed onto the carbon. Thus, the final carbonaceous material can not simply be the solid, devolatilized residue of the processing steps, but rather can include additional carbon that has been deposited from the gas phase, such as by decomposition of organic vapors (e.g., tars) that can form carbon.

Certain embodiments extend the concept of additional carbon formation by including a separate unit in which cooled carbon is subjected to an environment including carbon-containing species, to enhance the carbon content of the final product. When the temperature of this unit is below pyrolysis temperatures, the additional carbon is expected to be in the form of adsorbed carbonaceous species, rather than additional fixed carbon.

There are a large number of options as to intermediate input and output (purge or probe) streams of one or more phases present in any particular zone, various mass and energy recycle schemes, various additives that can be introduced anywhere in the process, adjustability of process conditions including both reaction and separation conditions in order to tailor product distributions, and so on. Zone-specific input and output streams enable good process monitoring and control, such as through FTIR sampling and dynamic process adjustments.

Some embodiments do not employ fast pyrolysis, and some embodiments do not employ slow pyrolysis. Surprisingly high-quality biomedia compositions can be obtained from the disclosed processes and systems.

In some embodiments, a pyrolysis process for producing a high-carbon biogenic reagent comprises the following steps:
(a) providing a carbon-containing feedstock comprising biomass;
(b) optionally drying the feedstock to remove at least a portion of moisture contained within the feedstock;
(c) optionally deaerating the feedstock to remove at least a portion of interstitial oxygen, if any, contained with the feedstock;
(d) pyrolyzing the feedstock in the presence of a substantially inert gas phase for at least 10 minutes and with at least one temperature selected from about 150° C. to about 600° C., to generate hot pyrolyzed solids, condensable vapors, and non-condensable gases;
(e) separating at least a portion of the condensable vapors and at least a portion of the non-condensable gases from the hot pyrolyzed solids;
(f) cooling the hot pyrolyzed solids to generate cooled pyrolyzed solids; and
(g) recovering a high-carbon biogenic reagent comprising at least a portion of the cooled pyrolyzed solids.

“Biomass,” for purposes of this disclosure, shall be construed as any biogenic feedstock or mixture of a biogenic and non-biogenic feedstocks. Elementally, biomass includes at least carbon, hydrogen, and oxygen. The methods and apparatus of the invention can accommodate a wide range of feedstocks of various types, sizes, and moisture contents.

Biomass includes, for example, plant and plant-derived material, vegetation, agricultural waste, forestry waste, wood waste, paper waste, animal-derived waste, poultry-derived waste, and municipal solid waste. In various embodiments of the invention utilizing biomass, the biomass feedstock can include one or more materials selected from: timber harvesting residues, softwood chips, hardwood chips, tree branches, tree stumps, knots, leaves, bark, sawdust, off-spec paper pulp, cellulose, corn, corn stover, wheat straw, rice straw, sugarcane bagasse, switchgrass, miscanthus, animal manure, municipal garbage, municipal sewage, commercial waste, grape pumice, almond shells, pecan shells, coconut shells, coffee grounds, grass pellets, hay pellets, wood pellets, cardboard, paper, carbohydrates, plastic, and cloth. A person of ordinary skill in the art will readily appreciate that the feedstock options are virtually unlimited.

The present invention can also be used for mixtures of biomass and fossil fuels (such as biomass/coal blends), recognizing that the carbon intensity of the final product will not be as low as with pure biomass feedstocks, but lower than if pure fossil-fuel feedstocks are used. In some embodiments, a feedstock includes, coal, oil shale, crude oil, asphalt, or solids from crude-oil processing (such as petcoke). Feedstocks can include waste tires, recycled plastics, recycled paper, construction waste, deconstruction waste, and other waste or recycled materials.

Selection of a particular feedstock or feedstocks is not regarded as technically critical, but is carried out in a manner that tends to favor an economical process. Typically, regardless of the feedstocks chosen, there can be (in some embodiments) screening to remove undesirable materials. The feedstock can optionally be dried prior to processing. Carbon-containing feedstocks can be transportable by any known means, such as by truck, train, ship, barge, tractor trailer, or any other vehicle or means of conveyance.

The feedstock employed can be provided or processed into a wide variety of particle sizes or shapes. For example, the feed material can be a fine powder, or a mixture of fine and coarse particles. The feed material can be in the form of large pieces of material, such as wood chips or other forms of wood (e.g., round, cylindrical, square, etc.). In some embodiments, the feed material comprises pellets or other agglomerated forms of particles that have been pressed together or otherwise bound, such as with a binder.

It is noted that size reduction is a costly and energy-intensive process. Pyrolyzed material can be sized with significantly less energy input—that is, it can be preferred to reduce the particle size of the product, not the feedstock. This is an option in the present invention because the process does not require a fine starting material, and there is not necessarily any significant particle-size reduction during processing. The ability to process very large pieces of feedstock is a significant economic advantage of this invention. Notably, some market applications of the high-carbon product actually require large sizes (e.g., on the order of centimeters), so that in some embodiments, large pieces are fed, produced, and sold.

When it is desired to produce a final carbonaceous biogenic reagent that has structural integrity, such as in the form of cylinders, there are at least two options in the context of this invention. First, the material produced from the process can be collected and then further process mechanically into the desired form. For example, the product can be pressed or pelletized, with a binder. The second option is to utilize feed materials that generally possess the desired size or shape for the final product, and employ processing steps that do not destroy the basic structure of the feed material. In some embodiments, the feed and product have similar geometrical shapes, such as spheres, cylinders, or cubes.

The ability to maintain the approximate size of feed material throughout the process is beneficial when product strength is important. Also, this avoids the difficulty and cost of pelletizing high fixed-carbon materials.

The starting feed material can be provided with a range of moisture levels, as will be appreciated. In some embodiments, the feed material can already be sufficiently dry that it need not be further dried before pyrolysis. Typically, it will be desirable to utilize commercial sources of biomass which will usually contain moisture, and feed the biomass through a drying step before introduction into the pyrolysis reactor. However, in some embodiments a dried feedstock can be utilized.

It is desirable to provide a relatively low-oxygen environment in the mild-pyrolysis reactor, such as about, or at most about, 10 mol %, 5 mol %, 4 mol %, 3 mol %, 2 mol %, 1.5 mol %, 1 mol %, 0.5 mol %, 0.2 mol %, 0.1 mol %, 0.05 mol %, 0.02 mol %, or 0.01 mol % O₂ in the gas phase. First, uncontrolled combustion should be avoided in the pyrolysis reactor, for safety reasons. Some amount of total carbon oxidation to CO₂ can occur, and the heat released from the exothermic oxidation can assist the endothermic pyrolysis chemistry. Large amounts of partial or total oxidation of carbon will reduce the carbon yield to solids.

Practically speaking, it can be difficult to achieve a strictly oxygen-free environment in the reactor. This limit can be approached, and in some embodiments, the reactor is substantially free of molecular oxygen in the gas phase. To ensure that little or no oxygen is present in the pyrolysis reactor, it can be desirable to remove air from the feed material before it is introduced to the reactor. There are various ways to remove or reduce air in the feedstock.

In some embodiments, a deaeration unit is utilized in which feedstock, before or after drying, is conveyed in the presence of another gas which can remove adsorbed oxygen and penetrate the feedstock pores to remove oxygen from the pores. Essentially any gas that has lower than 21 vol % O₂ can be employed, at varying effectiveness. In some embodiments, nitrogen is employed. In some embodiments, CO or CO₂ is employed. Mixtures can be used, such as a mixture of nitrogen and a small amount of oxygen. Steam can be present in the deaeration gas, although adding significant moisture back to the feed should be avoided. The effluent from the deaeration unit can be purged (to the atmosphere or to an emissions treatment unit) or recycled.

In principle, the effluent (or a portion thereof) from the deaeration unit could be introduced into the pyrolysis reactor itself since the oxygen removed from the solids will now be highly diluted. In this embodiment, it can be advantageous to introduce the deaeration effluent gas to the last zone of the reactor, when it is operated in a countercurrent configuration.

Various types of deaeration units can be employed. If drying it to be performed, it can be preferable to dry and then deaerate since it can be inefficient to scrub soluble oxygen out of the moisture present. In certain embodiments, the drying and deaerating steps are combined into a single unit, or some amount of deaeration is achieved during drying, and so on.

The optionally dried and optionally deaerated feed material is introduced to a pyrolysis reactor or multiple reactors in series or parallel. The feed material can be introduced using any known means, including screw feeders or lock hoppers, for example. In some embodiments, a material feed system incorporates an air knife.

When a single reactor is employed, multiple zones can be present. Multiple zones, such as two, three, four, or more zones, can allow for the separate control of temperature, solids residence time, gas residence time, gas composition, flow pattern, or pressure in order to adjust the overall process performance.

References to “zones” shall be broadly construed to include regions of space within a single physical unit, physically separate units, or any combination thereof. For a continuous reactor, the demarcation of zones can relate to structure, such as the presence of flights within the reactor or distinct heating elements to provide heat to separate zones. Alternatively, or additionally, the demarcation of zones in a continuous reactor can relate to function, such as distinct temperatures, fluid flow patterns, solid flow patterns, extent of reaction, and so on. In a single batch reactor, “zones” are operating regimes in time, rather than in space. Multiple batch reactors can also be used.

It will be appreciated that there are not necessarily abrupt transitions from one zone to another zone. For example, the boundary between the preheating zone and pyrolysis zone can be somewhat arbitrary; some amount of pyrolysis can take place in a portion of the preheating zone, and some amount of “preheating” can continue to take place in the pyrolysis zone. The temperature profile in the reactor is typically continuous, including at zone boundaries within the reactor.

Some embodiments employ a first zone that is operated under conditions of preheating or mild pyrolysis. The temperature of the first zone can be selected from about 150° C. to about 500° C., such as about 300° C. to about 400° C. The temperature of the first zone is preferably not so high as to shock the biomass material which ruptures the cell walls and initiates fast decomposition of the solid phase into vapors and gases.

All references to zone temperatures in this specification should be construed in a non-limiting way to include temperatures that can apply to the bulk solids present, or the gas phase, or the reactor walls (on the process side). It will be understood that there will be a temperature gradient in each zone, both axially and radially, as well as temporally (i.e., following start-up or due to transients). Thus, references to zone temperatures can be references to average temperatures or other effective temperatures that can influence the actual kinetics. Temperatures can be directly measured by thermocouples or other temperature probes, or indirectly measured or estimated by other means.

The second zone, or in general the primary pyrolysis zone, is operated under conditions of pyrolysis. The temperature of the second zone can be selected from about 150° C. to about 700° C., such as about, or at least about, or at most about 200° C., 250° C., 300° C., 350° C., 400° C., 450° C., 500° C., 550° C., or 600° C. Within this zone, preheated biomass undergoes pyrolysis chemistry to release gases and condensable vapors, leaving a significant amount of solid material as a high-carbon reaction intermediate. Biomass components (primarily cellulose, hemicellulose, and lignin) decompose and create vapors, which escape by penetrating through pores or creating new pores. The preferred temperature will at least depend on the residence time of the second zone, as well as the nature of the feedstock and desired product properties.

The third zone, or cooling zone, is operated to cool down the high-carbon reaction intermediate to varying degrees. At a minimum, the temperature of the third zone should be a lower temperature than that of the second zone. The temperature of the third zone can be selected from about 100° C. to about 550° C., such as about 150° C. to about 350° C.

Chemical reactions can continue to occur in the cooling zone. Without being limited by any particular theory, it is believed that secondary pyrolysis reactions can be initiated in the third zone. Carbon-containing components that are in the gas phase can condense (due to the reduced temperature of the third zone). The temperature remains sufficiently high, however, to promote reactions that can form additional fixed carbon from the condensed liquids (secondary pyrolysis) or at least form bonds between adsorbed species and the fixed carbon. One exemplary reaction that can take place is the Boudouard reaction for conversion of carbon monoxide to carbon dioxide plus fixed carbon.

The residence times of the reactor zones can vary. There is an interplay of time and temperature, so that for a desired amount of pyrolysis, higher temperatures can allow for lower reaction times, and vice versa. The residence time in a continuous reactor (zone) is the volume divided by the volumetric flow rate. The residence time in a batch reactor is the batch reaction time, following heating to reaction temperature.

It should be recognized that in multiphase reactors, there are multiple residence times. In the present context, in each zone, there will be a residence time (and residence-time distribution) of both the solids phase and the vapor phase. For a given apparatus employing multiple zones, and with a given throughput, the residence times across the zones will generally be coupled on the solids side, but residence times can be uncoupled on the vapor side when multiple inlet and outlet ports are utilized in individual zones. The solids and vapor residence times are uncoupled.

The solids residence time of the preheating zone can be selected from about 5 min to about 60 min, such as about 10, 20, 30, 40, or 50 min. Depending on the temperature, sufficient time is desired to allow the biomass to reach a desired preheat temperature. The heat-transfer rate, which will depend on the particle type and size, the physical apparatus, and on the heating parameters, will dictate the minimum residence time necessary to allow the solids to reach a desired preheat temperature. Additional time can not be desirable as it would contribute to higher capital cost, unless some amount of mild pyrolysis is intended in the preheating zone.

The solids residence time of the pyrolysis zone can be selected from about 10 min to about 120 min, such as about 20, 30, 40, 50, 60, 70, 80, 90, or 100 min. Depending on the pyrolysis temperature in this zone, there should be sufficient time to allow the carbonization chemistry to take place, following the necessary heat transfer. For times below about 10 min, in order to remove high quantities of non-carbon elements, the temperature would need to be quite high, such as above 700° C. This temperature would promote fast pyrolysis and its generation of vapors and gases derived from the carbon itself, which is to be avoided when the intended product is solid carbon.

In a static system, there would be an equilibrium conversion that could be substantially reached at a certain time. When, as in certain embodiments, vapor is continuously flowing over solids with continuous volatiles removal, the equilibrium constraint can be removed to allow for pyrolysis and devolatilization to continue until reaction rates approach zero. Longer times would not tend to substantially alter the remaining recalcitrant solids.

The solids residence time of the cooling zone can be selected from about 5 min to about 60 min, such as about 10, 20, 30, 40, or 50 min. Depending on the cooling temperature in this zone, there should be sufficient time to allow the carbon solids to cool to the desired temperature. The cooling rate and temperature will dictate the minimum residence time necessary to allow the carbon to be cooled. Additional time can not be desirable, unless some amount of secondary pyrolysis is desired.

As discussed above, the residence time of the vapor phase can be separately selected and controlled. The vapor residence time of the preheating zone can be selected from about 0.1 min to about 15 min, such as about 0.5, 1, 2, 3, 4, 5, 6, 7, 8, 9, or 10 min. The vapor residence time of the pyrolysis zone can be selected from about 0.1 min to about 20 min, such as about 0.5, 1, 2, 3, 4, 5, 6, 7, 8, 9, 10, 11, 12, 13, 14, or 15 min. The vapor residence time of the cooling zone can be selected from about 0.1 min to about 15 min, such as about 0.5, 1, 2, 3, 4, 5, 6, 7, 8, 9, or 10 min. Short vapor residence times promote fast sweeping of volatiles out of the system, while longer vapor residence times promote reactions of components in the vapor phase with the solid phase.

The mode of operation for the reactor, and overall system, can be continuous, semi-continuous, batch, or any combination or variation of these. In some embodiments, the reactor is a continuous, countercurrent reactor in which solids and vapor flow substantially in opposite directions. The reactor can also be operated in batch but with simulated countercurrent flow of vapors, such as by periodically introducing and removing gas phases from the batch vessel.

Various flow patterns can be desired or observed. With chemical reactions and simultaneous separations involving multiple phases in multiple reactor zones, the fluid dynamics can be quite complex. Typically, the flow of solids can approach plug flow (well-mixed in the radial dimension) while the flow of vapor can approach fully mixed flow (fast transport in both radial and axial dimensions). Multiple inlet and outlet ports for vapor can contribute to overall mixing.

The pressure in each zone can be separately selected and controlled. The pressure of each zone can be independently selected from about 1 kPa to about 3000 kPa, such as about 101.3 kPa (normal atmospheric pressure). Independent zone control of pressure is possible when multiple gas inlets and outlets are used, including vacuum ports to withdraw gas when a zone pressure less than atmospheric is desired.

The process can conveniently be operated at atmospheric pressure, in some embodiments. There are many advantages associated with operation at atmospheric pressure, ranging from mechanical simplicity to enhanced safety. In certain embodiments, the pyrolysis zone is operated at a pressure of about 90 kPa, 95 kPa, 100 kPa, 101 kPa, 102 kPa, 105 kPa, or 110 kPa (absolute pressures).

Vacuum operation (e.g., 10-100 kPa) would promote fast sweeping of volatiles out of the system. Higher pressures (e.g., 100-1000 kPa) can be useful when the off-gases will be fed to a high-pressure operation. Elevated pressures can also be useful to promote heat transfer, chemistry, or separations.

The step of separating at least a portion of the condensable vapors and at least a portion of the non-condensable gases from the hot pyrolyzed solids can be accomplished in the reactor itself, or using a distinct separation unit. A substantially inert sweep gas can be introduced into one or more of the zones. Condensable vapors and non-condensable gases are then carried away from the zone(s) in the sweep gas, and out of the reactor.

The sweep gas can be N₂, Ar, CO, CO₂, H₂, H₂O, CH₄, other light hydrocarbons, or combinations thereof, for example. The sweep gas can first be preheated prior to introduction, or possibly cooled if it is obtained from a heated source.

The sweep gas more thoroughly removes volatile components, by getting them out of the system before they can condense or further react. The sweep gas allows volatiles to be removed at higher rates than would be attained merely from volatilization at a given process temperature. Or, use of the sweep gas allows milder temperatures to be used to remove a certain quantity of volatiles. The reason the sweep gas improves the volatiles removal is that the mechanism of separation is not merely relative volatility but rather liquid/vapor phase disengagement assisted by the sweep gas. The sweep gas can both reduce mass-transfer limitations of volatilization as well as reduce thermodynamic limitations by continuously depleting a given volatile species, to cause more of it to vaporize to attain thermodynamic equilibrium.

Some embodiments remove gases laden with volatile organic carbon from subsequent processing stages, in order to produce a product with high fixed carbon. Without removal, the volatile carbon can adsorb or absorb onto the pyrolyzed solids, thereby requiring additional energy (cost) to achieve a purer form of carbon which can be desired. By removing vapors quickly, it is also speculated that porosity can be enhanced in the pyrolyzing solids. Higher porosity is desirable for some products.

In certain embodiments, the sweep gas in conjunction with a relatively low process pressure, such as atmospheric pressure, provides for fast vapor removal without large amounts of inert gas necessary.

In some embodiments, the sweep gas flows countercurrent to the flow direction of feedstock. In other embodiments, the sweep gas flows cocurrent to the flow direction of feedstock. In some embodiments, the flow pattern of solids approaches plug flow while the flow pattern of the sweep gas, and gas phase generally, approaches fully mixed flow in one or more zones.

The sweep can be performed in any one or more of the reactor zones. In some embodiments, the sweep gas is introduced into the cooling zone and extracted (along with volatiles produced) from the cooling or pyrolysis zones. In some embodiments, the sweep gas is introduced into the pyrolysis zone and extracted from the pyrolysis or preheating zones. In some embodiments, the sweep gas is introduced into the preheating zone and extracted from the pyrolysis zone. In these or other embodiments, the sweep gas can be introduced into each of the preheating, pyrolysis, and cooling zones and also extracted from each of the zones.

In some embodiments, the zone or zones in which separation is carried out is a physically separate unit from the reactor. The separation unit or zone can be disposed between reactor zones, if desired. For example, there can be a separation unit placed between pyrolysis and cooling units.

The sweep gas can be introduced continuously, especially when the solids flow is continuous. When the pyrolysis reaction is operated as a batch process, the sweep gas can be introduced after a certain amount of time, or periodically, to remove volatiles. Even when the pyrolysis reaction is operated continuously, the sweep gas can be introduced semi-continuously or periodically, if desired, with suitable valves and controls.

The volatiles-containing sweep gas can exit from the one or more reactor zones, and can be combined if obtained from multiple zones. The resulting gas stream, containing various vapors, can then be fed to a thermal oxidizer for control of air emissions. Any known thermal-oxidation unit can be employed. In some embodiments, the thermal oxidizer is fed with natural gas and air, to reach sufficient temperatures for substantial destruction of volatiles contained therein.

The effluent of the thermal oxidizer will be a hot gas stream comprising water, carbon dioxide, and nitrogen. This effluent stream can be purged directly to air emissions, if desired. Preferably, the energy content of the thermal oxidizer effluent is recovered, such as in a waste-heat recovery unit. The energy content can also be recovered by heat exchange with another stream (such as the sweep gas). The energy content can be utilized by directly or indirectly heating, or assisting with heating, a unit elsewhere in the process, such as the dryer or the reactor. In some embodiments, essentially all of the thermal oxidizer effluent is employed for indirect heating (utility side) of the dryer. The thermal oxidizer can employ other fuels than natural gas.

The yield of carbonaceous material can vary, depending on the above-described factors including type of feedstock and process conditions. In some embodiments, the net yield of solids as a percentage of the starting feedstock, on a dry basis, is at least 25%, 30%, 35%, 40%, 45%, 50%, or greater. The remainder will be split between condensable vapors, such as terpenes, tars, alcohols, acids, aldehydes, or ketones; and non-condensable gases, such as carbon monoxide, hydrogen, carbon dioxide, and methane. The relative amounts of condensable vapors compared to non-condensable gases will also depend on process conditions, including the water present.

In terms of the carbon balance, in some embodiments the net yield of carbon as a percentage of starting carbon in the feedstock is at least 25%, 30%, 40%, 50%, 60%, 65%, 70%, 75%, 80%, or greater. For example, the in some embodiments the carbonaceous material contains between about 40% and about 70% of the carbon contained in the starting feedstock. The rest of the carbon results in the formation of methane, carbon monoxide, carbon dioxide, light hydrocarbons, aromatics, tars, terpenes, alcohols, acids, aldehydes, or ketones, to varying extents.

In alternative embodiments, some portion of these compounds is combined with the carbon-rich solids to enrich the carbon and energy content of the product. In these embodiments, some or all of the resulting gas stream from the reactor, containing various vapors, can be condensed, at least in part, and then passed over cooled pyrolyzed solids derived from the cooling zone or from the separate cooling unit. These embodiments are described in more detail below.

Following the reaction and cooling within the cooling zone (if present), the carbonaceous solids can be introduced into a distinct cooling unit. In some embodiments, solids are collected and simply allowed to cool at slow rates. If the carbonaceous solids are reactive or unstable in air, it can be desirable to maintain an inert atmosphere or rapidly cool the solids to, for example, a temperature less than 40° C., such as ambient temperature. In some embodiments, a water quench is employed for rapid cooling. In some embodiments, a fluidized-bed cooler is employed. A “cooling unit” should be broadly construed to also include containers, tanks, pipes, or portions thereof.

In some embodiments, the process further comprises operating the cooling unit to cool the warm pyrolyzed solids with steam, thereby generating the cool pyrolyzed solids and superheated steam; wherein the drying is carried out, at least in part, with the superheated steam derived from the cooling unit. Optionally, the cooling unit can be operated to first cool the warm pyrolyzed solids with steam to reach a first cooling-unit temperature, and then with air to reach a second cooling-unit temperature, wherein the second cooling-unit temperature is lower than the first cooling-unit temperature and is associated with a reduced combustion risk for the warm pyrolyzed solids in the presence of the air.

Following cooling to ambient conditions, the carbonaceous solids can be recovered and stored, conveyed to another site operation, transported to another site, or otherwise disposed, traded, or sold. The solids can be fed to a unit to reduce particle size. A variety of size-reduction units are known in the art, including crushers, shredders, grinders, pulverizers, jet mills, pin mills, and ball mills.

Screening or some other means for separation based on particle size can be included. The grinding can be upstream or downstream of grinding, if present. A portion of the screened material (e.g., large chunks) can be returned to the grinding unit. The small and large particles can be recovered for separate downstream uses. In some embodiments, cooled pyrolyzed solids are ground into a fine powder, such as a pulverized carbon or activated carbon product.

Various additives can be introduced throughout the process, before, during, or after any step disclosed herein. The additives can be broadly classified as process additives, selected to improve process performance such as carbon yield or pyrolysis time/temperature to achieve a desired carbon purity; and product additives, selected to improve one or more properties of the high-carbon biogenic reagent, or a downstream product incorporating the reagent. Certain additives can provide enhanced process and product (biogenic reagents or products containing biogenic reagents) characteristics.

Additives can be added before, during, or after any one or more steps of the process, including into the feedstock itself at any time, before or after it is harvested. Additive treatment can be incorporated prior to, during, or after feedstock sizing, drying, or other preparation. Additives can be incorporated at or on feedstock supply facilities, transport trucks, unloading equipment, storage bins, conveyors (including open or closed conveyors), dryers, process heaters, or any other units. Additives can be added anywhere into the pyrolysis process itself, using suitable means for introducing additives. Additives can be added after carbonization, or even after pulverization, if desired.

In some embodiments, an additive is selected from a metal, a metal oxide, a metal hydroxide, or a combination thereof. For example an additive can be selected from, but is by no means limited to, magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, and combinations thereof.

In some embodiments, an additive is selected from an acid, a base, or a salt thereof. For example an additive can be selected from, but is by no means limited to, sodium hydroxide, potassium hydroxide, magnesium oxide, hydrogen bromide, hydrogen chloride, sodium silicate, potassium permanganate, or combinations thereof.

In some embodiments, an additive is selected from a metal halide. Metal halides are compounds between metals and halogens (fluorine, chlorine, bromine, iodine, and astatine). The halogens can form many compounds with metals. Metal halides are generally obtained by direct combination, or more commonly, neutralization of basic metal salt with a hydrohalic acid. In some embodiments, an additive is selected from iron chloride (FeCl₂ or FeCl₃), iron bromide (FeBr₂ or FeBr₃), or hydrates thereof, and any combinations thereof.

Additives can result in a final product with greater energy content (energy density). An increase in energy content can result from an increase in total carbon, fixed carbon, volatile carbon, or even hydrogen. Alternatively or additionally, the increase in energy content can result from removal of non-combustible matter or of material having lower energy density than carbon. In some embodiments, additives reduce the extent of liquid formation, in favor of solid and gas formation, or in favor of solid formation.

Without being limited to any particular hypothesis, additives can chemically modify the starting biomass, or treated biomass prior to pyrolysis, to reduce rupture of cell walls for greater strength/integrity. In some embodiments, additives can increase fixed carbon content of biomass feedstock prior to pyrolysis.

Additives can result in a biogenic reagent with improved mechanical properties, such as yield strength, compressive strength, tensile strength, fatigue strength, impact strength, elastic modulus, bulk modulus, or shear modulus. Additives can improve mechanical properties by simply being present (e.g., the additive itself imparts strength to the mixture) or due to some transformation that takes place within the additive phase or within the resulting mixture. For example, reactions such as vitrification can occur within a portion of the biogenic reagent that includes the additive, thereby improving the final strength.

Chemical additives can be applied to wet or dry biomass feedstocks. The additives can be applied as a solid powder, a spray, a mist, a liquid, or a vapor. In some embodiments, additives can be introduced through spraying of a liquid solution (such as an aqueous solution or in a solvent), or by soaking in tanks, bins, bags, or other containers.

In certain embodiments, dip pretreatment is employed wherein the solid feedstock is dipped into a bath comprising the additive, either batchwise or continuously, for a time sufficient to allow penetration of the additive into the solid feed material.

In some embodiments, additives applied to the feedstock can reduce energy requirements for the pyrolysis, or increase the yield of the carbonaceous product. In these or other embodiments, additives applied to the feedstock can provide functionality that is desired for the intended use of the carbonaceous product.

The throughput, or process capacity, can vary widely from small laboratory-scale units to full operations, including any pilot, demonstration, or semi-commercial scale. In various embodiments, the process capacity (for feedstocks, products, or both) is at least about 1 kg/day, 10 kg/day, 100 kg/day, 1 ton/day (all tons are metric tons), 10 tons/day, 100 tons/day, 500 tons/day, 1000 tons/day, 2000 tons/day, or greater.

In some embodiments, a portion of solids produced can be recycled to the front end of the process, i.e., to the drying or deaeration unit or directly to the reactor. By returning to the front end and passing through the process again, treated solids can become higher in fixed carbon. Solid, liquid, and gas streams produced or existing within the process can be independently recycled, passed to subsequent steps, or removed/purged from the process at any point.

In some embodiments, pyrolyzed material is recovered and then fed to a separate unit for further pyrolysis, to create a product with greater carbon purity. In some embodiments, the secondary process can be conducted in a simple container, such as a steel drum, in which heated inert gas (such as heated N₂) is passed through. Other containers useful for this purpose include process tanks, barrels, bins, totes, sacks, and roll-offs. This secondary sweep gas with volatiles can be sent to the thermal oxidizer, or back to the main process reactor, for example. To cool the final product, another stream of inert gas, which is initially at ambient temperature for example, can be passed through the solids to cool the solids, and then returned to an inert gas preheat system.

Some variations of the invention utilize a biogenic reagent production system comprising:
(a) a feeder configured to introduce a carbon-containing feedstock;
(b) an optional dryer, disposed in operable communication with the feeder, configured to remove moisture contained within a carbon-containing feedstock;
(c) a multiple-zone reactor, disposed in operable communication with the dryer, wherein the multiple-zone reactor contains at least a pyrolysis zone disposed in operable communication with a spatially separated cooling zone, and wherein the multiple-zone reactor is configured with an outlet to remove condensable vapors and non-condensable gases from solids;
(d) a solids cooler, disposed in operable communication with the multiple-zone reactor; and
(e) a high-carbon biogenic reagent recovery unit, disposed in operable communication with the solids cooler.

Some variations utilize a biogenic reagent production system comprising:
(a) a feeder configured to introduce a carbon-containing feedstock;
(b) an optional dryer, disposed in operable communication with the feeder, configured to remove moisture contained within a carbon-containing feedstock;
(c) an optional preheater, disposed in operable communication with the dryer, configured to heat or mildly pyrolyze the feedstock;
(d) a pyrolysis reactor, disposed in operable communication with the preheater, configured to pyrolyze the feedstock;
(e) a cooler, disposed in operable communication with the pyrolysis reactor, configured to cool pyrolyzed solids; and
(f) a high-carbon biogenic reagent recovery unit, disposed in operable communication with the cooler,
wherein the system is configured with at least one gas outlet to remove condensable vapors and non-condensable gases from solids.

The feeder can be physically integrated with the multiple-zone reactor, such as through the use of a screw feeder or auger mechanism to introduce feed solids into the first reaction zone.

In some embodiments, the system further comprises a preheating zone, disposed in operable communication with the pyrolysis zone. Each of the pyrolysis zone, cooling zone, and preheating zone (it present) can be located within a single unit, or can be located in separate units.

Optionally, the dryer can be configured as a drying zone within the multiple-zone reactor. Optionally, the solids cooler can be disposed within the multiple-zone reactor (i.e., configured as an additional cooling zone or integrated with the main cooling zone).

The system can include a purging means for removing oxygen from the system. For example, the purging means can comprise one or more inlets to introduce a substantially inert gas, and one or more outlets to remove the substantially inert gas and displaced oxygen from the system. In some embodiments, the purging means is a deaerater disposed in operable communication between the dryer and the multiple-zone reactor.

The multiple-zone reactor can be configured with at least a first gas inlet and a first gas outlet. The first gas inlet and the first gas outlet can be disposed in communication with different zones, or with the same zone.

In some embodiments, the multiple-zone reactor is configured with a second gas inlet or a second gas outlet. In some embodiments, the multiple-zone reactor is configured with a third gas inlet or a third gas outlet. In some embodiments, the multiple-zone reactor is configured with a fourth gas inlet or a fourth gas outlet. In some embodiments, each zone present in the multiple-zone reactor is configured with a gas inlet and a gas outlet.

Gas inlets and outlets allow not only introduction and withdrawal of vapor, but gas outlets (probes) in particular allow precise process monitoring and control across various stages of the process, up to and potentially including all stages of the process. Precise process monitoring would be expected to result in yield and efficiency improvements, both dynamically as well as over a period of time when operational history can be utilized to adjust process conditions.

In certain embodiments, a reaction gas probe is disposed in operable communication with the pyrolysis zone. Such a reaction gas probe can be useful to extract gases and analyze them, in order to determine extent of reaction, pyrolysis selectivity, or other process monitoring. Then, based on the measurement, the process can be controlled or adjusted in any number of ways, such as by adjusting feed rate, rate of inert gas sweep, temperature (of one or more zones), pressure (of one or more zones), additives, and so on.

As intended herein, “monitor and control” via reaction gas probes should be construed to include any one or more sample extractions via reaction gas probes, and optionally making process or equipment adjustments based on the measurements, if deemed necessary or desirable, using well-known principles of process control (feedback, feedforward, proportional-integral-derivative logic, etc.).

A reaction gas probe can be configured to withdraw gas samples in a number of ways. For example, a sampling line can have a lower pressure than the pyrolysis reactor pressure, so that when the sampling line is opened an amount of gas can readily be withdrawn from pyrolysis zone. The sampling line can be under vacuum, such as when the pyrolysis zone is near atmospheric pressure. Typically, a reaction gas probe will be associated with one gas output, or a portion thereof (e.g., a line split from a gas output line).

In some embodiments, both a gas input and a gas output are utilized as a reaction gas probe by periodically introducing an inert gas into a zone, and pulling the inert gas with a process sample out of the gas output (“sample sweep”). Such an arrangement could be used in a zone that does not otherwise have a gas inlet/outlet for the substantially inert gas for processing, or, the reaction gas probe could be associated with a separate gas inlet/outlet that is in addition to process inlets and outlets. A sampling inert gas that is introduced and withdrawn periodically for sampling (in embodiments that utilize sample sweeps) could even be different than the process inert gas, if desired, either for reasons of accuracy in analysis or to introduce an analytical tracer.

For example, acetic acid concentration in the gas phase of the pyrolysis zone can be measured using a gas probe to extract a sample, which is then analyzed using a suitable technique (such as gas chromatography, GC; mass spectroscopy, MS; GC-MS, or Fourier-Transform Infrared Spectroscopy, FTIR). CO or CO₂ concentration in the gas phase could be measured and used as an indication of the pyrolysis selectivity toward gases/vapors, for example. Terpene concentration in the gas phase could be measured and used as an indication of the pyrolysis selectivity toward liquids, for example.

In some embodiments, the system further comprises at least one additional gas probe disposed in operable communication with the cooling zone, or with the drying zone (if present) or the preheating zone (if present).

A gas probe for the cooling zone could be useful to determine the extent of any additional chemistry taking place in the cooling zone, for example. A gas probe in the cooling zone could also be useful as an independent measurement of temperature (in addition, for example, to a thermocouple disposed in the cooling zone). This independent measurement can be a correlation of cooling temperature with a measured amount of a certain species. The correlation could be separately developed, or could be established after some period of process operation.

A gas probe for the drying zone could be useful to determine the extent of drying, by measuring water content, for example. A gas probe in the preheating zone could be useful to determine the extent of any mild pyrolysis taking place, for example.

In certain embodiments, the cooling zone is configured with a gas inlet, and the pyrolysis zone is configured with a gas outlet, to generate substantially countercurrent flow of the gas phase relative to the solid phase. Alternatively, or additionally, the preheating zone (when it is present) can be configured with a gas outlet, to generate substantially countercurrent flow of the gas phase relative to the solid phase. Alternatively, or additionally, the drying zone can be configured with a gas outlet, to generate substantially countercurrent flow.

The pyrolysis reactor or reactors can be selected from any suitable reactor configuration that is capable of carrying out the pyrolysis process. Exemplary reactor configurations include, but are not limited to, fixed-bed reactors, fluidized-bed reactors, entrained-flow reactors, augers, ablative reactors, rotating cones, rotary drum kilns, calciners, roasters, moving-bed reactors, transport-bed reactors, ablative reactors, rotating cones, or microwave-assisted pyrolysis reactors.

In some embodiments in which an auger is used, sand or another heat carrier can optionally be employed. For example, the feedstock and sand can be fed at one end of a screw. The screw mixes the sand and feedstock and conveys them through the reactor. The screw can provide good control of the feedstock residence time and does not dilute the pyrolyzed products with a carrier or fluidizing gas. The sand can be reheated in a separate vessel.

In some embodiments in which an ablative process is used, the feedstock is moved at a high speed against a hot metal surface. Ablation of any char forming at surfaces can maintain a high rate of heat transfer. Such apparatus can prevent dilution of products. As an alternative, the feedstock particles can be suspended in a carrier gas and introduced at a high speed through a cyclone whose wall is heated.

In some embodiments in which a fluidized-bed reactor is used, the feedstock can be introduced into a bed of hot sand fluidized by a gas, which is typically a recirculated product gas. Reference herein to “sand” shall also include similar, substantially inert materials, such as glass particles, recovered ash particles, and the like. High heat-transfer rates from fluidized sand can result in rapid heating of the feedstock. There can be some ablation by attrition with the sand particles. Heat is usually provided by heat-exchanger tubes through which hot combustion gas flows.

Circulating fluidized-bed reactors can be employed, wherein gas, sand, and feedstock move together. Exemplary transport gases include recirculated product gases and combustion gases. High heat-transfer rates from the sand ensure rapid heating of the feedstock, and ablation is expected to be stronger than with regular fluidized beds. A separator can be employed to separate the product gases from the sand and char particles. The sand particles can be reheated in a fluidized burner vessel and recycled to the reactor.

In some embodiments, a multiple-zone reactor is a continuous reactor comprising a feedstock inlet, a plurality of spatially separated reaction zones configured for separately controlling the temperature and mixing within each of the reaction zones, and a carbonaceous-solids outlet, wherein one of the reaction zones is configured with a first gas inlet for introducing a substantially inert gas into the reactor, and wherein one of the reaction zones is configured with a first gas outlet.

In various embodiments the reactor includes at least two, three, four, or more reaction zones. Each of the reaction zones is disposed in communication with separately adjustable heating means independently selected from electrical heat transfer, steam heat transfer, hot-oil heat transfer, phase-change heat transfer, waste heat transfer, or combinations thereof. In some embodiments, at least one reactor zone is heated with an effluent stream from the thermal oxidizer, if present.

The reactor can be configured for separately adjusting gas-phase composition and gas-phase residence time of at least two reaction zones, up to and including all reaction zones present in the reactor.

The reactor can be equipped with a second gas inlet or a second gas outlet. In some embodiments, the reactor is configured with a gas inlet in each reaction zone. In these or other embodiments, the reactor is configured with a gas outlet in each reaction zone. The reactor can be a cocurrent or countercurrent reactor.

In some embodiments, the feedstock inlet comprises a screw or auger feed mechanism. In some embodiments, the carbonaceous-solids outlet comprises a screw or auger output mechanism.

Certain embodiments utilize a rotating calciner with a screw feeder. In these embodiments, the reactor is axially rotatable, i.e., it spins about its centerline axis. The speed of rotation will impact the solid flow pattern, and heat and mass transport. Each of the reaction zones can be configured with flights disposed on internal walls, to provide agitation of solids. The flights can be separately adjustable in each of the reaction zones.

Other means of agitating solids can be employed, such as augers, screws, or paddle conveyors. In some embodiments, the reactor includes a single, continuous auger disposed throughout each of the reaction zones. In other embodiments, the reactor includes twin screws disposed throughout each of the reaction zones.

Some systems are designed specifically with the capability to maintain the approximate size of feed material throughout the process—that is, to process the biomass feedstock without destroying or significantly damaging its structure. In some embodiments, the pyrolysis zone does not contain augers, screws, or rakes that would tend to greatly reduce the size of feed material being pyrolyzed.

In some embodiments of the invention, the system further includes a thermal oxidizer disposed in operable communication with the outlet at which condensable vapors and non-condensable gases are removed. The thermal oxidizer can be configured to receive a separate fuel (such as natural gas) and an oxidant (such as air) into a combustion chamber, adapted for combustion of the fuel and at least a portion of the condensable vapors. Certain non-condensable gases can also be oxidized, such as CO or CH₄, to CO₂.

When a thermal oxidizer is employed, the system can include a heat exchanger disposed between the thermal oxidizer and the dryer, configured to utilize at least some of the heat of the combustion for the dryer. This embodiment can contribute significantly to the overall energy efficiency of the process.

In some embodiments, the system further comprises a carbon-enhancement unit, disposed in operable communication with the solids cooler, configured for combining condensable vapors, in at least partially condensed form, with the solids. The carbon-enhancement unit can increase the carbon content of the high-carbon biogenic reagent obtained from the recovery unit.

The system can further include a separate pyrolysis unit adapted to further pyrolyze the high-carbon biogenic reagent to further increase its carbon content. The separate pyrolysis unit can be a relatively simply container, unit, or device, such as a tank, barrel, bin, drum, tote, sack, or roll-off.

The overall system can be at a fixed location, or it can be distributed at several locations. The system can be constructed using modules which can be simply duplicated for practical scale-up. The system can also be constructed using economy-of-scale principles, as is well-known in the process industries.

Some variations relating to carbon enhancement of solids will now be further described. In some embodiments, a process for producing a biogenic reagent comprises:
(a) providing a carbon-containing feedstock comprising biomass;
(b) optionally drying the feedstock to remove at least a portion of moisture contained within the feedstock;
(c) optionally deaerating the feedstock to remove at least a portion of interstitial oxygen, if any, contained with the feedstock;
(d) in a pyrolysis zone, pyrolyzing the feedstock in the presence of a substantially inert gas for at least 10 minutes and with a pyrolysis temperature selected from about 150° C. to about 600° C., to generate hot pyrolyzed solids, condensable vapors, and non-condensable gases;
(e) separating at least a portion of the condensable vapors and at least a portion of the non-condensable gases from the hot pyrolyzed solids;
(f) in a cooling zone, cooling the hot pyrolyzed solids, in the presence of the substantially inert gas for at least 5 minutes and with a cooling temperature less than the pyrolysis temperature, to generate warm pyrolyzed solids;
(g) optionally cooling the warm pyrolyzed solids to generate cool pyrolyzed solids;
(h) subsequently passing at least a portion of the condensable vapors or at least a portion of the non-condensable gases from step (e) across the warm pyrolyzed solids or the cool pyrolyzed solids, to form enhanced pyrolyzed solids with increased carbon content; and
(i) recovering a high-carbon biogenic reagent comprising at least a portion of the enhanced pyrolyzed solids.

In some embodiments, step (h) includes passing at least a portion of the condensable vapors from step (e), in vapor or condensed form, across the warm pyrolyzed solids, to produce enhanced pyrolyzed solids with increased carbon content. In some embodiments, step (h) includes passing at least a portion of the non-condensable gases from step (e) across the warm pyrolyzed solids, to produce enhanced pyrolyzed solids with increased carbon content.

Alternatively, or additionally, vapors or gases can be contacted with the cool pyrolyzed solids. In some embodiments, step (h) includes passing at least a portion of the condensable vapors from step (e), in vapor or condensed form, across the cool pyrolyzed solids, to produce enhanced pyrolyzed solids with increased carbon content. In some embodiments, step (h) includes passing at least a portion of the non-condensable gases from step (e) across the cool pyrolyzed solids, to produce enhanced pyrolyzed solids with increased carbon content.

In certain embodiments, step (h) includes passing substantially all of the condensable vapors from step (e), in vapor or condensed form, across the cool pyrolyzed solids, to produce enhanced pyrolyzed solids with increased carbon content. In certain embodiments, step (h) includes passing substantially all of the non-condensable gases from step (e) across the cool pyrolyzed solids, to produce enhanced pyrolyzed solids with increased carbon content.

The process can include various methods of treating or separating the vapors or gases prior to using them for carbon enhancement. For example, an intermediate feed stream comprising or consisting essentially of at least a portion of the condensable vapors and at least a portion of the non-condensable gases, obtained from step (e), can be fed to a separation unit configured to generate at least first and second output streams. In certain embodiments, the intermediate feed stream comprises all of the condensable vapors, all of the non-condensable gases, or both.

Separation techniques can include or use distillation columns, flash vessels, centrifuges, cyclones, membranes, filters, packed beds, capillary columns, and so on. Separation can be principally based, for example, on distillation, absorption, adsorption, or diffusion, and can utilize differences in vapor pressure, activity, molecular weight, density, viscosity, polarity, chemical functionality, affinity to a stationary phase, and any combinations thereof.

In some embodiments, the first and second output streams are separated from the intermediate feed stream based on relative volatility. For example, the separation unit can be a distillation column, a flash tank, or a condenser.

Thus in some embodiments, the first output stream comprises the condensable vapors, and the second output stream comprises the non-condensable gases. The condensable vapors can include at least one carbon-containing compound selected from terpenes, alcohols, acids, aldehydes, or ketones. The vapors from pyrolysis can include aromatic compounds such as benzene, toluene, ethylbenzene, and xylenes. Heavier aromatic compounds, such as refractory tars, can be present in the vapor. The non-condensable gases can include at least one carbon-containing molecule selected from carbon monoxide, carbon dioxide, or methane.

In some embodiments, the first and second output streams are separated intermediate feed stream based on relative polarity. For example, the separation unit can be a stripping column, a packed bed, a chromatography column, or membranes.

Thus in some embodiments, the first output stream comprises polar compounds, and the second output stream comprises non-polar compounds. The polar compounds can include at least one carbon-containing molecule selected from methanol, furfural, or acetic acid. The non-polar compounds can include at least one carbon-containing molecule selected from carbon monoxide, carbon dioxide, methane, a terpene, or a terpene derivative.

Step (h) can increase the total carbon content of the high-carbon biogenic reagent, relative to an otherwise-identical process without step (h). The extent of increase in carbon content can be, for example, about 1%, 2%, 5%, 10%, 15%, 25%, or even greater, in various embodiments.

In some embodiments, step (h) increases the fixed carbon content of the high-carbon biogenic reagent. In these or other embodiments, step (h) increases the volatile carbon content of the high-carbon biogenic reagent. Volatile carbon content is the carbon attributed to volatile matter in the reagent. The volatile matter can be, but is not limited to, hydrocarbons including aliphatic or aromatic compounds (e.g., terpenes); oxygenates including alcohols, aldehydes, or ketones; and various tars. Volatile carbon will typically remain bound or adsorbed to the solids at ambient conditions but upon heating, will be released before the fixed carbon would be oxidized, gasified, or otherwise released as a vapor.

Depending on conditions associated with step (h), it is possible for some amount of volatile carbon to become fixed carbon (e.g., via Boudouard carbon formation from CO). Typically, the volatile matter will enter the micropores of the fixed carbon and will be present as condensed/adsorbed species, but remain relatively volatile. This residual volatility can be more advantageous for fuel applications, compared to product applications requiring high surface area and porosity.

Step (h) can increase the energy content (i.e., energy density) of the high-carbon biogenic reagent. The increase in energy content can result from an increase in total carbon, fixed carbon, volatile carbon, or even hydrogen. The extent of increase in energy content can be, for example, about 1%, 2%, 5%, 10%, 15%, 25%, or even greater, in various embodiments.

Further separations can be employed to recover one or more non-condensable gases or condensable vapors, for use within the process or further processing. For example, further processing can be included to produce refined carbon monoxide or hydrogen.

As another example, separation of acetic acid can be conducted, followed by reduction of the acetic acid into ethanol. The reduction of the acetic acid can be accomplished, at least in part, using hydrogen derived from the non-condensable gases produced.

Condensable vapors can be used for either energy in the process (such as by thermal oxidation) or in carbon enrichment, to increase the carbon content of the high-carbon biogenic reagent. Certain non-condensable gases, such as CO or CH₄, can be utilized either for energy in the process, or as part of the substantially inert gas for the pyrolysis step. Combinations of any of the foregoing are also possible.

A potential benefit of including step (h) is that the gas stream is scrubbed, with the resulting gas stream being enriched in CO and CO₂. The resulting gas stream can be utilized for energy recovery, recycled for carbon enrichment of solids, or used as an inert gas in the reactor. Similarly, by separating non-condensable gases from condensable vapors, the CO/CO₂ stream is prepared for use as the inert gas in the reactor system or in the cooling system, for example.

Other variations are premised on the realization that the principles of the carbon-enhancement step can be applied to any feedstock in which it is desired to add carbon.

In some embodiments, a batch or continuous process for producing a biogenic reagent comprises:
(a) providing a solid stream comprising a carbon-containing material;
(b) providing a gas stream comprising condensable carbon-containing vapors, non-condensable carbon-containing gases, or a mixture of condensable carbon-containing vapors and non-condensable carbon-containing gases; and
(c) passing the gas stream across the solid stream under suitable conditions to form a carbon-containing product with increased carbon content relative to the carbon-containing material.

In some embodiments, the starting carbon-containing material is pyrolyzed biomass or torrefied biomass. The gas stream can be obtained during an integrated process that provides the carbon-containing material. Or, the gas stream can be obtained from separate processing of the carbon-containing material. The gas stream, or a portion thereof, can be obtained from an external source (e.g., an oven at a lumber mill). Mixtures of gas streams, as well as mixtures of carbon-containing materials, from a variety of sources, are possible.

In some embodiments, the process further comprises recycling or reusing the gas stream for repeating the process to further increase carbon or energy content of the carbon-containing product. In some embodiments, the process further comprises recycling or reusing the gas stream for carrying out the process to increase carbon or energy content of another feedstock different from the carbon-containing material.

In some embodiments, the process further includes introducing the gas stream to a separation unit configured to generate at least first and second output streams, wherein the gas stream comprises a mixture of condensable carbon-containing vapors and non-condensable carbon-containing gases. The first and second output streams can be separated based on relative volatility, relative polarity, or any other property. The gas stream can be obtained from separate processing of the carbon-containing material.

In some embodiments, the process further comprises recycling or reusing the gas stream for repeating the process to further increase carbon content of the carbon-containing product. In some embodiments, the process further comprises recycling or reusing the gas stream for carrying out the process to increase carbon content of another feedstock.

The carbon-containing product can have an increased total carbon content, a greater fixed carbon content, a greater volatile carbon content, a greater energy content, or any combination thereof, relative to the starting carbon-containing material.

In related variations, a biogenic reagent production system comprises:
(a) a feeder configured to introduce a carbon-containing feedstock;
(b) an optional dryer, disposed in operable communication with the feeder, configured to remove moisture contained within a carbon-containing feedstock;
(c) a multiple-zone reactor, disposed in operable communication with the dryer, wherein the multiple-zone reactor contains at least a pyrolysis zone disposed in operable communication with a spatially separated cooling zone, and wherein the multiple-zone reactor is configured with an outlet to remove condensable vapors and non-condensable gases from solids;
(d) a solids cooler, disposed in operable communication with the multiple-zone reactor;
(e) a material-enrichment unit, disposed in operable communication with the solids cooler, configured to pass the condensable vapors or the non-condensable gases across the solids, to form enhanced solids with increased carbon content; and
(f) a high-carbon biogenic reagent recovery unit, disposed in operable communication with the material-enrichment unit.

The system can further comprise a preheating zone, disposed in operable communication with the pyrolysis zone. In some embodiments, the dryer is configured as a drying zone within the multiple-zone reactor. Each of the zones can be located within a single unit or in separate units. Also, the solids cooler can be disposed within the multiple-zone reactor.

In some embodiments, the cooling zone is configured with a gas inlet, and the pyrolysis zone is configured with a gas outlet, to generate substantially countercurrent flow of the gas phase relative to the solid phase. In these or other embodiments, the preheating zone or the drying zone (or dryer) is configured with a gas outlet, to generate substantially countercurrent flow of the gas phase relative to the solid phase.

In particular embodiments, the system incorporates a material-enrichment unit that comprises:
(i) a housing with an upper portion and a lower portion;
(ii) an inlet at a bottom of the lower portion of the housing configured to carry the condensable vapors and non-condensable gases;
(iii) an outlet at a top of the upper portion of the housing configured to carry a concentrated gas stream derived from the condensable vapors and non-condensable gases;
(iv) a path defined between the upper portion and the lower portion of the housing; and
(v) a transport system following the path, the transport system configured to transport the solids, wherein the housing is shaped such that the solids adsorb at least some of the condensable vapors or at least some of the non-condensable gases.

The present invention is capable of producing a variety of compositions useful as biogenic reagents, and products incorporating such reagents. In some variations, a biogenic reagent is produced by any process disclosed herein, such as a process comprising the steps of:
(a) providing a carbon-containing feedstock comprising biomass;
(b) optionally drying the feedstock to remove at least a portion of moisture contained within the feedstock;
(c) optionally deaerating the feedstock to remove at least a portion of interstitial oxygen, if any, contained with the feedstock;
(d) in a pyrolysis zone, pyrolyzing the feedstock in the presence of a substantially inert gas for at least 10 minutes and with a pyrolysis temperature selected from about 150° C. to about 600° C., to generate hot pyrolyzed solids, condensable vapors, and non-condensable gases;
(e) separating at least a portion of the condensable vapors and at least a portion of the non-condensable gases from the hot pyrolyzed solids;
(f) in a cooling zone, cooling the hot pyrolyzed solids, in the presence of the substantially inert gas for at least 5 minutes and with a cooling temperature less than the pyrolysis temperature, to generate warm pyrolyzed solids;
(g) cooling the warm pyrolyzed solids to generate cool pyrolyzed solids; and
(h) recovering a high-carbon biogenic reagent comprising at least a portion of the cool pyrolyzed solids.

In some embodiments, the reagent comprises about at least 70 wt %, at least 80 wt %, at least 90 wt %, or at least 95 wt % total carbon on a dry basis. The total carbon includes at least fixed carbon, and can further include carbon from volatile matter. In some embodiments, carbon from volatile matter is about at least 5%, at least 10%, at least 25%, or at least 50% of the total carbon present in the high-carbon biogenic reagent. Fixed carbon can be measured using ASTM D3172, while volatile carbon can be measured using ASTM D3175, for example.

The high-carbon biogenic reagent can comprise about 10 wt % or less, such as about 5 wt % or less, hydrogen on a dry basis. The biogenic reagent can comprise about 1 wt % or less, such as about 0.5 wt % or less, nitrogen on a dry basis. The biogenic reagent can comprise about 0.5 wt % or less, such as about 0.2 wt % or less, phosphorus on a dry basis. The biogenic reagent can comprise about 0.2 wt % or less, such as about 0.1 wt % or less, sulfur on a dry basis.

Carbon, hydrogen, and nitrogen can be measured using ASTM D5373 for ultimate analysis, for example. Oxygen can be measured using ASTM D3176, for example. Sulfur can be measured using ASTM D3177, for example.

Certain embodiments provide reagents with little or essentially no hydrogen (except from any moisture that can be present), nitrogen, phosphorus, or sulfur, and are substantially carbon plus any ash and moisture present. Therefore, some embodiments provide a biogenic reagent with up to and including 100% carbon, on a dry/ash-free (DAF) basis.

Generally speaking, feedstocks such as biomass contain non-volatile species, including silica and various metals, which are not readily released during pyrolysis. It is of course possible to utilize ash-free feedstocks, in which case there should not be substantial quantities of ash in the pyrolyzed solids. Ash can be measured using ASTM D3174, for example.

Various amounts of non-combustible matter, such as ash, can be present. The high-carbon biogenic reagent can comprise about 10 wt % or less, such as about 5 wt %, about 2 wt %, about 1 wt % or less non-combustible matter on a dry basis. In certain embodiments, the reagent contains little ash, or even essentially no ash or other non-combustible matter. Therefore, some embodiments provide essentially pure carbon, including 100% carbon, on a dry basis.

Various amounts of moisture can be present. On a total mass basis, the high-carbon biogenic reagent can comprise at least 1 wt %, 2 wt %, 5 wt %, 10 wt %, 15 wt %, 25 wt %, 35 wt %, 50 wt %, or more moisture. As intended herein, “moisture” is to be construed as including any form of water present in the biogenic reagent, including absorbed moisture, adsorbed water molecules, chemical hydrates, and physical hydrates. The equilibrium moisture content can vary at least with the local environment, such as the relative humidity. Also, moisture can vary during transportation, preparation for use, and other logistics. Moisture can be measured using ASTM D3173, for example.

The biogenic reagent can have various energy contents which for present purposes means the energy density based on the higher heating value associated with total combustion of the bone-dry reagent. For example, the high-carbon biogenic reagent can possess an energy content of about at least 11,000 Btu/lb, at least 12,000 Btu/lb, at least 13,000 Btu/lb, at least 14,000 Btu/lb, or at least 15,000 Btu/lb. In certain embodiments, the energy content is between about 14,000-15,000 Btu/lb. The energy content can be measured using ASTM D5865, for example.

The biogenic reagent can be formed into a powder, such as a coarse powder or a fine powder. For example, the reagent can be formed into a powder with an average mesh size of about 200 mesh, about 100 mesh, about 50 mesh, about 10 mesh, about 6 mesh, about 4 mesh, or about 2 mesh, in embodiments.

In some embodiments, the biogenic reagent is formed into structural objects comprising pressed, binded, or agglomerated particles. The starting material to form these objects can be a powder form of the reagent, such as an intermediate obtained by particle-size reduction. The objects can be formed by mechanical pressing or other forces, optionally with a binder or other means of agglomerating particles together.

In some embodiments, the biogenic reagent is produced in the form of structural objects whose structure substantially derives from the feedstock. For example, feedstock chips can produce product chips of biogenic reagent. Or, feedstock cylinders can produce high-carbon biogenic reagent cylinders, which can be somewhat smaller but otherwise maintain the basic structure and geometry of the starting material.

A biogenic reagent according to the present invention can be produced as, or formed into, an object that has a minimum dimension of at least about 1 cm, 2 cm, 3 cm, 4 cm, 5 cm, 6 cm, 7 cm, 8 cm, 9 cm, 10 cm, or greater. In various embodiments, the minimum dimension or maximum dimension can be a length, width, or diameter.

Other variations of the invention relate to the incorporation of additives into the process, into the product, or both. In some embodiments, the high-carbon biogenic reagent includes at least one process additive incorporated during the process. In these or other embodiments, the reagent includes at least one product additive introduced to the reagent following the process.

In some embodiments, a biogenic reagent comprises, on a dry basis:
70 wt % or more total carbon;
5 wt % or less hydrogen;
1 wt % or less nitrogen;
0.5 wt % or less phosphorus;
0.2 wt % or less sulfur; and
an additive selected from a metal, a metal oxide, a metal hydroxide, a metal halide, or a combination thereof.

The additive can be selected from, but is by no means limited to, magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, and combinations thereof.

In some embodiments, a high-carbon biogenic reagent comprises, on a dry basis:
70 wt % or more total carbon;
5 wt % or less hydrogen;
1 wt % or less nitrogen;
0.5 wt % or less phosphorus;
0.2 wt % or less sulfur; and
an additive selected from an acid, a base, or a salt thereof.

The additive can be selected from, but is by no means limited to, sodium hydroxide, potassium hydroxide, magnesium oxide, hydrogen bromide, hydrogen chloride, sodium silicate, potassium permanganate, or combinations thereof.

In certain embodiments, a high-carbon biogenic reagent comprises, on a dry basis:
70 wt % or more total carbon;
5 wt % or less hydrogen;
1 wt % or less nitrogen;
0.5 wt % or less phosphorus;
0.2 wt % or less sulfur;
a first additive selected from a metal, metal oxide, metal hydroxide, a metal halide, or a combination thereof; and
a second additive selected from an acid, a base, or a salt thereof,
wherein the first additive is different from the second additive.

The first additive can be selected from magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, and combinations thereof, while the second additive can be independently selected from sodium hydroxide, potassium hydroxide, magnesium oxide, hydrogen bromide, hydrogen chloride, sodium silicate, potassium permanganate, or combinations thereof.

A certain high-carbon biogenic reagent consists essentially of, on a dry basis, carbon, hydrogen, nitrogen, phosphorus, sulfur, non-combustible matter, and an additive selected from magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, or combinations thereof.

A certain high-carbon biogenic reagent consists essentially of, on a dry basis, carbon, hydrogen, nitrogen, phosphorus, sulfur, non-combustible matter, and an additive selected from sodium hydroxide, potassium hydroxide, magnesium oxide, hydrogen bromide, hydrogen chloride, sodium silicate, or combinations thereof.

The amount of additive (or total additives) can vary widely, such as from about 0.01 wt % to about 25 wt %, including about 0.1 wt %, about 1 wt %, about 5 wt %, about 10 wt %, or about 20 wt %. It will be appreciated then when relatively large amounts of additives are incorporated, such as greater than about 1 wt %, there will be a reduction in energy content calculated on the basis of the total reagent weight (inclusive of additives). Still, in various embodiments, the high-carbon biogenic reagent comprising an additive(s) can possess an energy content of about at least 11,000 Btu/lb, at least 12,000 Btu/lb, at least 13,000 Btu/lb, at least 14,000 Btu/lb, or at least 15,000 Btu/lb.

The above discussion regarding product form applies also to embodiments that incorporate additives. In fact, certain embodiments incorporate additives as binding agents, fluxing agents, or other modifiers to enhance final properties for a particular application.

In certain embodiments, the majority of carbon contained in the high-carbon biogenic reagent is classified as renewable carbon. In some embodiments, substantially all of the carbon is classified as renewable carbon. There can be certain market mechanisms (e.g., Renewable Identification Numbers, tax credits, etc.) wherein value is attributed to the renewable carbon content within the high-carbon biogenic reagent.

In certain embodiments, the fixed carbon can be classified as non-renewable carbon (e.g., from coal) while the volatile carbon, which can be added separately, can be renewable carbon to increase not only energy content but also renewable carbon value.

The high-carbon biogenic reagents produced as described herein is useful for a wide variety of carbonaceous products. The high-carbon biogenic reagent can be a desirable market product itself. High-carbon biogenic reagents as provided herein are associated with lower levels of impurities, reduced process emissions, and improved sustainability (including higher renewable carbon content) compared to the state of the art.

In variations, a product includes any of the high-carbon biogenic reagents that can be obtained by the disclosed processes, or that are described in the compositions set forth herein, or any portions, combinations, or derivatives thereof.

Generally speaking, the high-carbon biogenic reagents can be combusted to produce energy (including electricity and heat); partially oxidized, gasified, or steam-reformed to produce syngas; utilized for their adsorptive or absorptive properties; utilized for their reactive properties during metal refining (such as reduction of metal oxides) or other industrial processing; or utilized for their material properties in carbon steel and various other metal alloys. Essentially, the high-carbon biogenic reagents can be utilized for any market application of carbon-based commodities or advanced materials, including specialty uses to be developed.

Prior to suitability or actual use in any product applications, the disclosed high-carbon biogenic reagents can be analyzed, measured, and optionally modified (such as through additives) in various ways. Some properties of potential interest, other than chemical composition and energy content, include density, particle size, surface area, microporosity, absorptivity, adsorptivity, binding capacity, reactivity, desulfurization activity, and basicity, to name a few properties.

Products or materials that can incorporate these high-carbon biogenic reagents include, but are by no means limited to, carbon-based blast furnace addition products, carbon-based taconite pellet addition products, ladle addition carbon-based products, met coke carbon-based products, coal replacement products, carbon-based coking products, carbon breeze products, fluidized-bed carbon-based feedstocks, carbon-based furnace addition products, injectable carbon-based products, pulverized carbon-based products, stoker carbon-based products, carbon electrodes, or activated carbon products.

Certain use of the disclosed biogenic reagents in metals production can reduce slag, increase overall efficiency, and reduce lifecycle environmental impacts.

Some variations of the invention utilize high-carbon biogenic reagents as carbon-based blast furnace addition products. A blast furnace is a type of metallurgical furnace used for smelting to produce industrial metals, such as (but not limited to) iron. Smelting is a form of extractive metallurgy; its main use is to produce a metal from its ore. Smelting uses heat and a chemical reducing agent to decompose the ore. The carbon or the carbon monoxide derived from the carbon removes oxygen from the ore, leaving behind elemental metal.

The reducing agent can comprise or consist essentially of a high-carbon biogenic reagent. In a blast furnace, high-carbon biogenic reagent, ore, and typically limestone can be continuously supplied through the top of the furnace, while air (optionally with oxygen enrichment) is blown into the bottom of the chamber, so that the chemical reactions take place throughout the furnace as the material moves downward. The end products are usually molten metal and slag phases tapped from the bottom, and flue gases exiting from the top of the furnace. The downward flow of the ore in contact with an upflow of hot, carbon monoxide-rich gases is a countercurrent process.

Carbon quality in the blast furnace is measured by its resistance to degradation. The role of the carbon as a permeable medium is crucial in economic blast furnace operation. The degradation of the carbon varies with the position in the blast furnace and involves the combination of reaction with CO₂, H₂O, or O₂ and the abrasion of carbon particles against each other and other components of the burden. Degraded carbon particles can cause plugging and poor performance.

The Coke Reactivity test is a highly regarded measure of the performance of carbon in a blast furnace. This test has two components: the Coke Reactivity Index (CRI) and the Coke Strength after Reaction (CSR). A carbon-based material with a low CRI value (high reactivity) and a high CSR value is preferable for better blast furnace performance. CRI can be determined according to any suitable method known in the art, for example by ASTM Method DS341 on an as-received basis.

In some embodiments, the high-carbon biogenic reagent provides a carbon product having suitable properties for introduction directly into a blast furnace.

The strength of the high-carbon biogenic reagent can be determined by any suitable method known in the art, for example by a drop-shatter test, or a CSR test. In some embodiments, the high-carbon biogenic reagent, optionally when blended with another source of carbon, provides a final carbon product having CSR of at least about 50%, 60%, or 70%. A combination product can also provide a final coke product having a suitable reactivity for combustion in a blast furnace. In some embodiments, the product has a CRI such that the high-carbon biogenic reagent is suitable for use as an additive or replacement for met coal, met coke, coke breeze, foundry coke, or injectable coal.

Some embodiments employ one or more additives in an amount sufficient to provide a high-carbon biogenic reagent that, when added to another carbon source (e.g., coke) having a CRI or CSR insufficient for use as a blast furnace product, provides a composite product with a CRI or CSR sufficient for use in a blast furnace. In some embodiments, one or more additives are present in an amount sufficient to provide a high-carbon biogenic reagent having a CRI of not more than about 40%, 30%, or 20%.

In some embodiments, one or more additives selected from the alkaline earth metals, or oxides or carbonates thereof, are introduced during or after the process of producing a high-carbon biogenic reagent. For example, calcium, calcium oxide, calcium carbonate, magnesium oxide, or magnesium carbonate can be introduced as additives. The addition of these compounds before, during, or after pyrolysis can increase the reactivity of the high-carbon biogenic reagent in a blast furnace. These compounds can lead to stronger materials, i.e., greater CSR, thereby improving blast-furnace efficiency. In addition, additives such as those selected from the alkaline earth metals, or oxides or carbonates thereof, can lead to lower emissions (e.g., SO₂).

In some embodiments, a blast furnace replacement product is a high-carbon biogenic reagent according to the present invention comprising at least about 55 wt % carbon, not more than about 0.5 wt % sulfur, not more than about 8 wt % non-combustible material, and a heat value of at least about 11,000 Btu per pound. In some embodiments, the blast furnace replacement product further comprises not more than about 0.035 wt % phosphorous, about 0.5 wt % to about 50 wt % volatile matter, and optionally one or more additives. In some embodiments, the blast furnace replacement product comprises about 2 wt % to about 15 wt % dolomite, about 2 wt % to about 15 wt % dolomitic lime, about 2 wt % to about 15 wt % bentonite, or about 2 wt % to about 15 wt % calcium oxide. In some embodiments, the blast furnace replacement product has dimensions substantially in the range of about 1 cm to about 10 cm.

In some embodiments, a high-carbon biogenic reagent according to the present invention is useful as a foundry coke replacement product. Foundry coke is generally characterized as having a carbon content of at least about 85 wt %, a sulfur content of about 0.6 wt %, not more than about 1.5 wt % volatile matter, not more than about 13 wt % ash, not more than about 8 wt % moisture, about 0.035 wt % phosphorus, a CRI value of about 30, and dimensions ranging from about 5 cm to about 25 cm.

Some variations of the invention utilize the high-carbon biogenic reagents as carbon-based taconite pellet addition products. The ores used in making iron and steel are iron oxides. Major iron oxide ores include hematite, limonite (also called brown ore), taconite, and magnetite, a black ore. Taconite is a low-grade but important ore, which contains both magnetite and hematite. The iron content of taconite is generally 25 wt % to 30 wt %. Blast furnaces typically require at least a 50 wt % iron content ore for efficient operation. Iron ores can undergo beneficiation including crushing, screening, tumbling, flotation, and magnetic separation. The refined ore is enriched to over 60% iron and is often formed into pellets before shipping.

For example, taconite can be ground into a fine powder and combined with a binder such as bentonite clay and limestone. Pellets about one centimeter in diameter can be formed, containing approximately 65 wt % iron, for example. The pellets are fired, oxidizing magnetite to hematite. The pellets are durable which ensures that the blast furnace charge remains porous enough to allow heated gas to pass through and react with the pelletized ore.

The taconite pellets can be fed to a blast furnace to produce iron, as described above with reference to blast furnace addition products. In some embodiments, a high-carbon biogenic reagent is introduced to the blast furnace. In these or other embodiments, a high-carbon biogenic reagent is incorporated into the taconite pellet itself. For example, taconite ore powder, after beneficiation, can be mixed with a high-carbon biogenic reagent and a binder and rolled into small objects, then baked to hardness. In such embodiments, taconite-carbon pellets with the appropriate composition can conveniently be introduced into a blast furnace without the need for a separate source of carbon.

Some variations of the invention utilize the high-carbon biogenic reagents as ladle addition carbon-based products. A ladle is a vessel used to transport and pour out molten metals. Casting ladles are used to pour molten metal into molds to produce the casting. Transfers ladle are used to transfer a large amount of molten metal from one process to another. Treatment ladles are used for a process to take place within the ladle to change some aspect of the molten metal, such as the conversion of cast iron to ductile iron by the addition of various elements into the ladle.

High-carbon biogenic reagents can be introduced to any type of ladle, but typically carbon will be added to treatment ladles in suitable amounts based on the target carbon content. Carbon injected into ladles can be in the form of fine powder, for good mass transport of the carbon into the final composition. In some embodiments, a high-carbon biogenic reagent according to the present invention, when used as a ladle addition product, has a minimum dimension of about 0.5 cm, such as about 0.75 cm, about 1 cm, about 1.5 cm, or greater.

In some embodiments, a high carbon biogenic reagent according to the present invention is useful as a ladle addition carbon additive at, for example, basic oxygen furnace or electric arc furnace facilities wherever ladle addition of carbon would be used (e.g., added to ladle carbon during steel manufacturing).

In some embodiments, the ladle addition carbon additive additionally comprises up to about 5 wt % manganese, up to about 5 wt % calcium oxide, or up to about 5 wt % dolomitic lime.

Direct-reduced iron (DRI), also called sponge iron, is produced from direct reduction of iron ore (in the form of lumps, pellets, or fines) by a reducing gas conventionally produced from natural gas or coal. The reducing gas is typically syngas, a mixture of hydrogen and carbon monoxide which acts as reducing agent. The high-carbon biogenic reagent as provided herein can be converted into a gas stream comprising CO, to act as a reducing agent to produce direct-reduced iron.

Iron nuggets are a high-quality steelmaking and iron-casting feed material. Iron nuggets are essentially all iron and carbon, with almost no gangue (slag) and low levels of metal residuals. They are a premium grade pig iron product with superior shipping and handling characteristics. The carbon contained in iron nuggets, or any portion thereof, can be the high-carbon biogenic reagent provided herein. Iron nuggets can be produced through the reduction of iron ore in a rotary hearth furnace, using a high-carbon biogenic reagent as the reductant and energy source.

Some variations of the invention utilize the high-carbon biogenic reagents as metallurgical coke carbon-based products. Metallurgical coke, also known as “met” coke, is a carbon material normally manufactured by the destructive distillation of various blends of bituminous coal. The final solid is a non-melting carbon called metallurgical coke. As a result of the loss of volatile gases and of partial melting, met coke has an open, porous morphology. Met coke has a very low volatile content. However, the ash constituents, that were part of the original bituminous coal feedstock, remain encapsulated in the resultant coke. Met coke feedstocks are available in a wide range of sizes from fine powder to basketball-sized lumps. Typical purities range from 86-92 wt % fixed carbon.

Metallurgical coke is used where a high-quality, tough, resilient, wearing carbon is required. Applications include, but are not limited to, conductive flooring, friction materials (e.g., carbon linings), foundry coatings, foundry carbon raiser, corrosion materials, drilling applications, reducing agents, heat-treatment agents, ceramic packing media, electrolytic processes, and oxygen exclusion.

Met coke can be characterized as having a heat value of about 10,000 to 14,000 Btu per pound and an ash content of about 10 wt % or greater. Thus, in some embodiments, a met coke replacement product comprises a high-carbon biogenic reagent according to the present invention (e.g., a carbon-negative pellet) comprising at least about 80 wt %, 85 wt %, or 90 wt % carbon, not more than about 0.8 wt % sulfur, not more than about 3 wt % volatile matter, not more than about 15 wt % ash, not more than about 13 wt % moisture, and not more than about 0.035 wt % phosphorus. A high-carbon biogenic reagent according to the present invention, when used as a met coke replacement product, can have a size range from about 2 cm to about 15 cm, for example.

In some embodiments, the met coke replacement product further comprises an additive such as chromium, nickel, manganese, magnesium oxide, silicon, aluminum, dolomite, fluorospar, calcium oxide, lime, dolomitic lime, bentonite and combinations thereof.

Some variations of the invention utilize the high-carbon biogenic reagents as coal replacement products. Any process or system using coal can in principle be adapted to use a high-carbon biogenic reagent.

In some embodiments, a high-carbon biogenic reagent is combined with one or more coal-based products to form a composite product having a greater rank than the coal-based product(s) or having fewer emissions, when burned, than the pure coal-based product.

For example, a low-rank coal such as sub-bituminous coal can be used in applications normally calling for a greater-rank coal product, such as bituminous coal, by combining a selected amount of a high-carbon biogenic reagent according to the present invention with the low-rank coal product. In other embodiments, the rank of a mixed coal product (e.g., a combination of a plurality of coals of different rank) can be improved by combining the mixed coal with some amount of high-carbon biogenic reagent. The amount of a high-carbon biogenic reagent to be mixed with the coal product(s) can vary depending on the rank of the coal product(s), the characteristics of the high-carbon biogenic reagent (e.g., carbon content, heat value, etc.) and the desired rank of the final combined product.

For example, anthracite coal is generally characterized as having at least about 80 wt % carbon, about 0.6 wt % sulfur, about 5 wt % volatile matter, up to about 15 wt % ash, up to about 10 wt % moisture, and a heat value of about 12,494 Btu/lb. In some embodiments, an anthracite coal replacement product is a high-carbon biogenic reagent comprising at least about 80 wt % carbon, not more than about 0.6 wt % sulfur, not more than about 15 wt % ash, and a heat value of at least about 12,000 Btu/lb.

In some embodiments, a high-carbon biogenic reagent is useful as a thermal coal replacement product. Thermal coal products are generally characterized as having high sulfur levels, high phosphorus levels, high ash content, and heat values of up to about 15,000 Btu/lb. In some embodiments, a thermal coal replacement product is a high-carbon biogenic reagent comprising not more than about 0.5 wt % sulfur, not more than about 4 wt % ash, and a heat value of at least about 12,000 Btu/lb.

Some variations of the invention utilize the high-carbon biogenic reagents as carbon-based coking products. Any coking process or system can be adapted to use high-carbon biogenic reagents to produce coke or use it as a coke feedstock.

In some embodiments, a high-carbon biogenic reagent is useful as a thermal coal or coke replacement product. For example, a thermal coal or coke replacement product can consist essentially of a high-carbon biogenic reagent comprising at least about 50 wt % carbon, not more than about 8 wt % ash, not more than about 0.5 wt % sulfur, and a heat value of at least about 11,000 Btu/lb. In other embodiments, the thermal coke replacement product further comprises about 0.5 wt % to about 50 wt % volatile matter. The thermal coal or coke replacement product can include about 0.4 wt % to about 15 wt % moisture.

In some embodiments, a high-carbon biogenic reagent is useful as a petroleum (pet) coke or calcine pet coke replacement product. Calcine pet coke is generally characterized as having at least about 66 wt % carbon, up to 4.6 wt % sulfur, up to about 5.5 wt % volatile matter, up to about 19.5 wt % ash, and up to about 2 wt % moisture, and is typically sized at about 3 mesh or less. In some embodiments, the calcine pet coke replacement product is a high-carbon biogenic reagent comprising at least about 66 wt % carbon, not more than about 4.6 wt % sulfur, not more than about 19.5 wt % ash, not more than about 2 wt % moisture, and is sized at about 3 mesh or less.

In some embodiments, a high-carbon biogenic reagent is useful as a coking carbon replacement carbon (e.g., co-fired with metallurgical coal in a coking furnace). In one embodiment, a coking carbon replacement product is a high-carbon biogenic reagent comprising at least about 55 wt % carbon, not more than about 0.5 wt % sulfur, not more than about 8 wt % non-combustible material, and a heat value of at least about 11,000 Btu per pound. In some embodiments, the coking carbon replacement product comprises about 0.5 wt % to about 50 wt % volatile matter, or one or more additives.

Some variations of the invention utilize the high-carbon biogenic reagents as carbon breeze products, which typically have very fine particle sizes such as 6 mm, 3 mm, 2 mm, 1 mm, or smaller. In some embodiments, a high-carbon biogenic reagent according to the present invention is useful as a coke breeze replacement product. Coke breeze is generally characterized as having a maximum dimension of not more than about 6 mm, a carbon content of at least about 80 wt %, 0.6 to 0.8 wt % sulfur, 1% to 20 wt % volatile matter, up to about 13 wt % ash, and up to about 13 wt % moisture. In some embodiments, a coke breeze replacement product is a high-carbon biogenic reagent according to the present invention comprising at least about 80 wt % carbon, not more than about 0.8 wt % sulfur, not more than about 20 wt % volatile matter, not more than about 13 wt % ash, not more than about 13 wt % moisture, and a maximum dimension of about 6 mm.

In some embodiments, a high-carbon biogenic reagent is useful as a carbon breeze replacement product during, for example, taconite pellet production or in an iron-making process.

Some variations utilize the high-carbon biogenic reagents as feedstocks for various fluidized beds, or as fluidized-bed carbon-based feedstock replacement products. The carbon can be employed in fluidized beds for total combustion, partial oxidation, gasification, steam reforming, or the like. The carbon can be primarily converted into syngas for various downstream uses, including production of energy (e.g., combined heat and power), or liquid fuels (e.g., methanol or Fischer-Tropsch diesel fuels).

In some embodiments, a high-carbon biogenic reagent according to the present invention is useful as a fluidized-bed coal replacement product in, for example, fluidized bed furnaces wherever coal would be used (e.g., for process heat or energy production).

Some variations utilize the high-carbon biogenic reagents as carbon-based furnace addition products. Coal-based carbon furnace addition products are generally characterized as having high sulfur levels, high phosphorus levels, and high ash content, which contribute to degradation of the metal product and create air pollution. In some embodiments, a carbon furnace addition replacement product comprising a high-carbon biogenic reagent comprises not more than about 0.5 wt % sulfur, not more than about 4 wt % ash, not more than about 0.03 wt % phosphorous, and a maximum dimension of about 7.5 cm. In some embodiments, the carbon furnace addition replacement product replacement product comprises about 0.5 wt % to about 50 wt % volatile matter and about 0.4 wt % to about 15 wt % moisture.

In some embodiments, a high-carbon biogenic reagent is useful as a furnace addition carbon additive at, for example, basic oxygen furnace or electric arc furnace facilities wherever furnace addition carbon would be used. For example, furnace addition carbon can be added to scrap steel during steel manufacturing at electric-arc furnace facilities). For electric-arc furnace applications, high-purity carbon is desired so that impurities are not introduced back into the process following earlier removal of impurities.

In some embodiments, a furnace addition carbon additive is a high-carbon biogenic reagent comprising at least about 80 wt % carbon, not more than about 0.5 wt % sulfur, not more than about 8 wt % non-combustible material, and a heat value of at least about 11,000 Btu per pound. In some embodiments, the furnace addition carbon additive further comprises up to about 5 wt % manganese, up to about 5 wt % fluorospar, about 5 wt % to about 10 wt % dolomite, about 5 wt % to about 10 wt % dolomitic lime, or about 5 wt % to about 10 wt % calcium oxide.

Some variations utilize the high-carbon biogenic reagents as stoker furnace carbon-based products. In some embodiments, a high-carbon biogenic reagent according to the present invention is useful as a stoker coal replacement product at, for example, stoker furnace facilities wherever coal would be used (e.g., for process heat or energy production).

Some variations utilize the high-carbon biogenic reagents as injectable (e.g., pulverized) carbon-based materials. In some embodiments, a high-carbon biogenic reagent is useful as an injection-grade calcine pet coke replacement product. Injection-grade calcine pet coke is generally characterized as having at least about 66 wt % carbon, about 0.55 to about 3 wt % sulfur, up to about 5.5 wt % volatile matter, up to about 10 wt % ash, up to about 2 wt % moisture, and is sized at about 6 mesh or less. In some embodiments, a calcine pet coke replacement product is a high-carbon biogenic reagent comprising at least about 66 wt % carbon, not more than about 3 wt % sulfur, not more than about 10 wt % ash, not more than about 2 wt % moisture, and is sized at about 6 mesh or less.

In some embodiments, a high-carbon biogenic reagent is useful as an injectable carbon replacement product at, for example, basic oxygen furnace or electric arc furnace facilities in any application where injectable carbon would be used (e.g., injected into slag or ladle during steel manufacturing).

In some embodiments, a high-carbon biogenic reagent is useful as a pulverized carbon replacement product, for example, wherever pulverized coal would be used (e.g., for process heat or energy production). In some embodiments, the pulverized coal replacement product comprises up to about 10 percent calcium oxide.

Some variations utilize the high-carbon biogenic reagents as carbon addition product for metals production. In some embodiments, a high-carbon biogenic reagent according to the present invention is useful as a carbon addition product for production of carbon steel or another metal alloy comprising carbon. Coal-based late-stage carbon addition products are generally characterized as having high sulfur levels, high phosphorous levels, and high ash content, and high mercury levels which degrade metal quality and contribute to air pollution. In some embodiments of this invention, the carbon addition product comprises not more than about 0.5 wt % sulfur, not more than about 4 wt % ash, not more than about 0.03 wt % phosphorus, a minimum dimension of about 1 to 5 mm, and a maximum dimension of about 8 to 12 mm.

Some variations utilize the high-carbon biogenic reagents within carbon electrodes. In some embodiments, a high-carbon biogenic reagent is useful as an electrode (e.g., anode) material suitable for use, for example, in aluminum production.

Other uses of the high-carbon biogenic reagent in carbon electrodes include applications in batteries, fuel cells, capacitors, and other energy-storage or energy-delivery devices. For example, in a lithium-ion battery, the high-carbon biogenic reagent can be used on the anode side to intercalate lithium. In these applications, carbon purity and low ash can be very important.

Some variations of the invention utilize the high-carbon biogenic reagents as catalyst supports. Carbon is a known catalyst support in a wide range of catalyzed chemical reactions, such as mixed-alcohol synthesis from syngas using sulfided cobalt-molybdenum metal catalysts supported on a carbon phase, or iron-based catalysts supported on carbon for Fischer-Tropsch synthesis of higher hydrocarbons from syngas.

Some variations utilize the high-carbon biogenic reagents as activated carbon products. Activated carbon is used in a wide variety of liquid and gas-phase applications, including water treatment, air purification, solvent vapor recovery, food and beverage processing, and pharmaceuticals. For activated carbon, the porosity and surface area of the material are generally important. The high-carbon biogenic reagent provided herein can provide a superior activated carbon product, in various embodiments, due to (i) greater surface area than fossil-fuel based activated carbon; (ii) carbon renewability; (iii) vascular nature of biomass feedstock in conjunction with additives better allows penetration/distribution of additives that enhance pollutant control; and (iv) less inert material (ash) leads to greater reactivity.

It should be recognized that in the above description of market applications of biogenic reagents, the described applications are not exclusive, nor are they exhaustive. Thus a biogenic reagent that is described as being suitable for one type of carbon product can be suitable for any other application described, in various embodiments. These applications are exemplary only, and there are other applications of biogenic reagents, or derivatives thereof.

In addition, in some embodiments, the same physical material can be used in multiple market processes, either in an integrated way or in sequence. Thus, for example, a high-carbon biogenic reagent that is used as a carbon electrode or an activated carbon may, at the end of its useful life as a performance material, then be introduced to a combustion process for energy value or to a metal-making (e.g., metal ore reduction) process, etc.

Some embodiments can employ a biogenic reagent both for its reactive or adsorptive properties and also as a fuel. For example, a biogenic reagent injected into an emissions stream can be suitable to remove contaminants, followed by combustion of the biogenic reagent particles and possibly the contaminants, to produce energy and thermally destroy or chemically oxidize the contaminants.

Significant environmental and product use advantages can be associated with high-carbon biogenic reagents, compared to conventional fossil-fuel-based products. The high-carbon biogenic reagents can be not only environmentally superior, but also functionally superior from a processing standpoint because of greater purity, for example.

With regard to some embodiments of metals production, production of biogenic reagents with disclosed processes can result in significantly lower emissions of CO, CO₂, NOx, SO₂, and hazardous air pollutants compared to the coking of coal-based products necessary to prepare them for use in metals production.

Use of high-carbon biogenic reagents in place of coal or coke also significantly reduces environmental emissions of SO₂, hazardous air pollutants, and mercury.

Also, because of the purity of these high-carbon biogenic reagents (including low ash content), the disclosed biogenic reagents have the potential to reduce slag and increase production capacity in batch metal-making processes.

In some embodiments, the biogenic reagent functions as an activated carbon or other filtration media. In certain embodiments, a portion of the biogenic reagent is recovered as an activated carbon product or a filtration media product, while another portion (e.g., the remainder) of the biogenic reagent is pelletized with a binder to produce biocarbon pellets. In other embodiments, the biogenic reagent is pelletized with a binder to produce biocarbon pellets that are shipped for later conversion to an activated carbon product. The later conversion can include pulverizing back to a powder, and can also include chemical treatment with, e.g., steam, acids, or bases. In these embodiments, the biocarbon pellets can be regarded as activated-carbon or filtration-media precursor pellets.

The activated carbon, when produced, can be characterized by an Iodine Number of at least about 500, 750, 800, 1000, 1500, or 2000, for example. The activated carbon is can be characterized by a renewable carbon content of at least 50%, 60%, 70%, 80%, 90%, or 95% as determined from a measurement of the ¹⁴C/¹²C isotopic ratio of the activated carbon. In some embodiments, the activated carbon is characterized as (fully) renewable activated carbon as determined from a measurement of the ¹⁴C/¹²C isotopic ratio of the activated carbon.

In some embodiments, the pyrolysis reactor is configured for optimizing the production of different types of activated carbon. For example, reaction conditions (e.g., time, temperature, and steam concentration) can be selected for an activated carbon product with certain attributes such as Iodine Number. Different reaction conditions can be selected for a different activated carbon product, such as one with a greater Iodine Number. The pyrolysis reactor can be operated in a campaign mode to produce one product and then switched to another mode for another product. The first product can have been continuously or periodically removed during the first campaign, or can be removed prior to switching the reaction conditions of the pyrolysis reactor.

The activated carbon can be characterized by an Iodine Number of at least about 500, 750, 1000, 1500, or 2000, for example. The activated carbon can be characterized by a renewable carbon content of at least 90% as determined from a measurement of the ¹⁴C/¹²C isotopic ratio of the activated carbon. In some embodiments, the activated carbon is characterized as (fully) renewable activated carbon as determined from a measurement of the ¹⁴C/¹²C isotopic ratio of the activated carbon.

Activated carbon or filtration media produced by the processes disclosed herein can be used in a number of ways.

In some embodiments, the activated carbon or filtration media is utilized internally at the process site to purify the one or more primary products. In some embodiments, the activated carbon is utilized at the site to purify water. In these or other embodiments, the activated carbon or filtration media is utilized at the site to treat a liquid waste stream to reduce liquid-phase emissions or to treat a vapor waste stream to reduce air emissions. In some embodiments, the activated carbon or filtration media is utilized as a soil amendment to assist generation of new biomass, which can be the same type of biomass utilized as local feedstock at the site.

Activated carbon or filtration media prepared according to the processes disclosed herein can have the same or better characteristics as traditional fossil fuel-based activated carbon. In some embodiments, the activated carbon or filtration media has a surface area that is comparable to, equal to, or greater than surface area associated with fossil fuel-based activated carbon. In some embodiments, the activated carbon or filtration media can control pollutants as well as or better than traditional activated carbon products. In some embodiments, the activated carbon or filtration media has an inert material (e.g., ash) level that is comparable to, equal to, or less than an inert material (e.g., ash) level associated with a traditional activated carbon product. In some embodiments, the activated carbon or filtration media has a particle size or a particle size distribution that is comparable to, equal to, greater than, or less than a particle size or a particle size distribution associated with a traditional activated carbon product. In some embodiments, the activated carbon or filtration media has a particle shape that is comparable to, substantially similar to, or the same as a particle shape associated with a traditional activated carbon product. In some embodiments, the activated carbon or filtration media has a particle shape that is substantially different than a particle shape associated with a traditional activated carbon product. In some embodiments, the activated carbon or filtration media has a pore volume that is comparable to, equal to, or greater than a pore volume associated with a traditional activated carbon product. In some embodiments, the activated carbon or filtration media has pore dimensions that are comparable to, substantially similar to, or the same as pore dimensions associated with a traditional activated carbon product. In some embodiments, the activated carbon or filtration media has an attrition resistance of particles value that is comparable to, substantially similar to, or the same as an attrition resistance of particles value associated with a traditional activated carbon product. In some embodiments, the activated carbon or filtration media has a hardness value that is comparable to, substantially similar to, or the same as a hardness value associated with a traditional activated carbon product. In some embodiments, the activated carbon or filtration media has a bulk density value that is comparable to, substantially similar to, or the same as a bulk density value associated with a traditional activated carbon product. In some embodiments, the activated carbon or filtration media has an adsorptive capacity that is comparable to, substantially similar to, or the same as an adsorptive capacity associated with a traditional activated carbon product.

Prior to suitability or actual use in any product applications, the disclosed activated carbons or filtration media can be analyzed, measured, and optionally modified (such as through additives) in various ways. Some properties of potential interest include density, particle size, surface area, microporosity, absorptivity, adsorptivity, binding capacity, reactivity, desulfurization activity, basicity, hardness, and Iodine Number.

Activated carbon is used commercially in a wide variety of liquid and gas-phase applications, including water treatment, air purification, solvent vapor recovery, food and beverage processing, sugar and sweetener refining, automotive uses, and pharmaceuticals. For activated carbon, key product attributes can include particle size, shape, composition, surface area, pore volume, pore dimensions, particle-size distribution, the chemical nature of the carbon surface and interior, attrition resistance of particles, hardness, bulk density, and adsorptive capacity.

The bulk density for the biogenic activated carbon or filtration media can be from about 50 g/liter to about 650 g/liter, for example.

The surface area of the biogenic activated carbon or filtration media can vary widely. Exemplary surface areas (e.g., BET surface areas) range from about 400 m²/g to about 2000 m²/g or greater, such as about 500 m²/g, 600 m²/g, 800 m²/g, 1000 m²/g, 1200 m²/g, 1400 m²/g, 1600 m²/g, or 1800 m²/g. Surface area generally correlates to adsorption capacity.

The pore-size distribution can be important to determine ultimate performance of the activated carbon. Pore-size measurements can include micropore content, mesopore content, and macropore content.

The Iodine Number is a parameter used to characterize activated carbon performance. The Iodine Number measures the degree of activation of the carbon, and is a measure of micropore (e.g., 0-20 Å) content. It is an important measurement for liquid-phase applications. Exemplary Iodine Numbers for activated carbon or filtration media produced by embodiments of the disclosure include about 500, 600, 750, 900, 1000, 1100, 1200, 1300, 1500, 1600, 1750, 1900, 2000, 2100, and 2200, including all intervening ranges. The units of Iodine Number are milligram iodine per gram carbon.

Another pore-related measurement is Methylene Blue Number, which measures mesopore content (e.g., 20-500 Å). Exemplary Methylene Blue Numbers for activated carbon or filtration media produced by embodiments of the disclosure include about 100, 150, 200, 250, 300, 350, 400, 450, and 500, including all intervening ranges. The units of Methylene Blue Number are milligram methylene blue (methylthioninium chloride) per gram carbon.

Another pore-related measurement is Molasses Number, which measures macropore content (e.g., >500 Å). Exemplary Molasses Numbers for activated carbon or filtration media produced by embodiments of the disclosure include about 100, 150, 200, 250, 300, 350, and 400, including all intervening ranges. The units of Molasses Number are milligram molasses per gram carbon.

In some embodiments, the activated carbon or filtration media is characterized by a mesopore volume of at least about 0.5 cm³/g, such as at least about 1 cm³/g, for example.

The activated carbon or filtration media can be characterized by its water-holding capacity. In various embodiments, activated carbon or filtration media produced by embodiments of the disclosure have a water-holding capacity at 25° C. of about 10% to about 300% (water weight divided by weight of dry activated carbon), such as from about 50% to about 100%, e.g., about 60-80%.

Hardness or Abrasion Number is measure of activated carbon's resistance to attrition. It is an indicator of activated carbon's physical integrity to withstand frictional forces and mechanical stresses during handling or use. Some amount of hardness is desirable, but if the hardness is too high, excessive equipment wear can result. Exemplary Abrasion Numbers, measured according to ASTM D3802, range from about 1% to great than about 99%, such as about 1%, about 5%, about 10%, about 15%, about 20%, about 25%, about 30%, about 35%, about 40%, about 45%, about 50%, about 55%, 60%, about 65%, about 70%, about 75%, about 80%, about 85%, about 90%, about 95%, about 96%, about 97%, about 98%, about 99%, or greater than about 99%.

In some embodiments, an optimal range of hardness can be achieved in which activated carbon is reasonably resistant to attrition but does not cause abrasion and wear in capital facilities that process the activated carbon. This optimum is made possible in some embodiments of this disclosure due to the selection of feedstock as well as processing conditions. In some embodiments in which the downstream use can handle high hardness, the process of this disclosure can be operated to increase or maximize hardness to produce biogenic activated carbon or filtration media having an Abrasion Number of about 75%, about 80%, about 85%, about 90%, about 95%, about 96%, about 97%, about 98%, about 99%, or greater than about 99%.

The biogenic activated carbon or filtration media provided by the present disclosure has a wide range of commercial uses. For example, without limitation, the biogenic activated carbon or filtration media can be utilized in emissions control, water purification, groundwater treatment, wastewater treatment, air stripper applications, PCB removal applications, odor removal applications, soil vapor extractions, manufactured gas plants, industrial water filtration, industrial fumigation, tank and process vents, pumps, blowers, filters, pre-filters, mist filters, ductwork, piping modules, adsorbers, absorbers, and columns.

In one embodiment, a method of using activated carbon to reduce emissions comprises:
(a) providing activated carbon particles comprising a biogenic activated carbon composition recovered from the second reactor disclosed herein;
(b) providing a gas-phase emissions stream comprising at least one selected contaminant;
(c) providing an additive selected to assist in removal of the selected contaminant from the gas-phase emissions stream;
(d) introducing the activated carbon particles and the additive into the gas-phase emissions stream, to adsorb at least a portion of the selected contaminant onto the activated carbon particles, thereby generating contaminant-adsorbed carbon particles within the gas-phase emissions stream; and
(e) separating at least a portion of the contaminant-adsorbed carbon particles from the gas-phase emissions stream, to produce a contaminant-reduced gas-phase emissions stream.

An additive for the biogenic activated carbon composition can be provided as part of the activated carbon particles. Alternatively, or additionally, an additive can be introduced directly into the gas-phase emissions stream, into a fuel bed, or into a combustion zone. Other ways of directly or indirectly introducing the additive into the gas-phase emissions stream for removal of the selected contaminant are possible, as will be appreciated by one of skill in the art.

A selected contaminant (in the gas-phase emissions stream) can be a metal, such as a metal is selected from mercury, boron, selenium, arsenic, and any compound, salt, or mixture thereof. A selected contaminant can be a hazardous air pollutant, an organic compound (such as a VOC), or a non-condensable gas, for example. In some embodiments, a biogenic activated carbon product adsorbs, absorbs or chemisorbs a selected contaminant in greater amounts than a comparable amount of a non-biogenic activated carbon product. In some such embodiments, the selected contaminant is a metal, a hazardous air pollutant, an organic compound (such as a VOC), a non-condensable gas, or any combination thereof. In some embodiments, the selected contaminant comprises mercury. In some embodiments, the selected contaminant comprises one or more VOCs. In some embodiments, the biogenic activated carbon comprises at least about 1 wt % hydrogen or at least about 10 wt % oxygen.

Hazardous air pollutants are those pollutants that cause or can cause cancer or other serious health effects, such as reproductive effects or birth defects, or adverse environmental and ecological effects. Section 112 Of the Clean Air Act, as amended, is incorporated by reference herein in its entirety. Pursuant to the Section 112 of the Clean Air Act, the United States Environmental Protection Agency (EPA) is mandated to control 189 hazardous air pollutants. Any current or future compounds classified as hazardous air pollutants by the EPA are included in possible selected contaminants in the present context.

Volatile organic compounds, some of which are also hazardous air pollutants, are organic chemicals that have a high vapor pressure at ordinary, room-temperature conditions. Examples include short-chain alkanes, olefins, alcohols, ketones, and aldehydes. Many volatile organic compounds are dangerous to human health or cause harm to the environment. EPA regulates volatile organic compounds in air, water, and land. EPA's definition of volatile organic compounds is described in 40 CFR § 51.100, which is incorporated by reference herein in its entirety.

Non-condensable gases are gases that do not condense under ordinary, room-temperature conditions. Non-condensable gas can include, but are not limited to, nitrogen oxides, carbon monoxide, carbon dioxide, hydrogen sulfide, sulfur dioxide, sulfur trioxide, methane, ethane, ethylene, ozone, ammonia, or combinations thereof.

Multiple contaminants can be removed by the disclosed activated carbon particles. In some embodiments, the contaminant-adsorbed carbon particles include at least two contaminants, at least three contaminants, or more. The activated carbon as disclosed herein can allow multi-pollutant control as well as control of certain targeted pollutants (e.g., selenium).

In some embodiments, contaminant-adsorbed carbon particles are treated to regenerate activated carbon particles. In some embodiments, the method includes thermally oxidizing the contaminant-adsorbed carbon particles. The contaminant-adsorbed carbon particles, or a regenerated form thereof, can be combusted to provide energy.

In some embodiments, an additive for activated carbon is selected from an acid, a base, a salt, a metal, a metal oxide, a metal hydroxide, a metal halide, or a combination thereof. In certain embodiments, the additive is selected from magnesium, manganese, aluminum, nickel, iron, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, sodium hydroxide, potassium hydroxide, hydrogen bromide, hydrogen chloride, sodium silicate, potassium permanganate, organic acids (e.g., citric acid), or combinations thereof.

In some embodiments, the gas-phase emissions stream is derived from metals processing, such as the processing of high-sulfur-content metal ores.

As an exemplary embodiment relating to mercury control, activated carbon can be injected (such as into the ductwork) upstream of a particulate matter control device, such as an electrostatic precipitator or fabric filter. In some cases, a flue gas desulfurization (dry or wet) system can be downstream of the activated carbon injection point. The activated carbon can be pneumatically injected as a powder. The injection location will typically be determined by the existing plant configuration (unless it is a new site) and whether additional downstream particulate matter control equipment is modified.

For boilers currently equipped with particulate matter control devices, implementing biogenic activated carbon injection for mercury control could entail: (i) injection of powdered activated carbon upstream of the existing particulate matter control device (electrostatic precipitator or fabric filter); (ii) injection of powdered activated carbon downstream of an existing electrostatic precipitator and upstream of a retrofit fabric filter; or (iii) injection of powdered activated carbon between electrostatic precipitator electric fields. Inclusion of iron or iron-containing compounds can drastically improve the performance of electrostatic precipitators for mercury control. Furthermore, inclusion of iron or iron-containing compounds can drastically change end-of-life options, since the spent activated carbon solids can be separated from other ash.

In some embodiments, powdered activated carbon injection approaches can be employed in combination with existing SO₂ control devices. Activated carbon could be injected prior to the SO₂ control device or after the SO₂ control device, subject to the availability of a means to collect the activated carbon sorbent downstream of the injection point.

In some embodiments, the same physical material can be used in multiple processes, either in an integrated way or in sequence. Thus, for example, activated carbon may, at the end of its useful life as a performance material, then be introduced to a combustion process for energy value or to a metal-making process that requires carbon but does not require the properties of activated carbon, etc.

The biogenic activated carbon or filtration media, and the principles of the disclosure, can be applied to liquid-phase applications, including processing of water, aqueous streams of varying purities, solvents, liquid fuels, polymers, molten salts, and molten metals, for example. As intended herein, “liquid phase” includes slurries, suspensions, emulsions, multiphase systems, or any other material that has (or can be adjusted to have) at least some amount of a liquid state present.

In one embodiment, the present disclosure provides a method of using activated carbon or filtration media to purify a liquid, in some variations, includes the following steps:
(a) providing activated carbon or filtration media particles;
(b) providing a liquid comprising at least one selected contaminant;
(c) providing an additive selected to assist in removal of the selected contaminant from the liquid; and
(d) contacting the liquid with the activated carbon or filtration media particles and the additive, to adsorb at least a portion of the at least one selected contaminant onto the activated carbon or filtration media particles, thereby generating contaminant-adsorbed carbon particles and a contaminant-reduced liquid.

The additive can be provided as part of the activated carbon or filtration media particles. Or, the additive can be introduced directly into the liquid. In some embodiments, additives—which can be the same, or different—are introduced both as part of the activated carbon or filtration media particles as well as directly into the liquid.

In some embodiments relating to liquid-phase applications, an additive is selected from an acid, a base, a salt, a metal, a metal oxide, a metal hydroxide, a metal halide, or a combination thereof. For example an additive can be selected from magnesium, manganese, aluminum, nickel, iron, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, sodium hydroxide, potassium hydroxide, hydrogen bromide, hydrogen chloride, sodium silicate, potassium permanganate, organic acids (e.g., citric acid), or combinations thereof.

In some embodiments, the selected contaminant (in the liquid to be treated) is a metal, such as a metal selected from arsenic, boron, selenium, mercury, and any compound, salt, or mixture thereof. In some embodiments, the selected contaminant is an organic compound (such as a VOC), a halogen, a biological compound, a pesticide, or a herbicide. The contaminant-adsorbed carbon particles can include two, three, or more contaminants. In some embodiments, an activated carbon product adsorbs, absorbs or chemisorbs a selected contaminant in greater amounts than a comparable amount of a non-biogenic activated carbon product. In some such embodiments, the selected contaminant is a metal, a hazardous air pollutant, an organic compound (such as a VOC), a non-condensable gas, or any combination thereof. In some embodiments, the selected contaminant comprises mercury. In some embodiments, the selected contaminant comprises one or more VOCs. In some embodiments, the biogenic activated carbon or filtration media comprises at least about 1 wt % hydrogen or at least about 10 wt % oxygen.

The liquid to be treated will typically be aqueous, although that is not necessary for the principles of this disclosure. In some embodiments, a liquid is treated with activated carbon or filtration media particles in a fixed bed. In other embodiments, a liquid is treated with activated carbon or filtration media particles in solution or in a moving bed.

In one embodiment, the present disclosure provides a method of using a biogenic activated carbon or filtration media composition to remove at least a portion of a sulfur-containing contaminant from a liquid, the method comprising:
(a) providing activated-carbon or filtration-media particles;
(b) providing a liquid containing a sulfur-containing contaminant;
(c) providing an additive selected to assist in removal of the sulfur-containing contaminant from the liquid; and
(d) contacting the liquid with the activated-carbon particles and the additive, to adsorb or absorb at least a portion of the sulfur-containing contaminant onto or into the activated-carbon or filtration-media particles.

In some embodiments, the sulfur-containing contaminant is selected from elemental sulfur, sulfuric acid, sulfurous acid, sulfur dioxide, sulfur trioxide, sulfate anions, bisulfate anions, sulfite anions, bisulfite anions, thiols, sulfides, disulfides, polysulfides, thioethers, thioesters, thioacetals, sulfoxides, sulfones, thiosulfinates, sulfimides, sulfoximides, sulfonediimines, sulfur halides, thioketones, thioaldehydes, sulfur oxides, thiocarboxylic acids, thioamides, sulfonic acids, sulfinic acids, sulfenic acids, sulfonium, oxosulfonium, sulfuranes, persulfuranes, or combinations, salts, or derivatives thereof. For example, the sulfur-containing contaminant can be a sulfate, in anionic or salt form.

The liquid can be an aqueous liquid, such as water. In some embodiments, the water is wastewater associated with a process selected from metal mining, acid mine drainage, mineral processing, municipal sewer treatment, pulp and paper, ethanol, or any other industrial process that is capable of discharging sulfur-containing contaminants in wastewater. The water can also be (or be part of) a natural body of water, such as a lake, river, or stream.

In one embodiment, the present disclosure provides a process to reduce the concentration of sulfates in water, the process comprising:
(a) providing activated-carbon or filtration-media particles recovered;
(b) providing a volume or stream of water containing sulfates;
(c) providing an additive selected to assist in removal of the sulfates from the water; and
(d) contacting the water with the activated-carbon or filtration-media particles and the additive, to adsorb or absorb at least a portion of the sulfates onto or into the activated-carbon or filtration-media particles.

In some embodiments, the sulfates are reduced to a concentration of about 50 mg/L or less in the water, such as a concentration of about 10 mg/L or less in the water. In some embodiments, the sulfate is present primarily in the form of sulfate anions or bisulfate anions. Depending on pH, the sulfate can also be present in the form of sulfate salts.

The water can be derived from, part of, or the entirety of a wastewater stream. Exemplary wastewater streams are those that can be associated with a metal mining, acid mine drainage, mineral processing, municipal sewer treatment, pulp and paper, ethanol, or any other industrial process that could discharge sulfur-containing contaminants to wastewater. The water can be a natural body of water, such as a lake, river, or stream. In some embodiments, the process is conducted continuously. In other embodiments, the process is conducted in batch.

When water is treated with activated carbon or filtration media, there can be filtration of the water, osmosis of the water, or direct addition (with sedimentation, clarification, etc.) of the activated-carbon or filtration-media particles to the water. When osmosis is employed, the activated carbon or filtration media can be used in several ways within, or to assist, an osmosis device. In some embodiments, the activated-carbon or filtration-media particles and the additive are directly introduced to the water prior to osmosis. The activated-carbon or filtration-media particles and the additive are optionally employed in pre-filtration prior to the osmosis. In certain embodiments, the activated-carbon or filtration-media particles and the additive are incorporated into a membrane for osmosis.

The present disclosure also provides a method of using a biogenic activated carbon or filtration media composition to remove a sulfur-containing contaminant from a gas phase, the method comprising:
(a) providing activated-carbon or filtration-media particles;
(b) providing a gas-phase emissions stream comprising at least one sulfur-containing contaminant;
(c) providing an additive selected to assist in removal of the sulfur-containing contaminant from the gas-phase emissions stream;
(d) introducing the activated-carbon or filtration-media particles and the additive into the gas-phase emissions stream, to adsorb or absorb at least a portion of the sulfur-containing contaminant onto the activated-carbon particles; and
(e) separating at least a portion of the activated-carbon or filtration-media particles from the gas-phase emissions stream.

In some embodiments, the sulfur-containing contaminant is selected elemental sulfur, sulfuric acid, sulfurous acid, sulfur dioxide, sulfur trioxide, sulfate anions, bisulfate anions, sulfite anions, bisulfite anions, thiols, sulfides, disulfides, polysulfides, thioethers, thioesters, thioacetals, sulfoxides, sulfones, thiosulfinates, sulfimides, sulfoximides, sulfonediimines, sulfur halides, thioketones, thioaldehydes, sulfur oxides, thiocarboxylic acids, thioamides, sulfonic acids, sulfinic acids, sulfenic acids, sulfonium, oxosulfonium, sulfuranes, persulfuranes, or combinations, salts, or derivatives thereof.

Generally speaking, the disclosed activated carbon or filtration media can be used in any application in which traditional activated carbon might be used. In some embodiments, the activated carbon is used as a total (i.e., 100%) replacement for traditional activated carbon. In some embodiments, the activated carbon or filtration media is essentially all or substantially all of the activated carbon used for a particular application.

For example and without limitation, the activated carbon or filtration media can be used—alone or in combination with a traditional activated carbon product—in filters. In some embodiments, a packed bed or packed column comprises the disclosed activated carbon or filtration media. In such embodiments, the biogenic activated carbon or filtration media has a size characteristic suitable for the particular packed bed or packed column. Injection of biogenic activated carbon or filtration media into gas streams can be useful for control of contaminant emissions in gas streams or liquid streams derived from coal-fired power plants, biomass-fired power plants, metal processing plants, crude-oil refineries, chemical plants, polymer plants, pulp and paper plants, cement plants, waste incinerators, food processing plants, gasification plants, and syngas plants.

In this detailed description, reference has been made to multiple embodiments of the invention and non-limiting examples relating to how the invention can be understood and practiced. Other embodiments that do not provide all of the features and advantages set forth herein can be utilized, without departing from the spirit and scope of the present invention. This invention incorporates routine experimentation and optimization of the methods and systems described herein. Such modifications and variations are considered to be within the scope of the invention defined by the claims.

All publications, patents, and patent applications cited in this specification are herein incorporated by reference in their entirety as if each publication, patent, or patent application were specifically and individually put forth herein.

Where methods and steps described above indicate certain events occurring in certain order, those of ordinary skill in the art will recognize that the ordering of certain steps can be modified and that such modifications are in accordance with the variations of the invention. Additionally, certain of the steps can be performed concurrently in a parallel process when possible, as well as performed sequentially.

Therefore, to the extent there are variations of the invention, which are within the spirit of the disclosure or equivalent to the inventions found in the appended claims, it is the intent that this patent will cover those variations as well. The present invention shall only be limited by what is claimed.

I/We claim:

1. A process for producing a biomedia composition, the process comprising:
(a) providing a starting feedstock containing biomass, wherein the starting feedstock is optionally dried;
(b) mildly pyrolyzing the starting feedstock to generate an intermediate biocarbon stream and a pyrolysis vapor;
(c) optionally washing or treating the intermediate biocarbon stream with an acid, a base, a salt, a metal, H₂, H₂O, CO, CO₂, or a combination thereof, to adjust acidity of the intermediate biocarbon stream; and
(d) recovering a biomedia composition containing:
from about 50 wt % to about 75 wt % total carbon, on a dry basis, according to an ASTM D5373 ultimate analysis of the biomedia composition, wherein the total carbon is at least 50% renewable according to an ASTM D6866 measurement of the ¹⁴C/¹²C isotopic ratio of the total carbon;
from about 20 wt % to about 40 wt % oxygen, on a dry basis, according to the ASTM D5373 ultimate analysis of the biomedia composition;
from about 3 wt % to about 10 wt % hydrogen, on a dry basis, according to the ASTM D5373 ultimate analysis of the biomedia composition; and
from about 0.1 wt % to about 2 wt % nitrogen, on a dry basis, according to the ASTM D5373 ultimate analysis of the biomedia composition,
wherein the biomedia composition is characterized by a volatile-matter content from about 50 wt % to about 75 wt %, according to an ASTM D3175 proximate analysis of the biomedia composition;
wherein the biomedia composition is characterized by an ash content from about 1 wt % to about 25 wt %, according to an ASTM D3174 proximate analysis of the biomedia composition; and
wherein the biomedia composition is characterized by a moisture content from 0 to about 75 wt %, according to an ASTM D3173 proximate analysis of the biomedia composition.

2. A process for producing a biomedia composition, the process comprising:
(a) providing a starting feedstock containing biomass, wherein the starting feedstock is optionally dried;
(b) mildly pyrolyzing the starting feedstock to generate an intermediate biocarbon stream and a pyrolysis vapor;
(c) optionally introducing one or more additives during step (a) or step (b), to adjust the acidity of the intermediate biocarbon stream; and
(d) recovering a biomedia composition containing:
from about 50 wt % to about 75 wt % total carbon, on a dry basis, according to an ASTM D5373 ultimate analysis of the biomedia composition, wherein the total carbon is at least 50% renewable according to an ASTM D6866 measurement of the ¹⁴C/¹²C isotopic ratio of the total carbon;
from about 20 wt % to about 40 wt % oxygen, on a dry basis, according to the ASTM D5373 ultimate analysis of the biomedia composition;
from about 3 wt % to about 10 wt % hydrogen, on a dry basis, according to the ASTM D5373 ultimate analysis of the biomedia composition; and
from about 0.1 wt % to about 2 wt % nitrogen, on a dry basis, according to the ASTM D5373 ultimate analysis of the biomedia composition,
wherein the biomedia composition is characterized by a volatile-matter content from about 50 wt % to about 75 wt %, according to an ASTM D3175 proximate analysis of the biomedia composition;
wherein the biomedia composition is characterized by an ash content from about 1 wt % to about 25 wt %, according to an ASTM D3174 proximate analysis of the biomedia composition; and
wherein the biomedia composition is characterized by a moisture content from 0 to about 75 wt %, according to an ASTM D3173 proximate analysis of the biomedia composition.

3. The process of either one of claim 1 or 2, wherein the biomass is selected from softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or combinations thereof.

4. The process of either one of claim 1 or 2, wherein the intermediate biocarbon stream or the biomedia composition is mechanically shredded.

5. The process of any one of claims 1 to 4, wherein the intermediate biocarbon stream or the biomedia composition is mechanically fluffed.

6. The process of any one of claims 1 to 5, wherein the intermediate biocarbon stream or the biomedia composition is mechanically treated to alter porosity of the biomedia composition.

7. The process of any one of claims 1 to 6, wherein the intermediate biocarbon stream or the biomedia composition is mechanically treated to alter solid flowability of the biomedia composition.

8. The process of any one of claims 1 to 7, wherein the biomedia composition is treated to adjust chemical oxygen demand of the biomedia composition.

9. The process of any one of claims 1 to 8, wherein the biomedia composition is treated to adjust color of the biomedia composition.

10. The process of any one of claims 1 to 9, wherein the biomedia composition is treated to adjust odor of the biomedia composition.

11. The process of any one of claims 1 to 10, wherein the biomedia composition is treated to adjust texture of the biomedia composition.

12. The process of any one of claims 1 to 11, wherein the biomedia composition comprises from about 55 wt % to about 70 wt % total carbon, on a dry basis, according to the ASTM D5373 ultimate analysis of the biomedia composition.

13. The process of claim 12, wherein the biomedia composition comprises from about 60 wt % to about 65 wt % total carbon, on a dry basis, according to the ASTM D5373 ultimate analysis of the biomedia composition.

14. The process of any one of claims 1 to 13, wherein the total carbon is at least 80% renewable according to the ASTM D6866 measurement of the ¹⁴C/¹²C isotopic ratio of the total carbon.

15. The process of any one of claims 1 to 13, wherein the total carbon is at least 90% renewable according to the ASTM D6866 measurement of the ¹⁴C/¹²C isotopic ratio of the total carbon.

16. The process of any one of claims 1 to 13, wherein the total carbon is 100% renewable according to the ASTM D6866 measurement of the ¹⁴C/¹²C isotopic ratio of the total carbon.

17. The process of any one of claims 1 to 16, wherein the biomedia composition comprises from about 25 wt % oxygen to about 35 wt % oxygen, on a dry basis, according to the ASTM D5373 ultimate analysis of the biomedia composition.

18. The process of any one of claims 1 to 17, wherein the biomedia composition comprises from about 5 wt % to about 8 wt % hydrogen, on a dry basis, according to the ASTM D5373 ultimate analysis of the biomedia composition.

19. The process of any one of claims 1 to 18, wherein the biomedia composition comprises from about 0.5 wt % to about 1 wt % nitrogen, on a dry basis, according to the ASTM D5373 ultimate analysis of the biomedia composition.

20. The process of any one of claims 1 to 19, wherein the biomedia composition comprises phosphorus, potassium, sulfur, or a combination thereof.

21. The process of any one of claims 1 to 20, wherein the biomedia composition contains less than 1 ppm mercury.

22. The process of claim 21, wherein the biocarbon composition is essentially free of mercury.

23. The process of any one of claims 1 to 22, wherein the biomedia composition is characterized by a volatile-matter content from about 60 wt % to about 70 wt %, according to the ASTM D3175 proximate analysis of the biomedia composition.

24. The process of any one of claims 1 to 23, wherein the biomedia composition is characterized by an ash content from about 2 wt % to about 20 wt %, according to the ASTM D3174 proximate analysis of the biomedia composition.

25. The process of any one of claims 1 to 24, wherein the biomedia composition is characterized by a moisture content from 10 wt % to about 50 wt %, according to the ASTM D3173 proximate analysis of the biomedia composition.

26. The process of any one of claims 1 to 25, wherein step (c) is performed.

27. The process of any one of claims 1 to 25, wherein step (c) is not performed.

28. The process of any one of claims 1 to 27, wherein the biomedia composition is hydrophilic.

29. The process of any one of claims 1 to 27, wherein the biomedia composition is hydrophobic.

30. The process of any one of claims 1 to 27, wherein the biomedia composition is amphipathic.

31. The process of any one of claims 1 to 30, wherein the biomedia composition is in the form of fine particulates.

32. The process of any one of claims 1 to 30, wherein the biomedia composition is in the form of fibrous particles.

33. The process of any one of claims 1 to 30, wherein the biomedia composition is in the form of a densified object.

34. The process of any one of claims 1 to 33, wherein the biomedia composition has a biomedia pH selected from about 4 to about 8.

35. The process of any one of claims 1 to 33, wherein the biomedia composition has a biomedia pH selected from about 5 to about 7.

36. The process of any one of claims 1 to 35, wherein the biomedia composition has a cationic exchange capacity selected from about 50 to about 200 meq/100 g.

37. The process of any one of claims 1 to 35, wherein the biomedia composition has a cationic exchange capacity selected from about 80 to about 150 meq/100 g.

38. The process of any one of claims 1 to 35, wherein the biomedia composition has a cationic exchange capacity selected from about 100 to about 125 meq/100 g.

39. The process of any one of claims 1 to 38, wherein the biomedia composition is characterized by a base-acid ratio defined by the following formula:
$$Base - Acid Ratio = \frac{{Fe}_{2} {O}_{3} + CaO + MgO + {K}_{2} O + {Na}_{2} O}{{SiO}_{2} + {Al}_{2} {O}_{3} + {TiO}_{2}}$$
wherein each of the Fe₂O₃, CaO, MgO, K₂O, Na₂O, SiO₂, Al₂O₃, and TiO₂ correspond to weight percentages in the biomedia composition pursuant to ASTM D4326, and wherein the base-acid ratio is selected from about 0.5 to about 10.

40. The process of claim 39, wherein the base-acid ratio is selected from about 1 to about 10.

41. The process of claim 39, wherein the base-acid ratio is selected from about 1 to about 5.

42. The process of claim 39, wherein the base-acid ratio is selected from about 5 to about 10.

43. The process of any one of claims 1 to 42, wherein the biomedia composition is characterized by an expanded base-acid ratio defined by the following formula:
$$Expanded Base - Acid Ratio = \frac{{Fe}_{2} {O}_{3} + CaO + MgO + {K}_{2} O + {Na}_{2} O + MnO + SrO + BaO}{{SiO}_{2} + {Al}_{2} {O}_{3} + {TiO}_{2} + {P}_{2} {O}_{5} + {SO}_{3}}$$
wherein each of the Fe₂O₃, CaO, MgO, K₂O, Na₂O, MnO, SrO, BaO, SiO₂, Al₂O₃, TiO₂, P₂O₅, and SO₃ correspond to weight fractions in the biomedia composition pursuant to ASTM D4326, and wherein the expanded base-acid ratio is selected from about 0.25 to about 8.

44. The process of claim 43, wherein the expanded base-acid ratio is selected from about 0.5 to about 8.

45. The process of claim 43, wherein the expanded base-acid ratio is selected from about 1 to about 4.

46. The process of claim 43, wherein the expanded base-acid ratio is selected from about 4 to about 8.

47. The process of any one of claims 1 to 46, wherein the biomedia composition is biologically sterile.

48. The process of any one of claims 1 to 47, wherein the biomedia composition is biodegradable.

49. The process of any one of claims 1 to 48, wherein the biomedia composition is compostable.

50. The process of any one of claims 1 to 49, wherein the process is continuous or semi-continuous.

51. The process of any one of claims 1 to 49, wherein the process is a batch process.
